(19) United States
(12) Patent Application Publication
(10) Pub. No.: US 2005/0031884 A1
(43) Pub. Date: Feb. 10, 2005

(54) Latex products

(76) Inventors: Kazuo Koide, Chiba (JP); Takayuki Suzuki, Chiba (JP); Takahisa Suzuki, (US)

Correspondence Address: FISH & RICHARDSON, PC, 12390 EL CAMINO REAL, SAN DIEGO, CA, 92130-2081, US

(21) Appl. No.: 10/432,879

(22) PCT Filed: Nov. 28, 2001
(86) PCT No.: PCT/JP01/10377

(30) Foreign Application Priority Data
Nov. 28, 2000 (JP) 2000-361376
Nov. 28, 2000 (JP) 2000-361383
Nov. 28, 2000 (JP) 2000-361391
Nov. 28, 2000 (JP) 2000-361399

(51) Int. Cl. B32B 25/04; B32B 25/12; B32B 25/16

(52) U.S. Cl. 428/521; 428/522

(57) ABSTRACT

The present invention finds that a detackified natural rubber latex product can be provided by a combination of treatment with a hydrophilic group sealant, coating with a detackifying polymer, halogenation and the like. The present invention also finds that a detackified natural rubber latex product which causes no discoloration of a metallic product surface can be provided by coating it with a detackifying, carboxylated latex vulcanized without using sulfur. The present invention also finds that a detackified natural rubber latex product of controlled protein elution can be provided by chemically modifying protein present in the natural rubber latex with an anionic group, cationic group or the like.

### TECHNICAL FIELD

The present invention relates to a novel non-adhesive latex product of natural rubber (NR), and novel method of producing the same.

### BACKGROUND ART

Latex products of natural rubber, e.g., immersion-processed products (e.g., balloon, glove, fingerstall and condom); extruded products (e.g., rubber yarn and tube); formed products (e.g., balloon and toys); totally rubber products (e.g., rubber sheet, hose and cloth), and rubber-lined products, frequently have tacky surfaces, which may cause deteriorated processability of the products or defective products. In addition, they have disadvantages such as incapability of manufacturing products of a desired product shape.

A detackifier has been used to solve these problems. It is generally powdery and referred to as powder. The common powder is of mica, talc, calcium carbonate, white carbon or corn starch.

The powder may be transferred to an object which comes into contact with the latex product to possibly cause various problems, when the product is used in the precision area. It may also deteriorate the outer appearances of the latex product. The FDA has issued the regulations on the rubber glove for medical purposes in July 1999, limiting protein elution to 1,200 μg or less and powder quantity to 120 mg or less for each glove. The regulations will be more stringent to limit the powder quantity to 20 mg in and after 2001. The powder quantity is regarded as an important measure against latex-caused allergy, because it plays an important role in allergy sensibilization. Protein in latex of natural rubber will cause no allergy sensibilization, when orally taken, because it is easily decomposed by a digestive juice. However, the powder adsorbs the protein derived from latex of natural rubber at a high concentration during the production process, and is released into the atmosphere while the product is being used. When the powder is inhaled or comes into contact with the skin, the latex protein will be absorbed in a living body, to cause the allergy sensibilization. Therefore, the powder is an important mediator for the latex allergy, and new sensibilization of the latex allergy will be greatly diminished, if a latex product of natural rubber can be free of powder (Ken Yagami, Proceedings for 5^{th} Latex Allergy Meeting). Thus, making latex products of natural rubber powder-free is an important technical theme.

The common tackiness prevention measures other than use of powder include halogenation by the post-chlorination treatment. For examples, U.S. Pat. Nos. 3,411,982 and 3,740,262 disclose that a rubber glove has slippery surfaces, when treated for halogenation. U.S. Pat. No. 4,304,008 discloses that halogenation facilitates use of the rubber products free of powder. U.S. Pat. No. 3,740,262 discloses halogenation of globes to provide powder-free external surface and powder-coated internal surface.

Halogenation is a fairly common method of preventing tackiness and blooming by coating the product surface with a thin, halogenated rubber layer, and provides the rubber products with clean, powder-free surface.

U.S. Pat. No. 4,304,008 discloses a surgical glove comprising natural rubber for the internal layer and halogenated, durable silicone for the external layer, where the internal layer is halogenated to be detackified.

U.S. Pat. No. 5,284,607, admitting defects involved in halogenation, discloses a method of forming a medical glove using an acid-soluble powder, which is subsequently treated with an acid, e.g., nitric acid, to dissolve the acid-soluble powder and then chlorinated with a bleaching agent.

Various improvements are noted in methods of producing rubber products which use powder or substance of particular structure.

U.S. Pat. No. 4,070,713 discloses a medical glove of two-layered structure with external and internal layers of an elastic material, where particles of zinc oxide, titanium oxide or the like are fast embedded in the internal layer and partly exposed to the inner surface coming into contact with the skin.

U.S. Pat. No. 4,143,109 discloses the method of producing the above described patent.

U.S. Pat. No. 5,138,719 discloses a method of producing a powder-free glove, fingerstall and similar products using latex and microcapsules, where the microcapsules are dispersed and disposed in the latex in such a way to increase in concentration towards the inner surface of the product from the outer surface. The microcapsules are present at a sufficiently high concentration on the inner surface to make the surface slippery, facilitating use of the product even in the absence of the powder.

U.S. Pat. No. 5,881,386 discloses a glove of two-layered structure of polyvinyl chloride and polyester/polyurethane, the inner layer of polyester/polyurethane containing particles of 1 to 75 μm in size.

Japanese Patent Laid-Open No. 11-12823 discloses a technique for producing a glove which produces less dust for works in clean rooms, where the glove of polyvinylidine chloride paste sol is immersed in an inner surface treatment agent containing particles of 0.1 to 1.5 μm in size.

Japanese Patent Laid-Open No. 11-61527 discloses a rubber glove easily worn or taken off, provided with a slippery resin layer by immersing the glove in an aqueous dispersing solution containing synthetic rubber latex and an organic filler which are not coagulated in the absence of a coagulating agent contained in the glove body.

National Publication of International Patent Application No. 9-501983 discloses a silicone-modified powder composition dispersible in water and method of producing the same, describing that the composition can be used as a blocking inhibitor.

Recently, latex products coated with various materials have been developed.

U.S. Pat. No. 4,310,928 provides a powder-free surgical glove coated on the natural rubber surface with oil, fat or lipophilic material dispersed in a coagulated liquid, where the coagulated liquid is incorporated with a surfactant to prevent separation of the oil, fat or lipophilic material.

U.S. Pat. Nos. 5,780,112 and 5,974,589 disclose a method of adhering a high-density, straight-chain hydrocarbon polymer, in particular polyethylene, to the natural rubber surface with the aid of chlorine generated from acidified hypochlorite, giving the treated latex product which is not tacky although free of powder.

National Publication of International Patent Application No. 11-507085 discloses a flexible copolymer coating which can be fast adhesive to the rubber product surface and extended without being separated from the rubber surface to which it is bonded, and also discloses an emulsion-based copolymer of a reactive monomer of low surface energy (preferably silicone oligomer), alkyl acrylate and reactive, hard monomer, in consideration of releasability from an immersion mold and easiness of wearing under both dry and wet conditions.

A number of methods have been proposed for producing a powder-free glove, which coat the rubber surface with a polymer capable of forming a hydrophilic hydrogel and then cure the polymer layer, e.g., by U.S. Pat. Nos. 3,326,742, 3,585,103, 3,607,473, 3,745,042, 3,901,755, 3,925,138, 3,930,076, 3,940,533, 3,966,530, 4,024,317, 4,110,495, and 4,125,477.

U.S. Pat. No. 4,499,154 discloses a method of producing a talc-free product, where an immersion-processed product is immersed in a natural rubber latex, leached in hot water, impregnated with a diluted acid, treated with water or an aqueous alkali solution to neutralize the surface, immersed in a polymer capable of forming hydrophilic hydrogel (e.g., copolymer of 2-hydroxyethyl methacrylate and methacrylic acid or 2-ethylhexyl acrylate) and a crosslinking agent solution therefor, heated to fix the coating layer to the rubber, treated to vulcanize the rubber, released out of the mold, spread with surfactant-containing silicone, and heated. The patent also discloses that the method improves slipping characteristics of the product for a wet hand, when the coating layer of the hydrogel polymer is crosslinked, and then treated with a cationic surfactant, e.g., long-chain aliphatic amine. This method, although giving a powder-free rubber product, needs many steps to unreasonably push up the production cost, and is impractical for production of a product sensitive to contamination with silicone.

U.S. Pat. No. 4,575,476 discloses that the product coated with a specific 2-oxyethylmethacrylate-based hydrogel polymer has good slipping characteristics for a dry hand. It also describes that the product surface to come into contact with the skin has improved slipping characteristics for a wet hand, when the hydrogel coating layer is treated with a surfactant (in particular cationic one) and long-chain aliphatic amine, and that tackiness of the surface not coated with the hydrogel is greatly improved when it is treated with a silicone-containing surfactant.

U.S. Pat. No. 5,688,855 describes that hydrophilicity of the solid surface gives surface lubricity in the presence of water, providing a method of automatically producing a hydrophilicity concentration gradient in the coating layer by coating the rubber product surface with a solution of polymer component capable of forming hydrogel and water-soluble polymer component low in compatibility with the above-described component in a solvent, and evaporating the solvent to separate these components from each other.

Japanese Patent Laid-Open No. 11-269708 discloses a glove comprising a base layer of rubber or resin laminated on the inner surface with a lubricating layer of collagen-containing rubber or resin.

One of the disadvantages of the product produced by the method of coating the rubber surface is the interlayer exfoliation when the rubber is extended.

U.S. Pat. No. 4,499,154 reinforces adhesion of the coating layer by undercoating the rubber surface with an acid.

WO 93/06996-A1 proposes use of a polymer having a repeating structure of a specific ether and ester group as the coating layer.

U.S. Pat. No. 4,548,844 discloses a method of improving adhesion between the rubber and hydrogel layers by acid treatment, describing that adhesion between these layers is improved when aluminum cations or trivalent or higher cations are applied before the hydrogel polymer, or incorporated in the polymer, conceivably because the hydroxyl or carboxyl group in the hydrogel polymer is bonded to the protein in the rubber latex.

Japanese Patent Laid-Open No. 6-70942 discloses a multi-layered product composed of the first layer of natural rubber, second layer of natural rubber, poly(acrylamide/acrylic acid) and polyethylene oxide, and third layer of acrylic copolymer and fluorocarbon telomere, claiming that the product can be worn under both dry and wet conditions in the absence of powder.

Japanese Patent Laid-Open No. 10-95867 discloses a method of producing a powder-free medical glove or the like which is coated with a lubricating composition composed of the first and second components in this order from the wearer's side of the elastomer product. The first composition is composed of at least one compound selected from the group consisting of acetylenediol, organically modified silicone, amino-modified silicone and cationic surfactant, and the second composition of at least one compound selected from the group consisting of cationic surfactant, organically modified silicone, amino-modified silicone and acetylenediol.

Japanese Patent Publication No. 7-4405 discloses a technique for surface treatment with modified polysiloxane.

One of the methods of producing powder-free rubber products coats the rubber product on one side by immersing in latex the mold lined with a coagulating agent, wherein a divalent metallic salt as the coagulating agent (e.g., calcium nitrate) and water-soluble surfactant (preferably nonionic) stable to the metallic salt are incorporated in the coagulating solution to stabilize the latex or resin polymer. This method by itself is not intended to detackify the rubber product, but can detackify it when a releasing agent or detackifier is incorporated as the third component in the coagulating agent composition.

U.S. Pat. Nos. 3,286,011 and 3,411,982 by Kavalir et al disclose the above techniques. These patents, however, cannot make the product powder-free, because power is used as the releasing agent. It is described that salts of multi-valent metals (e.g., calcium, magnesium and aluminum) can be used as the latex coagulating agent for these patents.

The above-described U.S. Pat. No. 4,310,928 discloses a technique for producing a surgical glove releasable from an immersion mold using a coagulating agent comprising a coagulating agent solution, e.g., that of calcium nitrate, dispersed with a lipophilic substance.

National Publication of International Patent Application No. 10-508899 discloses a method of producing a powder-free rubber product by incorporating a coating composition of acrylic-based emulsion copolymer and silicone emulsion in a coagulating agent. The coating composition is produced by copolymerization of a reactive silicone acrylate, alkyl acrylate and hard monomer. It is described that such a composition is known, facilitates releasing when incorporated with a silicone emulsion, and gives the glove showing good wearing characteristics under both dry and wet conditions.

EP 640,623 discloses a coagulating agent for natural rubber, composed of a salt-stable polychloroprene or polyurethane and divalent metal salt, and describes that a powder-free rubber glove can be produced by incorporating the coagulating agent with a releasing agent composed of polyethylene wax emulsion and cationic surfactant.

Japanese Patent Laid-Open No. 11-236466 uses a surfactant, polypropylene wax emulsion or the like as the tacky quenching or releasing agent in place of the above-described polyethylene wax emulsion, describing that it works as the agent to release polychloroprene from the immersion mold, because the cationic surfactant functions to stabilize polychloroprene to be incorporated in the coagulating solution and is more compatible with the immersion mold than with the polymer.

Japanese Patent Publication No. 2-42082 discloses a coagulating agent composition composed of water incorporated with latex, surfactant and divalent or trivalent metallic salt.

National Publication of International Patent Application No. 9-511708 employs the Teague process for producing a polyurethane-coated glove, wherein the glove is immersed in an aqueous dispersion or emulsion of polyurethane polymer or copolymer to form the first layer, which is then immersed in a coagulating agent and further in a latex compound to form the second layer. It also discloses a technique for forming a lubricating polymer layer on the second layer.

The techniques for powder-free rubber products from novel starting materials are also disclosed.

U.S. Pat. No. 5,851,683 proposes a special, consecutively copolymerized polymer for a powder-free glove of thermoplastic elastomer for use in clean rooms.

These methods of preventing tackiness of latex products are important techniques both from production and purposes of the products, and various ones are proposed. However, they generally need complex steps, and few processes developed so far are simple, effective and economical.

It is planned to regulate quantity of protein eluted out of natural rubber latex products in consideration of allergy possibly caused by them, and reduction of the quantity has been demanded. Halogenation is a known process for decomposition of the protein. Moreover, natural rubber latex products have been recently produced by new processes, wherein protein in natural rubber latex is enzymatically decomposed by the aid of protease (disclosed by, e.g., Japanese Patent Laid-Open No. 6-56902). These natural rubber latex products involve various disadvantages, e.g., insufficient vulcanization characteristics and strength-related properties. They are tacky as is the case with common natural rubber latex products.

The techniques for reducing allergen activity of natural rubber latex products are proposed by, e.g., WO97/08228, wherein protein in natural rubber latex is leached out in the process of producing the product, and protein eluted out in the vicinity of the latex film surface or in the treatment solution is reacted with an epoxy compound, glyoxal or the like. WO97/08228, however, is completely silent on reducing eluted quantity of the proteins planned to be regulated. Moreover, the epoxy compound, glyoxal or the like has mutagenicity, and may cause dermatitis. In addition, it is difficult to detackify a natural rubber latex product, when the tacky substance in leached out to the surface.

It is an object of the present invention to provide a novel natural rubber latex product and method of producing the same, in consideration of the problems involved in the current techniques to detackify the product. It is another object to provide a natural rubber latex product which causes no discoloration of the metallic product surface by sulfur used for vulcanization.

It is still another object to provide a natural rubber latex product which controls elution of protein and method of producing the same.

It is still another object to provide a natural rubber latex product which is free of powder and detackified, and controls elution of protein.

### DISCLOSURE OF THE INVENTION

The inventors of the present invention have extensively studied to solve the above-described problems. They have investigated various hydrophobicizing agents to make a natural rubber latex product non-hydrophilic and their hydrophobicizing capacity, based on the inventions made by them for detackifying the diene-based carboxylated synthetic rubber latex products (PCT/JP00/03370 and 2000/121767). However, the results are not always satisfactory. Such a treatment brings about some effects, which, however, are insufficient for producing the target powder-free product.

Then, they have changed way of thinking, and positively incorporate a hydrophilic substance in natural rubber latex and then treat the rubber for hydrophobicizing, to find that the very tacky natural rubber latex product is easily detackified.

More specifically, a film produced by immersing a mold in natural rubber latex shows a strongly tacky substance leached out on the surface, when treated for leaching. The inventors of the present invention consider that this tacky substance is a tacky auxiliary component, e.g., water-soluble protein, derived from a natural rubber latex. Then, they have attempted immersion forming of natural rubber latex, after it is incorporated with carrageenan, considered to have a capacity of reacting with protein (P. M. T. Hansen, J. Dairy Sci., 51(2) 192, 945 (1968)), to find that the surface tackiness is reduced. It is said that carrageenan helps form anionic, hydrophilic, colloidal particles at a pH equivalent to or above the isoelectric point of the protein, by the actions of multi-valent cations, e.g., calcium, lying between negatively charged carrageenan and protein, and that protein forms an insoluble composite with carrageenan at below the isoelectric point. It is therefore considered that carrageenan works to control leaching of the protein to the film surface both in the leaching and drying steps for the natural rubber latex production process. The natural rubber latex product thus produced shows reduced tackiness, partly because of hydrophilicity of incorporated carrageenan itself. Nevertheless, however, it still shows some residual tackiness, and needs a treatment, e.g., use of powder or chlorination, to be detackified.

Then, the inventors of the present invention have attempted to apply the techniques, applied for patents by them, for detackifying the diene-based carboxylated synthetic rubber latex products (PCT/JP00/03370 and 2000/121767) to the carrageenan-incorporated natural rubber latex, to find that the product is successfully detackified, which is difficult by the conventional method. More specifically, they have successfully produced a natural rubber latex product, which is detackified in spite of being free of powder, by treating carrageenan as an anionic, hydrophilic polymer and protein or the like as an auxiliary component with a hydrophilic group (which is described later). It is found that a natural rubber latex product showing no tackiness is obtained when a sealant is incorporated in the latex or used for surface treatment of the latex.

Next, a polyacrylic acid or acrylic-based copolymer known as a protein modifier is incorporated, to find that each is effective.

Then, the inventors of the present invention have studied the above-described effect of detackifying the latex with natural, semi-synthetic and synthetic anionic, hydrophilic polymers, to find that the effective compounds include anionized hydrophilic cellulose derivatives (e.g., carboxymethyl cellulose), anionized starch (e.g., phosphate-esterified starch, anionized starch incorporated with a hydrophobic group, and carboxymethylated starch), and anionized guar gum, alginic acid, pectin, xanthan gum and maleic acid copolymer. In other words, it is considered that, when multi-valent cations, e.g., calcium, are present, they lie between negatively charged polymer having an anionic group and protein to help form the anionic, hydrophilic colloidal particles, as is the case with carrageenan. Therefore, a tacky substance is prevented from leaching out both in the leaching and drying steps. At the same time, treating tacky substances, e.g., anionic, hydrophilic polymer and protein, with a hydrophilic group sealant as the agent for hydrophobicizing natural rubber latex to make it non-hydrophilic or hydrophobic gives a detackified natural rubber latex product without using powder.

It is considered that the anionic, hydrophilic polymer controls leaching of protein or the like as an auxiliary component, and, at the same time, provides sites for reaction or adsorption of the hydrophilic group sealant, to make the natural rubber latex product surface non-hydrophilic or hydrophobic, thereby preventing formation of the hydrogen bond and detackifying the product.

The hydrophilic group in the anionic, hydrophilic polymer is not limited to carboxyl, but a variety of groups are useful. These include sulfate ester (—OSO₃M), sulfonate (—SO₂OM), phosphate (—PO₃HM or —PO₃M₂), phosphate ester, —SO₂NH₂, and —SO₂NHCOR groups, wherein M is hydrogen atom, and alkali metal, ammonia or organoammonium, and R is an alkyl, phenyl which may be substituted or not, or naphthyl group which may be substituted or not.

Next, the inventors of the present invention have incorporated a nonionic, hydrophilic polymer in place of anionic, hydrophilic polymer in natural rubber latex for the treatment with the hydrophilic group sealant, to confirm that it has the effect similar to that by the anionic, hydrophilic polymer. In other words, a natural rubber latex product can be detackified in spite of being free of powder, when incorporated with methyl cellulose and treated with the hydrophilic group sealant.

Then, the inventors of the present invention have conducted the tests with cellulose derivatives, e.g., hydroxypropylmethyl cellulose, hydroxyethylmethyl cellulose and hydroxyethyl cellulose; nonionic hydrophilic synthetic polymers, e.g., polyvinyl alcohol, polyethylene oxide, poly(N-vinyl-2-pyrrolidine) and vinyl ether-based polymers; and natural polysaccharides, e.g., locust bean gum, guar gum, tamarind gum, pullulan, galactomannan, tragacanth gum and dextran, to obtain the similar results. These nonionic, hydrophilic polymers generally have hydroxyl, ether or amide group as the hydrophilic group.

The inventors of the present invention have further conducted the tests to incorporate cationic and ampholytic polymers in place of the anionic, hydrophilic polymer in natural rubber latex, which is kept at a pH 10 to 11 with ammonia and dispersed by protein mostly charged negative. It is considered that a cationic polymer, if it can be incorporated, will be directly bonded to protein and phospholipid considered to be the tacky components of natural rubber latex, and effective for detackifying the product. On the other hand, it is also considered that natural rubber latex will be coagulated, when protein dispersing the latex is bonded to the cationic polymer, as predicted by P. M. T. Hansen described earlier. As expected, the natural rubber latex is gelated with cationic polyacrylamide, which is commonly used for waste water treatment, as expected. It is therefore impossible to obtain a natural rubber latex product, although the cationic polymer is weakly cationic and low-molecular-weight type. On the other hand, cationized or ampholytic starch, which is used in the pulp industry, is found to bring about the effect of detackifying a natural rubber latex product similar to that by the anionic, hydrophilic polymer, without excessively increasing the viscosity, and as expected. The cationic group in the cationized starch is mostly of tertiary amine or quaternary ammonium, having a degree of substitution in a range of 0.02 to 0.06, mainly around 0.03 to 0.04. Therefore, the starch is low in degree of cationization. The inventors of the present invention have also conducted the tests with other cationic and ampholytic hydrophilic polymers used in the industry to find that all but few of these polymers tested show the effect of detackifying natural rubber latex without causing gelation. The similar results are obtained with cationic and ampholytic polyacrylamide.

The cationic, hydrophilic polymers useful for the present invention include synthetic polymers, e.g., aminoalkyl methacrylate/acrylamide copolymer, polyvinyl pyridium ammonium halide, polyallyl ammonium halide, polyaminomethylacrylamide, polyvinyl imidazoline, polyacrylamide modified by the Mannich reaction, polyacrylamide modified by the Hofmann reaction, polyethyleneimine, polydiallylamine, polypiridium halide, cationized starch, cationized cellulose, cationized polyvinyl alcohol, epoxyamine-based condensate, ionene-based condensate, cationized polymethacrylate ester resin, alkylene diamine/epichlorohydrin polycondensate, cationized polyvinyl pyrrolidone and cationized polyacrylamide; and semi-synthetic polymers, e.g., cationized cellulose, cationized starch and cationized guar gum. The ampholytic, hydrophilic polymers useful for the present invention include ampholytic cellulose, starch, guar gum and polyacrylamide. Whether or not the cationic or ampholytic, hydrophilic polymer gelates natural rubber latex cannot be always predicted, because it depends on type and molecular weight of the polymer, and type, quantity and distribution of the cationic group, among others. However, it can be readily known by adding the polymer to natural rubber latex. Therefore, the cationic and ampholytic, hydrophilic polymers useful for the present invention are limited to those which should not gelate natural rubber latex.

The hydrophilic polymer is not necessarily soluble in water. Even a water-dispersible polymer can bring about the effect of detackifying the latex, so long as it is hydrophilic. In particular, natural rubber latex is strongly alkaline, and a water-dispersible polymer may be soluble in alkaline water in natural rubber latex. Moreover, in the case of synthetic polymer, even a water-dispersible one may bring about the effect similar to that provided by a water-soluble one, because the molecule can be freely designed for the polymer.

The examples of water-dispersible, synthetic polymers useful for the present invention include polyvinyl acetate, ethylene/vinyl acetate copolymer, styrene/acrylate ester copolymer, styrene/methacrylate ester copolymer, acrylate ester copolymer, methacrylate ester copolymer, vinyl acetate/acrylic acid copolymer, vinyl acetate/acrylate ester copolymer, vinyl acetate/methacrylic acid copolymer, vinyl acetate/methacrylate ester copolymer, polyacrylamide, polymethacrylamide, acrylamide-based copolymer, methacrylamide-based copolymer, and anionic, cationic and ampholytic modifications of these polymers.

It is known that each of the above hydrophilic polymers interacts with natural rubber latex chemically, physicochemically and physically, as is seen in the creaming, protective colloidal and thickening phenomena. However, it is considered that the polymer also interacts with the tacky, auxiliary component in the latex, viewed from the controlled elution and leaching of the component in the leaching and drying steps in the latex product production process. It is also considered that a natural rubber latex product is hydrophobicized when a varying hydrophobicizing agent is acted thereon, after being incorporated with the hydrophilic polymer, and that the agent first acts on protein and phospholipid considered as the tacky auxiliary components, which are mostly charged negative.

The varying hydrophilic polymer intentionally incorporated in the latex will be the second target to be hydrophobicized. It is considered that the hydrophilic polymer provides the sites for reaction and adsorption of the hydrophilic group sealant to contribute to hydrophobicizing of the natural rubber latex product as a whole.

There are various hydrophilic groups to be hydrophobicized; those derived from protein, e.g., carboxyl, amino and thiol, those derived from phospholipids, e.g., phosphate ester; hydrophilic group, e.g., carboxyl; and those derived from the intentionally incorporated with nonionic, anionic, cationic or ampholytic, hydrophilic polymers. The hydrophilic group sealant is an agent which works to hydrophobicize various hydrophilic groups chemically, physicochemically and physically and prevent formation of the hydrogen bond, thereby detackifying the natural rubber latex product. The hydrophilic group sealants include various agents, e.g., hydrophobicizing crosslinking agent showing no tackiness, hydrogen bond modifier showing no tackiness, surfactant showing no tackiness, sizing agent, waterproofing agent and water repellant. The hydrophilic group sealant is not required to hydrophobicize all of these hydrophilic groups, but required to hydrophobicize only to an extent to detackify a natural rubber latex product as a whole. Therefore, many carboxyl group sealants capable of detackifying a natural rubber latex product as a whole function as a hydrophilic group sealant, and so is vice versa that many hydrophilic group sealants capable of detackifying a natural rubber latex product as a whole function as a carboxyl group sealant. Whether an agent has such a function should be judged to see whether it allows natural rubber latex product surfaces to adhere or attach to each other and causes no trouble when the product is used after the products are stored for several months while keeping their surfaces coming into contact with each other. However, it is convenient to concretely judge the function by the tackiness test, conducted in EXAMPLES.

The inventors of the present invention have first studied use of a crosslinking agent of tri- or tetra-valent metallic element as the hydrophilic group sealant. More specifically, they have attempted to form an immersion-processed film of natural rubber latex incorporated with an anionic, hydrophilic polymer in the presence of a divalent metallic salt coagulating agent incorporated with water-soluble polyaluminum hydroxide, to find that the film inside surface is detackified. A crosslinking agent of metallic element crosslinks anionic, hydrophilic group by the ionic bond to seal the group and prevent formation of the hydrogen bond, thereby detackifying the latex product. For example, an aluminum salt as the representative tri- or tetra-valent metallic cation follows the Schultz-Hardy law to show a strong coagulating function. Therefore, it is expected to hydrophobicize an anionic, hydrophilic polymer, and found to detackify the tacky, auxiliary components of a natural rubber latex product. These findings suggest that the tacky component of natural rubber latex is anionic.

A tetravalent zirconium salt and tri- and tetra-valent titanium salt also have a strong hydrophobicizing effect.

Next, the inventors of the present invention have studied to detackify the external surface of the immersion-processed film.

More specifically, they have heated the above-described latex film with detackified inner surface, immersed in a water-soluble polyaluminum hydroxide solution, to find that its external surface is detackified with the crosslinked aluminum compound layer thereon. Further, they have heated the above immersion-processed product, released out of the immersion mold, with its both surfaces immersed in an aluminum compound solution, to find that its both surfaces are detackified.

The inventors of the present invention have tested, based on the above knowledge, the crosslinked layer formation reactions on the latex surface using various tri- or tetra-valent metallic compounds, to find that the natural rubber latex product with detackified surface can be produced.

They have also treated in a similar manner the surface of a peroxotitanium complex, which, although tetravalent, forms a neutral, stable aqueous solution, to find the detackified film is formed on the natural rubber latex film surface without causing interlayer exfoliation.

They have further treated the natural rubber latex surface with titania, zirconia and alumina sol, known to form a uniform coating film, to find that the product with detackified, slippery surface can be produced.

Natural rubber latex is strongly ammonia-alkaline, and many tri- or tetra-valent crosslinking agents of metallic elements are possibly decomposed by ammonia to form powder of hydroxide or the like on the latex film surface. It is therefore necessary to take a sufficient countermeasure against formation of hydroxide by, e.g., evaporating or eluting out ammonia.

A hydroxide, or insoluble or sparingly soluble salt may be incorporated beforehand in natural rubber latex, even though it is a crosslinking agent of tri- or tetra-valent metallic element. The examples of these include aluminum hydroxide, calcium aluminate and satin white. These aluminum compounds, however, tend to gelate latex as time passes. On the other hand, ammonium zirconium carbonate causes no gelation of natural rubber latex in which it is incorporated, and is convenient.

PAC, water-soluble polyaluminum hydroxide, peroxotitanium and the like, whose metallic element is tri- or tetra-valent, show greater effect as polymer than as monomer, and these compounds are also crosslinking agents of tri- or tetra-valent metallic elements useful for the present invention.

Next, the inventors of the present invention have studied the effect of detackifying a natural rubber latex product with various organic crosslinking agents.

Polymers of low intermolecular cohesive energy, such as rubber, will have greatly improved mechanical properties, when their molecules are crosslinked with each other. Natural rubber may not exhibit the inherent rubber characteristics, until it is crosslinked to form the vulcanizate. Crosslinking agents for vulcanizing rubber are mostly of sulfur by far. T. H. Kempermann discusses in detail many non-sulfur crosslinking agents for vulcanization (Rubber Chem. Technol. 61, 422, 1988), describing vulcanization by sulfur donor, thiuram, thiourea, bis-mercapto, S—Cl compound, resin, compound having a reactive nitrogen group, compound having a reactive olefin group and peroxide, and ionic vulcanization. Most of them, however, are merely auxiliary in nature or of academic importance.

These crosslinking agents for vulcanization cannot detackify a natural rubber latex product. More specifically, natural rubber latex will lose its product value, when vulcanized to an extent of being detackified. The vulcanization methods for the present invention are not limited, and the conventional methods, e.g., vulcanization with the aid of sulfur, peroxide and radioactive ray, can be used.

The crosslinking agent necessary for the present invention crosslinks and hydrophobicizes protein and phospholipid considered to be the tacky, auxiliary components of natural rubber latex and a small quantity of hydrophilic polymer intentionally incorporated, thereby preventing formation of the hydrogen bond and detackifying the product. The hydrophilic groups to be crosslinked include carboxyl, amino, hydroxyl and thiol in the case of protein; phosphate ester and carboxyl in the case of phospholipids; and specific hydrophilic group in the case of the hydrophilic polymer.

On the other hand, various organic crosslinking agents for improving functions/performances of the rubber product or modification of the resin product pursue improvement of mechanical properties, beginning with resistance to heat and durability, by the crosslinking reactions. The common organic crosslinking agents are frequently used at high temperature of 120° C. or higher, because of priority given to storage and reaction stability. When used at lower temperature for a natural rubber latex product, they may be eluted out from the product surface without reacting the latex, failing to exhibit the effect of detackifying the latex. Moreover, self-crosslinking or multi-functional crosslinking agents may cause other problems, e.g., bonding the product surfaces to each other by the functional group remaining unreacted, and insufficient extent of detackifying the latex product surface.

Therefore, the inventors of the present invention have used crosslinking agents reacting at low temperature, e.g., oxazoline-based and carbodiimide-based ones, and treated therewith the latex at high temperature prior to the leaching step, to find that the natural rubber latex product is detackified even with organic crosslinking agents. It is also found that an emulsion type organic crosslinking agent can control itself from eluting out from the external surface of the natural rubber latex product, and exhibits the detackifying effect even when it works to crosslink at higher temperature. Even these crosslinking agents will lose their detackifying effect as time passes, when they are of self-condensing or multi-functional type, because the residual agent bonds the contacting surfaces to each other. Therefore, the organic crosslinking agent exhibiting the detackifying effect is preferably of low-temperature reaction, low-functional or emulsion type. The crosslinking agent for the present invention should hydrophobicize and detackify the crosslinked natural rubber latex product. Such an organic crosslinking agent exhibiting the above functions is referred to as the detackifying, hydrophobicizing organic crosslinking agent in this specification. More specifically, such a crosslinking agent prevents the natural rubber latex product surfaces from adhering or attaching to each other after the products are stored for several months while keeping their surfaces coming into contact with each other. Still more specifically, it is the crosslinking agent which is verified to show no tackiness by the tackiness test, conducted in EXAMPLES.

The surface treatment with an organic crosslinking agent can be effected subsequent to the leaching step, which widens a range of applicable agents.

Some organic compounds considered to react with various hydrophilic groups bring about the similar effect, although they are not hydrophilic group crosslinking agents. These compounds include glyoxal, benzaldehyde, dimethylol urea, polyamide compounds, polyamidepolyurea compound, polyamidepolyurea/glyoxal condensate, polyaminepolyurea compound, polyamideaminepolyurea compound, polyamideamine compound, polyamideamine/epihalohydrin condensate, polyamideamine/formaldehyde condensate, polyamine/epihalohydrin condensate, polyamine/formaldehyde condensate, polyamidepolyurea/epihalohydrin condensate, polyamidepolyurea/formaldehyde condensate, polyaminepolyurea/epihalohydrin condensate, polyaminepolyurea/formaldehyde condensate, polyamideaminepolyurea/epihalohydrin condensate, and polyamideaminepolyurea/formaldehyde condensate. These compounds are developed for paper as waterproofing agent, sizing agent, printing characteristic improver, wet strength improver and strength improver by incorporating a varying functional or hydrophobicizing group. They have the common feature of controlling the hydrogen bonding in paper. Such a hydrophilic group sealant is referred to as a detackifying, hydrogen bonding adjustor in this specification.

Next, the inventors of the present invention have studied monofunctional compounds, e.g., monofunctional epoxy and amine compounds, which can prevent formation of hydrogen bond derived from the hydrophilic group. Being monofunctional, they cannot crosslink the hydrophilic group. As a result, it is confirmed that these compounds, which are considered to bond to and hydrophobicize a hydrophilic group, bring about the effect similar to that by the above-described compounds.

Further, the inventors of the present invention have studied sizing agents used in the paper industry as the hydrophilic group sealants. The sizing agents are represented by a rosin-based one, rosin comprising abietic acid as the major ingredient. Rosin coats pulp fibers, by which it exhibits excellent hydrophobicizing effect. It has a large contact angle of 53° with water, and should have a notable effect as a hydrophobicizing agent. It has a very large contact angle of 130°, when bonded to aluminum, to bring about still larger hydrophobicizing effect. These sizing agents have the hydrophilic group sealing effect, as confirmed by the similar tests. The effect of sizing agent is considered to come from physicochemically or physically coating and hydrophobicizing the latex surface.

Recently, an alkyl ketene dimer (AKD), alkenyl succinic anhydride (ASA) and cationic sizing agent, among others, have been used as the sizing agents for neutral paper. These sizing agents working under neutral or alkaline conditions, and cationic sizing agents are confirmed to bring about the similar effects. The hydrophobicizing effect by AKD and ASA is generally believed to come from the chemical bond with a hydrophilic group. However, some argue that the compound loses its hydrophilicity as a result of self-decomposition on the fiber surfaces, to hydrophobicize itself as a whole, where the hydrophilic group works as an anchor.

Cationic sizing agents, e.g., styrene-based polyamidepolyamine epichlorohydrin resin modified with quaternary amino acid (disclosed by Japanese Patent Laid-Open No. 2001-32191), have been developed as the surface sizing agents for paper. These surface sizing agents, in particular cationic-based ones, work to detackify natural rubber latex products.

In any case, it is apparent that these sizing agents hydrophobicize the latex surfaces by sealing them chemically, physicochemically or physically. Such a sizing agent is referred to as a detackifying sizing agent in this specification.

A waterproofing agent is one of the compounds with improved hydrophobicizing effect and convenience, although functionally similar to the above-described hydrophilic group sealant. These agents are used to waterproof paper coating binders such as starch, protein, casein, PVA, and various types of latex. It is considered, from the objects for which it is used, that a waterproofing agent works as the suitable hydrophilic group sealant for the present invention. In fact, they show good results as confirmed by the similar tests. For example, ammonium zirconium carbonate, which is a crosslinking agent of tetravalent metallic element, is stable when incorporated in natural rubber latex and, being tetravalent, shows excellent detackifying effect, unlike the aluminum-based crosslinking agent of metallic element, which tends to gelate natural rubber latex when directly incorporated therein.

There are various compounds useful as waterproofing agents, including compounds having methylol group or lower alkylated compounds thereof, aldehyde-based compounds, compounds having epoxy or chlorohydrin group, compounds having ethyleneimine group, polyvinyl butyral-based compounds, and tri- or tetra-valent multi-valent metallic compounds. Each maker has been developing waterproofing agents one after another for hydrophobicizing and waterproofing purposes. They are also useful for detackifying natural rubber latex products, and are referred to as detackifying waterproofing agents in this specification.

There are specific waterproofing agents for specific hydrophilic polymers incorporated. For example, diborate shows a detackfying effect for polyvinyl alcohol. These specific agents are also included in the waterproofing agents useful for the present invention.

Water repellants, provided with water repellency, have been also developed. For example, aliphatic amide wax, aliphatic chromium complexes, aluminum stearate, chlorosulfonated polyethylene, ethylene urea-based resin, acrylic-based resin and silicone-based resin have been used as water repellants. They also exhibit a detackifying effect, as do the waterproofing agents.

The inventors of the present invention have also conducted the detackifying tests with releasing agents for natural rubber latex products in a manner similar to those with waterproofing agents, to confirm that these agents also work to detackify the products. Releasing agents are used for releasing paper, adhesive tape, process paper and transfer paper. Of these, aqueous or reactive ones are preferable. Non-silicone releasing agents are preferable for precision devices which are sensitive to silicone. The releasing agents capable of detackifying natural rubber latex products are referred to as detackifying releasing agents in this specification.

Protein considered as one of the tacky components of natural rubber latex is mostly acidic, and soluble in water or hydrophilic. The inventors of the present invention have considered that the protein in natural rubber latex can provides sites for reaction or adsorption for the hydrophilic group sealant.

Therefore, they have produced natural rubber latex products incorporated with various hydrophilic group sealants, e.g., anionic and nonionic surfactants, to find that the thick products are detackified but thinner ones (around 0.1 mm thick) remain tacky. These tacky products can be detackified, when their external surfaces are halogenated or coated with a detackified polymer, as described later. This means that the natural rubber latex product incorporated with the hydrophilic group sealant remains detackified inside. They have considered that the hydrophilic group sealant, itself or bonded to a tacky substance, is eluted out on the external surface of the natural rubber latex product.

One of the possible causes for elution of the hydrophilic group sealant is elution or leaching of the protein in the latex, which can provide the reaction or adsorption sites. It is considered that the acidic protein is in condition of fairly easily eluting out in latex, which is at a pH of around 10.5 to 11 in the case of high-ammonia latex and around 10 in the case of low-ammonia latex. Therefore, the inventors of the present invention have considered to reduce content of ammonia in latex. It is desirable to reduce its content upstream of the leaching step, because it is eluted out in this step. They have attempted to treat the natural rubber latex film incorporated with a hydrophilic group sealant in the leaching step after drying it under heating to evaporate ammonia, to find that the detackified natural rubber latex product is obtained without using a hydrophilic polymer. The drying treatment under heating conceivably have the effects of making the tacky substances insoluble or sparingly soluble, increased concentration of the hydrophilic group sealant, and sufficient bonding between the hydrophilic group sealant and tacky substances prior to the leaching step, in addition to evaporation of ammonia. It is also found that the natural rubber latex product is detackified by mere surface treatment with a nonionic, anionic, or cationic surfactant, when drying-treated beforehand.

The tests with various other hydrophilic group sealants, e.g., detackifying, hydrophobicizing crosslinking agents, waterproofing agents and sizing agents, have produced the similar results.

There are various agents, e.g., the above-described detackifying, hydrophobicizing crosslinking agents, which work as hydrophilic group sealants and are water-dispersible. Many of these hydrophilic group sealants are not eluted out in themselves, even when leaching-treated without undergoing the drying step at high temperature. Moreover, the natural rubber latex product is subjected to a drying step at high temperature anyway before it is completed. Therefore, it is possible to detackify a natural rubber latex product only with a hydrophilic group sealant without drying it at high temperature prior to the leaching step.

Next, the inventors of the present invention have studied to detackify the external and internal surfaces separately, known that the internal surface of a natural rubber latex product coming into contact with the mold can be detackified relatively easily, when it is incorporated with a hydrophilic group sealant.

More specifically, they have attempted to detackify the external surface by the method, e.g., coating with a detackified polymer, halogenation or crosslinking agent of tri- or tetra-valent metallic element which elutes the treatment agent to only a limited extent in the leaching step, and detackify the internal surface by one of the above-described method.

No treatment agent will be eluted out from the internal surface, which comes into contact with the mold but not normally with water. Moreover, the natural rubber latex product is subjected to a drying step at high temperature anyway before it is completed. Therefore, it is not necessary to seriously consider elution of the treatment agent for hydrophobicizing and detackifying the internal surface, which should widen a range of applicable hydrophilic group sealants.

The inventors of the present invention have first studied the coating with a detackifying polymer. Coating a natural rubber latex product on both surfaces with the diene-based carboxylated synthetic rubber latex they have invented can make the product detackified.

Next, they have studied to provide the detackifying polymer coating layer only on the external surface of the natural rubber latex product, and detackify the internal surface by the above-described various detackifying techniques, e.g., incorporation of a hydrophilic group sealant, to produce the product detackified as a whole, in consideration of the technical complexity and difficulty involved in the inner coating with the diene-based carboxylated synthetic rubber latex.

The coating layer of detackifying polymer provided on the internal surface may partly come off, when it is thin, while the product is being released from the mold, to cause defective product. The separated coating layer remaining in the mold will cause serious production problems, when the coagulating solution cannot run over that portion. Moreover, when the coating layer is sufficiently thick, the difference between the polymer coating layer and natural rubber layer in properties are more noted, to cause undesirable phenomena, e.g., interlayer exfoliation. On the other hand, the product with the internal surface coated with a detackifying natural rubber latex layer and external surface coated with a detackifying polymer coating layer can be easily released out of the mold, even when the coating layer is very thin. Moreover, the product free of defects, e.g., interlayer exfoliation, can be produced. A known technique can be used to coat the product with a detackifying polymer, but it is preferable to coat with the diene-based carboxylated synthetic rubber latex developed by the inventors of the present invention. The preferable diene-based carboxylated synthetic rubber latexes include NBR, SBR, CR and MBR. Coating the external surface of a natural rubber latex film with the detackifying, diene-based carboxylated synthetic rubber latex brings about another advantage of reduced pinholes in the product, resulting from double dipping.

The technique for detackifying the internal surface of the natural rubber latex product has been described in detail. The technique for the diene-based carboxylated synthetic rubber latex (PCT/JP00/03370) has been applied in such a way that the natural rubber latex film whose internal surface is detackified is immersed in a diluted solution of the detackifying diene-based carboxylated synthetic rubber latex. The external surface is detackified very easily, although the coating layer is very thin, less than 1 PHR. The product shows no quality defects, e.g., interlayer exfoliation.

The natural rubber latex product, detackified as well as the one coated with diene-based carboxylated synthetic rubber latex, is obtained when the external surface is coated with a polymer-based, detackifying releasing agent.

When a rubber glove is produced, it is turned inside out while being released out of the mold. It has the internal surface coated with a detackifying polymer layer, which, when detackified, can be worn more easily by a hand than a natural rubber latex product. Therefore, it can be worn or taken off more easily than a natural rubber latex product. Therefore, the natural rubber latex product of good wearing characteristics can be obtained without using powder.

The detackifying polymer coating layer can be vulcanized in the absence of sulfur. The synthetic rubber latex vulcanized without using sulfur has the external surface negative in the silver plate test, which tests the discoloration reaction between the contacting latex surface and metallic surface.

Non-sulfur vulcanization methods are not limited for the present invention, and known ones can be used. These include crosslinking with metals, e.g., zinc oxide, sodium aluminate and aluminum hydroxide, and vulcanization with peroxides. The coating layer is preferably vulcanized to an extent to prevent interlayer separation from the natural rubber latex layer, and to allow it to follow expansion of the natural rubber latex layer. The coating layer may be surface-coated with a polymer solution not intended for vulcanization, because it contributes to the product strength to only a limited extent.

Thus, the natural rubber latex product whose external surface is coated with the detackifying polymer layer can have advantages of both natural and synthetic rubber.

The natural rubber latex product whose external surface is coated with a detackifying polymer layer can be detackified on both external and internal surfaces by merely incorporating a hydrophilic group sealant without using a hydrophilic polymer. The similar results are obtained when an anionic or nonionic surfactant is used as the hydrophilic group sealant. A highly soluble agent, e.g., anionic or nonionic surfactant, incorporated in natural rubber latex will be eluted out in the leaching step for the production process from the external surface of the immersion-processed product, to make the product tacky as a whole. However, it will not be eluted out from the external surface when it is coated with a detackifying polymer layer, while the internal surface remains detackified because of no surfactant eluted out therefrom. As a result, the product is detackified as a whole. Thus, making the external surface detackified widens a range of the hydrophilic group sealants capable of detackifying the internal surface.

The diene-based carboxylated synthetic rubber latex can be detackified by, e.g., incorporating a carboxyl group sealant in the latex, or coating the latex with a carboxyl group sealant. The carboxyl group sealant is discussed in detail in PCT/JP00/03370, described earlier. It is a generic term for those agents, e.g., crosslinking agents of tri- or tetra-valent metal, organic crosslinking agents, various types of hydrophilicity adjustors, and sizing agents which act chemically, physicochemically or physically on the hydrophilic group in the diene-based carboxylated synthetic rubber latex to hydrophobicize and detackify the latex.

It is also found that the diene-based carboxylated synthetic rubber latex film has the surface of very high lubricity, when incorporated with various types of reactive cationic compounds, e.g., cationic epichlorohydrin-based resin as one type of the hydrophilicity adjustors. The natural rubber latex product has the detackified external surface of high lubricity, when coated in the similar manner with the diene-based carboxylated synthetic rubber latex incorporated with various types of reactive cationic compounds, e.g., cationic epichlorohydrin-based resin. When a rubber glove is produced, it is turned inside out, the external surface becoming the internal surface. The glove prepared in this manner has an advantage of being easily worn by a hand.

The synthetic rubber latex glove of or coated with the diene-based carboxylated synthetic rubber latex incorporated with a reactive cationic compound has the glove film of high lubricity, allowing it to be easily worn by a hand.

This means that the diene-based carboxylated synthetic rubber latex glove incorporated with a reactive cationic compound has an independent value.

The diene-based carboxylated synthetic rubber latex glove easily worn by a hand can be produced by incorporating a varying reactive cationic compound, e.g., cationic epichlorohydrin-based resin, in the latex.

Next, the inventors of the present invention have coated a natural rubber latex film with the diene-based carboxylated synthetic rubber latex incorporated with a carboxyl group sealant and/or hydrophilic group sealant, to find that the natural rubber latex product detackified on both surfaces can be produced, even when the latex is not treated to be detackified. It is considered that the carboxyl group sealant and/or hydrophilic group sealant, incorporated in the detackifying diene-based carboxylated synthetic rubber latex, diffuse into the natural rubber latex layer to make the product detackified as a whole.

Furthermore, the inventors of the present invention have provided a thin layer of a common diene-based carboxylated synthetic rubber latex not treated to be detackified over the natural rubber latex whose internal surface is detackified, to find that the detackifying natural rubber latex product is unexpectedly produced. It is considered that the hydrophilic group sealant, incorporated in the natural rubber latex, diffuse into the diene-based carboxylated synthetic rubber latex layer to make the layer detackified.

Next, the inventors of the present invention have studied halogenation of the external surface. Halogenation, although possibly causing environmental problems, forms a coating layer of halogenated hydrocarbon in a sense with the halogen atom bonded to the double bond in the rubber molecule on the natural rubber latex product surface. As a result, the halogenated surface of the rubber product is hydrophobicized and detackified while losing the inherent rubber characteristics. The rubber characteristics hinder wearing or taking off of the glove, when it is the rubber product. This is one of the reasons why many natural rubber latex products are halogenated. Halogenation causes many quality and environmental problems. One of the major problems viewed from production is that latex cannot be halogenated on-machine in the mold for both surfaces. Normally, the rubber shape is halogenated after being released out of the mold by a separate step, or its external surface is halogenated on-machine and then the internal surface is halogenated by a separate step after the shape is released out of the mold and turned inside out. Therefore, the halogenation should invariably deteriorate productivity.

Therefore, the inventors of the present invention have attempted to develop more efficient halogenation process for natural rubber by detackifying by on-machine halogenation for the external surface and by various detackifying techniques described earlier for the internal surface. More specifically, the natural rubber latex film incorporated with a hydrophilic group sealant is produced, and then halogenated for the external surface only. This produces the detackified natural rubber latex product. The halogenation can be effected on-machine, because it is only for one side.

When the product is glove, it has greatly improved wearing/taking-off characteristics, because it is turned inside out while being released out of the mold, the halogenated external surface becoming the internal surface. Thus, the treatment of only one side by halogenation is of high practical value, because the product can be halogenated on-machine and easily worn and taken off.

Moreover, the one-side halogenation greatly widens a range of the conditions under which the internal surface can be detackified and applicable detackifying treatment agents, like the coating treatment of the external surface with a detackifying polymer.

The third method of detackifying the external surface at low temperature, effected separately from the step of detackifying the internal surface, involves use of a highly reactive, hydrophilic group sealant, e.g., crosslinking agent of tri- or tetra-valent metallic element (e.g., polyaluminum hydroxide, zirconium acetate, zirconium oxychloride or titanium tetrachloride). The treatment agent, itself being charged positive, can be bonded even at low temperature to the external natural rubber latex surface, which is charged negative, causing little problems resulting from elution of the agent in the leaching step. When the crosslinking agent of metallic element is used, however, it is necessary to take some measures, e.g., leaching the latex before treatment with the agent, because, when the agent comes into contact with the film surface while it is highly alkaline and later heated, the powder of hydroxide or the like on the surface may be formed. The internal surface may be detackified in a manner similar to one of the two methods described earlier. The external surface can be detackified with another type of hydrophilic group sealant, needless to say. In such a case, however, it is necessary to allow the hydrophilic group sealant to sufficiently react at high temperature before the leaching step, when the external surface is leached after being treated with the hydrophilic group sealant.

The techniques for detackifying natural rubber latex products have been described in detail. The term “detackified” described above does not mean that the surface is not adhesive, but that the surfaces are not adhered to each other to an extent not causing practical problems when they come into contact with each other under pressure while the products are stored for several months, preferably 1 year, even in the absence of powder. In other words, they can be delivered to the markets as the powder-free natural rubber latex products. However, practicality test needs a long time, and it is convenient to determine whether they are detackified or not by the tackiness test. In this specification, those passing the test are regarded as being detackified.

The hydrophilic group sealant is the agent which chemically, physicochemically or physically seals the auxiliary components (e.g., protein and phospholipids) considered to cause tackiness of natural rubber latex and the hydrophilic group of the hydrophilic polymer intentionally incorporated in the latex, controls formation of the hydrogen bond, and makes the internal surface of a natural rubber product non-hydrophilic or hydrophobic. More specifically, it is an agent which detackifies the natural rubber latex product surface in the tackiness test conducted in EXAMPLES.

The carboxyl group sealant originally means the agent which chemically, physicochemically or physically seals the carboxyl group in the diene-based carboxylated synthetic rubber latex, controls formation of the hydrogen bond derived from the carboxyl group, and detackifies the latex. It is expanded to denote the agent which can contribute to detackifying a natural rubber latex product, because the tacky auxiliary components of natural rubber latex are protein, phospholipids and the like, and anionic substances. The carboxyl group sealant shares fairly many properties with the hydrophilic group sealant.

The detackifying crosslinking agent of tri- or tetra-valent metallic element means the crosslinking agent of tri- or tetra-valent metallic element having the detackifying effect. These agents are frequently cationic and water-soluble, but include water-insoluble ones, and also anionic ones, e.g., sodium aluminate and zirconium ammonium carbonate.

The detackifying, hydrophobicizing organic crosslinking agent for the present invention is not intended to form a vulcanizate of natural rubber latex, but to chemically, physicochemically or physically seal protein and phospholipids considered to be the tacky auxiliary components of natural rubber latex and the hydrophilic polymer intentionally incorporated in the latex, thereby detackifying the natural rubber latex product.

The detackifying hydrogen bond adjustor is an agent for introducing a varying functional group and hydrophobic group to adjust the hydrogen bonds in paper, and used as the printing characteristic improver, wet paper strength improver, waterproofing agent or the like. The detackifying hydrogen bond adjustor is the hydrogen bond adjustor which has a function of detackifying the natural rubber latex product.

The detackifying sizing agent is an agent to be incorporated in paper or used for surface treatment of paper to prevent running of ink on paper. The detackifying sizing agent is the sizing agent which has a function of detackifying the natural rubber latex product.

The detackifying waterproofing agent is an agent developed to insolubilize water-soluble polymers, e.g., coating binders (e.g., various types of latexes, protein, casein, starch and PVA). The detackifying waterproofing agent is the waterproofing agent which has a function of detackifying the natural rubber latex product.

The detackifying water repellant is developed to impart water repellency or waterproofness. The detackifying water repellant is the water repellant which has a function of detackifying the natural rubber latex product.

The detackifying releasing agent is an agent used for releasing paper, adhesive tape, process paper, transfer paper and the like. The detackifying releasing agent is the releasing agent which has a function of detackifying the natural rubber latex product.

The detackifying surfactant is the agent which acts on natural rubber latex, the hydrophilic polymer intentionally incorporated in natural rubber latex and diene-based carboxylated synthetic rubber latex, to make them non-hydrophilic or hydrophobic. More specifically, it is the surfactant which detackifies internal or external surface of natural rubber latex, as confirmed by the tackiness test.

Each of the above agents hydrophobicize chemically, physicochemically and physically protein and phospholipid considered to be the tacky, auxiliary components of natural rubber latex and the hydrophilic polymer intentionally incorporated, thereby preventing formation of the hydrogen bond and detackifying the product.

Original purposes for which these agents are developed do not matter, so long as they exhibit the detackifying effect. The hydrophilic group of carboxyl group sealant referred to in this specification is a general term for these agents.

The detackifying polymer coating layer includes the coating layer of detackifying diene-based carboxylated synthetic rubber latex and the known polymer coating layer believed to be detackifying.

The external surface means the surface which does not come into contact with the mold in the case of the immersion-processed product. When a glove is the product, the external surface is the internal surface of the glove, because it is turned inside out while being released out of the mold. Nevertheless, however, the external surface of the present invention means the surface which does not come into contact with the mold.

The internal surface is the surface which comes into contact with the mold.

The detackifying wound-up fingerstall is the fingerstall of natural rubber latex which is wound up in the absence of powder (both surfaces are pressed to each other) and can be smoothly wound back when in use.

As described above, use of the present invention can easily give the natural rubber latex product detackified on one or both surfaces. The product surfaces are not adhered to each other even when they come into contact with each other under heating during the production process or thereafter, a characteristic which can be used for producing novel products.

One example is the fingerstall of detackifying natural rubber latex which is wound up from its mouth on-machine before being released out of the mold. The fingerstall wound up from the mouth has been already developed. For example, referring to FIG. 4, the fingerstall 12 put on the fingertip 13 can be worn by simply winding it back on the finger in the arrowed direction, as shown in FIG. 5. Its usefulness has been recognized, because it can easily cover the finger. However, a fingerstall as a natural rubber latex product is inherently tacky on both surfaces, and the winding-up type is detackified beforehand with powder or post-treatment of chlorination and then manually wound up. Such a product is rarely used in a factory producing precision processed products, because of difficulty in keeping the products highly clean. On the other hand, the present invention provides a finger stall of natural rubber latex detackified on both surfaces, which can be mechanically wound up on the mold and keep the precision products highly clean. Recently, thinner fingerstalls are increasingly in demand to reduce fatigue of the wearer. A thinner fingerstall, however, is more difficult to wear, and hence thin, powder-free, detackified, clean, wound-up fingerstalls are strongly in demand.

The natural rubber latex detackified on both surfaces can be easily made into the fingerstall with a wound-up mouth. When a fingerstall is produced, the upper portion is left tacky without being provided with the hydrophilic group sealant layer or the like, and wound up totally and then wound back in such a way to leave the tacky portion as the wound-up mouth. In the conventional method, it is necessary to provide the wound-up mouth by first winding up only the upper portion of the fingerstall, and then releasing the fingerstall out of the mold in a separate step. The wound-up mouth is greatly in demand for flat products, because it facilitates wearing/taking-off of the fingerstall. A fingerstall can be detackified, after being provided with the wound-up mouth by the conventional method. The wound-up fingerstall described earlier can be provided with the wound-up mouth in a similar manner.

Referring to FIG. 5, when the fingerstall 12, wound up from the mouth to have the wound-up mouth, is taken off from the finger 14, it can be wound back on the finger easily except for the mouth, which is left tacky unlike the other portion. The fingerstall provided with a wound-up mouth can be easily worn/taken off by picking the mouth by other fingers. Depending on properties of the fingerstall, the wound-up mouth has a function of clamping the finger to keep the fingerstall held thereon.

It is possible to produce the wound-up fingerstall having no wound-up mouth by winding up the fingerstall which is detackified over the entire surface. The fingerstall having no wound-up mouth has an advantage of reducing fatigue of the person who wears it for a long time, because the finger is not fastened by the mouth.

It is found that quantity of protein eluted out of the natural rubber latex product incorporated with the hydrophilic polymer is generally larger than from the conventional one (Table 26). This will partly prove the controlled leaching of the tacky protein to the surface of the natural rubber latex product incorporated with the hydrophilic polymer during the production process. Nevertheless, however, this is a problem, although quantity of the protein eluted out can be reduced to the normal level by increasing temperature of the leaching step. In an attempt to solve the above problem, the technique described earlier for reducing allergen (WO97/08228) is applied to incorporate an epoxy compound in natural rubber latex. The analysis of the product indicates that the eluted protein quantity is not decreased but conversely increased. The similar results are obtained with the product treated with an organic crosslinking agent, e.g., epoxy compound, for both surfaces (Table 27). The above-described technique is originally developed to reduce allergenic substance by the reaction of allergenic substance eluted out and present in the vicinity of the natural rubber latex film surface with the epoxy compound or the like, on the assumption that allergenic substance is eluted out. It is found that the technique is not applicable to controlling elution of protein, because ε-amino group in protein which these compounds can react with is not necessarily present massively and the reaction products do not always become in-soluble in water.

Then, the inventors of the present invention have changed way of thinking, and studied to control elution of protein from the natural rubber latex product by chemical modification of the protein. For example, it is known that amino group in protein greatly changes in coagulation properties, when carboxylated by modifying the amino group in gelatin with phthalic or succinyl compound, because of decreased isoelectric point or changed electrostatic properties (Revised Fundamentals of Photography, Corona-sha, p.153).

They have first studied anionization of protein in natural rubber latex. It is believed that natural rubber latex contains protein at around 2%. If it totally remains in the product and then is eluted out therefrom, the eluted protein should reach around 20,000 μg/g. In actuality, however, it reaches only around 100 μg/g. It is known that protein in natural rubber latex is mostly acidic. Therefore, they have considered that anionic protein or protein having carboxyl group is fixed in a natural rubber latex product.

They have attempted to incorporate natural rubber latex with a reactive dye as the compound for introducing an anionic group in protein in latex. Such a dye is developed for cellulosic fibers to be dyed in an alkaline or neutral region, and known to react also with protein-based fibers. It should be noted that an anionic group, e.g., sulfonic group, is introduced in the reactive dye, to make it soluble in water. The result is decreased quantity of protein eluted out from the product, as expected. It is considered that the protein is fixed in the natural rubber latex product after reacting with the reactive dye. Fixation of the protein reacting with the reactive dye depends on properties of the reactive group in the dye, number of the reactive groups, easiness of its reaction with protein, its fixation-related properties and so on. The point is that protein in latex is insolubilized as a result of the reaction with the reactive dye. The reactive dye which can fix protein is referred to as the fixing reactive dye.

Recently, a variety of reactive dyes have been commercialized by, e.g., developing new functional groups and multi-functional dyes to increase fixation rate of the reactive dye on the fibers. As a result, the reactive dyes suitable for insolubilizing protein in natural rubber latex can be easily selected.

It is found that quantity of protein eluted out from natural rubber latex is also decreased, when the latex is incorporated with a compound having a structure of carboxylic anhydride. The similar effect is observed with an ionic starch showing the fixing ability when dissolved at high temperature.

For dying fibers with a reactive dye, a cationic fixing agent is used to prevent the dye from coming off from the fibers. The inventors of the present invention have treated natural rubber latex with a cationic, reactive fixing agent after it is incorporated with a reactive dye, to observe that no dye comes off in the leaching step and quantity of protein eluted out of the natural rubber latex product is decreased, as expected.

Next, the inventors of the present invention have treated a natural rubber latex product on both surfaces with a cationic reaction type fixing agent, to find that quantity of protein eluted out is decreased unexpectedly. Analysis of the chemical structure of the reaction type dye fixing agent indicates that it is a polyamine epichlorohydrin resin, polyamide polyamine epichlorohydrin resin or the like, by which is meant that it is almost the same as the compound used for detackifying the natural rubber latex product. The natural rubber latex product is prepared again using such an epichlorohydrin resin or the equivalent to measure quantity of protein eluted out. The result is a greatly decreased quantity.

It is also found that the quantity is also greatly decreased, when natural rubber latex is directly incorporated with the epichlorohydrin-based compound.

Furthermore, it is found that coating the external surface of natural rubber latex with the diene-based carboxylated synthetic rubber latex incorporated with cation-based compound decreases eluted quantity of protein to a very low level.

It is considered that the reactive cationic compound reacts with natural rubber latex to introduce the cationic group in the protein and insolubilizes itself, thereby fixing the protein in the natural rubber latex. Therefore, the decreased eluted quantity of protein results from the chemical modification by cationizing the protein in the natural rubber latex.

It is also confirmed that eluted quantity of the protein in the natural rubber latex is reduced in the presence of the crosslinking agent of tri- or tetra-valent metallic element, which is reactive with protein and cationic.

Furthermore, the inventors of the present invention have attempted to directly incorporate a cationic compound, which is considered to be unreactive with protein in the natural rubber latex. More specifically, they have incorporated a cationic starch, dissolved in water at high temperature, in natural rubber latex to also find decreased quantity of the protein eluted out from the natural rubber latex product. The cationic starch is insoluble in the product at normal temperature, and it is considered that the protein captured by the cationic starch is fixed in the natural rubber latex product. Such a cationic compound, not limited to cationic starch, contains a dispersant insoluble or sparingly soluble in water, or water-soluble cationic compound which is chemically insolubilized by a crosslinking agent or the like. An ampholytic compound, e.g., ampholytic starch, brings about the similar effect. An anion starch also brings about the similar effect, as described earlier.

The natural rubber latex product of controlled protein elution, as referred to herein, is treated by leaching to control the elution. Viewed from allergy caused by natural rubber latex, however, some argue to regulate the elution at 100 μg/g as the first target, followed by 50 μg/g as the second target, to prevent latex-caused allergy sensibilization (4^{th} LAF Meeting). Therefore, protein elution is preferably controlled at 50 μg/g or less. This level should be set according to thickness or the like and properties of the product. Some discuss that no allergy sensibilization will be caused by natural latex, when protein elution is controlled at 10 μg/g or less. Some of the natural rubber latex products of controlled protein elution of the present invention show a protein elution level of the order of 10 μg/g, even of the order of several μg/g. The level of protein eluted out from the product of the present invention is considered to be very low, knowing that the level of the protein-free carboxylated NBR latex product sulfur-vulcanized under the same conditions as those for natural rubber latex is 5 μg/g, as shown in Table 40. It is discussed that the JIS method tends to be disturbed by a vulcanization agent or the like to give a higher level of eluted protein (Tomoichi Kanou, et al, Proceedings of 6^{th} Japan Latex Allergy Meeting, 2001, Jul. 20).

The natural rubber latex product of controlled protein elution is not necessarily powder-free. The product with powder can be used for common purposes. Therefore, the present invention includes the natural rubber latex product of controlled protein and with powder.

However, the present invention can give the ideal natural rubber latex product of controlled protein and free of powder for use in production of precision processed products by combining the techniques of detackifying natural rubber latex products and controlling elution of protein. It is also possible to provide the product which causes no discoloration of a metallic surface and is not affected by sulfur for vulcanization by coating it with a layer of detackifying, carboxylated synthetic rubber latex or the like.

The present invention provides the following products:

1. A detackified natural rubber latex product, characterized in that both surfaces are provided with a detackified, diene-based carboxylated synthetic rubber latex coating layer.

2. A detackified natural rubber latex product with one or both surfaces detackified, characterized in that a natural rubber latex is incorporated with a detackifying hydrophilic polymer and/or hydrophilic group sealant.

3. A detackified natural rubber latex product with one or both surfaces detackified, characterized in that the surfaces of a natural rubber latex product are treated with a hydrophilic group sealant.

4. A detackified natural rubber latex product with one or both surfaces detackified, characterized in that a natural rubber latex is incorporated with at least one selected from the group consisting of nonionic polymer and anionic polymer, and cationic polymer and ampholytic polymer which cause no gelation of the natural rubber latex, and further with at least one selected from a hydrophilic group sealant and a carboxyl group sealant.

5. The detackified natural rubber latex product with one or both surfaces detackified according to any one of items 2 to 4, characterized in that an external surface of a natural rubber latex product or a natural rubber latex product incorporated with a hydrophilic group sealant and/or hydrophilic polymer is detackified by providing at least one layer selected from the group consisting of a detackified polymer layer, a halogenation treated layer, a layer treated with a detackifying crosslinking agent of tri- or tetra-valent metallic element, and a layer treated with at least one of a peroxotitania solution, peroxotitania sol, zirconia sol or alumina sol, a layer treated with a hydrophilic group sealant and a layer treated with a carboxyl group sealant.

6. A detackified natural rubber latex product with one or both surfaces detackified, characterized in that the detackified polymer coating layer, as set forth in item 5, on an external surface is a detackifying, diene-based carboxylated synthetic rubber latex coating layer or a detackifying, releasing agent coating layer.

7. A detackified natural rubber latex product with one or both surfaces detackified, characterized in that the detackifying polymer coating layer or the detackifying diene-based carboxylated synthetic rubber latex coating layer, as set forth in any one of items 1, 5 and 6, on an external surface is detackified by incorporating the polymer or a diene-based carboxylated synthetic rubber latex with a hydrophilic group sealant or a carboxyl group sealant.

8. A detackified natural rubber latex product with one or both surfaces detackified, characterized in that the detackifying polymer coating layer or the detackifying, diene-based carboxylated synthetic rubber latex coating layer, as set forth in items 1, 5 and 6, on an external surface is detackified by at least one selected from a hydrophilic group sealant and a carboxyl group sealant incorporated in the natural rubber latex.

9. A detackified natural rubber latex product with one or both surfaces detackified, characterized in that the detackifying polymer coating layer or the detackifying diene-based carboxylated synthetic rubber coating latex layer, as set forth in any one of items 1, 5 and 6, on an external surface is detackified by treating a surface of the polymer coating layer or diene-based carboxylated synthetic rubber latex coating layer with at least one selected from a hydrophilic group sealant and a carboxyl group sealant.

10. A detackified, lubricating, diene-based carboxylated synthetic rubber latex coat or product with one or both surfaces detackified, characterized in that a lubricating, diene-based carboxylated synthetic rubber latex coat or product, which is incorporated with a reactive, cationic compound or the lubricating, diene-based carboxylated synthetic rubber latex coat or product treated with one or more carboxyl group sealants.

11. The detackified natural rubber latex product with one or both surfaces detackified according to item 7, characterized in that an external surface is coated with a detackified, lubricating, diene-based carboxylated synthetic rubber latex incorporated with a reactive, cationic compound.

12. A detackified natural rubber latex product with one or both surfaces detackified, characterized in that an internal surface of the natural rubber latex product as set forth in any one of items 1 to 11 is detackified with at least one selected from a hydrophilic group sealant and a carboxyl group sealant incorporated in the natural rubber latex.

13. A detackified natural rubber latex product with one or both surfaces detackified, characterized in that an internal surface of the natural rubber latex product as set forth in anyone of items 1 to 11 is detackified with at least one selected from a hydrophilic group sealant and a carboxyl group sealant incorporated in the detackified polymer coating layer or detackifying, diene-based carboxylated synthetic rubber latex coating layer on an external surface.

14. A detackified natural rubber latex product with one or both surfaces detackified, characterized in that an internal surface of the product as set forth in any one of items 1 to 11 is detackified by providing a detackifying polymer layer, layer treated with detackifying crosslinking agent of tri- or tetra-valent metallic element, or a layer treated with a hydrophilic group sealant or a carboxyl group sealant.

15. A detackified natural rubber latex product with one or both surfaces detackified, characterized in that the detackifying polymer coating layer on an internal surface, as set forth in item 14, is a detackifying, diene-based carboxylated synthetic rubber latex coating layer.

16. A detackified natural rubber latex product with one or both surfaces detackified, characterized in that the detackifying polymer coating layer or the detackifying, diene-based carboxylated synthetic rubber latex coating layer, as set forth in item 14 or 15, on an internal surface is detackified by incorporating the polymer or the carboxylated synthetic rubber latex with at least one selected from a hydrophilic group sealant and a carboxyl group sealant.

17. A detackified natural rubber latex product with one or both surfaces detackified, characterized in that the detackifying polymer coating layer or the detackifying, diene-based carboxylated synthetic rubber latex coating layer, as set forth in items 14 or 15, on an internal surface is detackified by coating the internal surface of the polymer coating layer or the carboxylated synthetic rubber latex coating layer with at least one selected from a hydrophilic group sealant and a carboxyl group sealant.

18. A detackified natural rubber latex product with one or both surfaces detackified, characterized in that the detackifying polymer coating layer or the detackifying, diene-based carboxylated synthetic rubber latex coating layer on an internal surface, as set forth in items 14 or 15, is detackified with a hydrophilic group sealant or a carboxyl group sealant incorporated in the detackifying polymer coating layer or detackifying, diene-based carboxylated synthetic rubber latex coating layer, as set forth in any one of items 1 and 5 to 7, on an external surface, or with a hydrophilic group sealant or a carboxyl group sealant incorporated in the natural rubber latex.

19. A detackified natural rubber latex product with one or both surfaces detackified, characterized in that the hydrophilic, nonionic polymer, as set forth in item 4 or 5, has at least one hydrophilic group selected from the group consisting of hydroxyl (—OH), ether (—O—) and amide (—CONH₂—) groups.

20. A detackified natural rubber latex product with one or both surfaces detackified, characterized in that the hydrophilic, anionic polymer, as set forth in item 4 or 5, has at least one hydrophilic group selected from the group consisting of carboxyl (—COOM), sulfate ester (—OSO₃M), sulfonate (—SO₂OM), phosphate (—PO₃HM or —PO₃M₂), phosphate ester, —SO₂NH₂, and —SO₂NHCOR groups, where M is hydrogen atom, and alkali metal, ammonia or organoammonium; and R is an alkyl, phenyl which may be substituted or not, or naphthyl group which may be substituted or not.

21. A detackified natural rubber latex product with one or both surfaces detackified, characterized in that the hydrophilic, cationic polymer which causes no gelation of the natural rubber latex, as set forth in item 4 or 5, has at least one compound selected from the group consisting of amine salt (primary, secondary or tertiary), quaternary ammonium or pyridinium salt, phosphonium salt and sulfonium salt.

22. A detackified natural rubber latex product with one or both surfaces detackified, characterized in that the hydrophilic, ampholytic polymer which causes no gelation of the natural rubber latex, as set forth in item 4 or 5, has the hydrophilic group as set forth in items 20 and 21.

23. A detackified natural rubber latex product with one or both surfaces detackified, characterized in that the hydrophilic polymer, as set forth in any one of items 4, 5 and 19 to 22, is a water-soluble polysaccharide or derivative thereof.

24. A detackified natural rubber latex product with one or both surfaces detackified, characterized in that the water-soluble polysaccharide, as set forth in item 23, is selected from the group consisting of carboxymethyl cellulose, methyl cellulose, ureaphosphate-esterified starch, cationized starch, ampholytic starch, guar gum, phosphate-esterified guar gum, ampholytic guar gum, sodium alginate, carrageenan, locust bean gum, and xanthan gum.

25. A detackified natural rubber latex product with one or both surfaces detackified, characterized in that the hydrophilic polymer, as set forth in any one of items 4, 5 and 19 to 22, is water-soluble, water-sensitive or water-dispersible synthetic polymer.

26. A detackified natural rubber latex product with one or both surfaces detackified, characterized in that the hydrophilic polymer, as set forth in item 25, is selected from the group consisting of ammonium polyacrylate, ampholytic polyacrylamide, polyethylene oxide, polyvinyl alcohol, cationic polyamide resin, carboxylate-based acrylic copolymer, cationic acrylic copolymer, N-methoxymethylated polyamide modification (water-soluble nylon), acrylate ester copolymer, polyvinyl butyral, and cationic styrene/acrylic acid copolymer.

27. A detackified natural rubber latex product with one or both surfaces detackified, characterized in that the water-dispersible synthetic polymer, as set forth in item 25 is selected from the group consisting of polyvinyl acetate, ethylene-vinyl acetate copolymer, styrene-acrylate ester copolymer, styrene/methacrylate ester copolymer, acrylate ester copolymer, alkali-thickened acrylic-based emulsion, methacrylate ester copolymer, vinyl acetate/acrylic acid copolymer, vinyl acetate/acrylate ester copolymer, vinyl acetate/methacrylic acid copolymer, vinyl acetate/methacrylate ester copolymer, polyacrylamide, polymethacrylamide, copolymerized polyamide emulsion, acrylamide-based copolymer, methacrylamide-based copolymer, anionic, cationic and ampholytic modifications of these polymers, polyvinyl butyral emulsion, and polyolefin containing carboxyl group.

28. A detackified natural rubber latex product with one or both surfaces detackified, characterized in that the detackifying, hydrophilic polymer, as set forth in item 2, is at least one selected from the group consisting of methyl cellulose, locust bean gum, xanthan gum, carboxymethyl cellulose, alginate, carrageenan, and polyamide derivative.

29. A detackified natural rubber latex product with one or both surfaces detackified, characterized in that the hydrophilic group sealant or carboxyl group sealant, as set forth in anyone of items 2 to 18, is a detackifying crosslinking agent of tri- or tetra-valent metallic element.

30. The detackified natural rubber latex product with one or both surfaces detackified according to item 29, characterized in that the detackifying crosslinking agent of tri- or tetra-valent metallic element contains at least selected from the group consisting of aluminum, titanium and zirconium compounds.

31. A detackified natural rubber latex product with one or both surfaces detackified, characterized in that the hydrophilic group sealant or carboxyl group sealant, as set forth in any one of items 2 to 18 is at least one selected from the group consisting of peroxotitania solution, peroxotitania sol, zirconia sol and alumina sol.

32. A detackified natural rubber latex product with one or both surfaces detackified, characterized in that the hydrophilic group sealant or carboxyl group sealant, as set forth in any one of items 2 to 18, is a detackifying, hydrophobic, organic crosslinking agent for the hydrophilic polymer as set forth in item 4 or 5 and/or an auxiliary component of natural rubber latex.

33. A detackified natural rubber latex product with one or both surfaces detackified, characterized in that the detackifying, hydrophobic, organic crosslinking agent, as set forth in item 32, contains at least one selected from the group consisting of blocked isocyanate, oxazoline and carbodiimide.

34. The detackified natural rubber latex product with one or both surfaces detackified according to any one of items 2 to 18, characterized in that the hydrophilic group sealant or carboxyl group sealant contains at least one type of detackifying, hydrogen bond adjustors.

35. A detackified natural rubber latex product with one or both surfaces detackified, characterized in that the detackifying, hydrogen bond adjustor, as set forth in item 34, is selected from the group consisting of a polyamide compound, polyamide epoxy resin, polyaminepolyurea-based resin and polyamidepolyurea-based resin.

36. A detackified natural rubber latex product with one or both surfaces detackified, characterized in that the hydrophilic group sealant or the carboxyl group sealant as set forth in any one of items 2 to 18, and the compound reactive with the carboxyl group in the carboxylated synthetic rubber latex as set forth in item 10 or 11 are polyamide amine/epihalohydrin condensate, polyamine/epihalohydrin condensate, polyamidepolyurea/epihalohydrin condensate, polyaminepolyurea/epihalohydrin condensate, polyamideaminepolyurea/epihalohydrin condensate, polyamidepolyamine epichlorohydrin resin modified with a quaternary amino group, styrene-based polyamidepolyamine epichlorohydrin resin modified with a quaternary amino group, cation-modified urea resin, and cation-modified, epoxy-based polyamide resin.

37. A detackified natural rubber latex product with one or both surfaces detackified, characterized in that the hydrophilic group sealant or carboxyl group sealant, as set forth in any one of items 2 to 18, contains at least one compound selected from the group consisting of monofunctional amine, monofunctional epoxy compound, monofunctional isocyanate, monofunctional blocked isocyanate, alkyl ketene dimer (AKD), alkenyl ketene dimer, alkenyl succinic anhydride (ASA), aliphatic acid anhydride, and isocyanate aziridine derivative.

38. A detackified natural rubber latex product with one or both surfaces detackified, characterized in that the hydrophilic group sealant or the carboxyl group sealant, as set forth in any one of items 2 to 18, is a detackifying sizing agent.

39. A detackified natural rubber latex product with one or both surfaces detackified, characterized in that the hydrophilic group sealant or carboxyl group sealant, as set forth in any one of items 2 to 18 is a detackifying anionic, nonionic, or cationic surfactant.

40. A detackified natural rubber latex product with one or both surfaces detackified, characterized in that the detackifying waterproofing agent, as set forth in any one of items 2 to 18, acts on a tacky auxiliary component of the natural rubber latex, incorporated hydrophilic nonionic, anionic, cationic or ampholytic polymer, or a polymer coating layer or a carboxylated synthetic rubber latex coating layer.

41. A detackified natural rubber latex product with one or both surfaces detackified, characterized in that the detackifying waterproofing agent, as set forth in item 40, is a compound having a methylol group or lower alkylated compound thereof, aldehyde-based compound, a compound having an epoxy or chlorohydrin group, a compound having an ethyleneimine group, a polyvinyl butyral-based compound, or a tri- or tetra-valent multi-valent metallic compound.

42. A detackified natural rubber latex product with one or both surfaces detackified, characterized in that the detackifying waterproofing agent, as set forth in items 40 and 41, is polyamide epoxy resin, branched polyethylene imine, modified polyamine-based resin, polyamide-based resin, ketone resin, alkyl ketene dimer, ammonium zirconium carbonate, or blocked glyoxal resin.

43. A detackified natural rubber latex product with one or both surfaces detackified, characterized in that the hydrophilic group sealant or carboxyl group sealant, as set forth in any one of items 2 to 18, is a detackifying water repellant.

44. A detackified natural rubber latex product with one or both surfaces detackified, characterized in that the hydrophilic group sealant or carboxyl group sealant, as set forth in any one of items 2 to 18, is a detackifying releasing agent.

45. A natural rubber latex product of controlled protein elution, characterized by being treated with a compound which can introduce an anionic and/or cationic group in protein in the natural rubber latex.

46. The natural rubber latex product of controlled protein elution according to item 45, characterized in that the compound which can introduce an anionic and/or cationic group in the natural rubber latex is a compound reactive with protein in the natural rubber latex.

47. The natural rubber latex product of controlled protein elution according to item 45, characterized in that the compound which can introduce an anionic and/or cationic group in the natural rubber latex is a fixing compound or compound which can be fixed.

48. The natural rubber latex product of controlled protein elution according to item 46, characterized in that the compound which can introduce an anionic and/or cationic group in the natural rubber latex is reactive dye and derivative of carboxylic anhydride as anionic compounds; polyamideamine/epihalohydrin condensate, polyamine/epihalohydrin condensate, polyamidepolyurea/epihalohydrin condensate, polyaminepolyurea/epihalohydrin condensate, polyamideaminepolyurea/epihalohydrin condensate, polyamidepolyamine epichlorohydrin resin modified with a quaternary amino group, styrene-based, polyamidepolyamine epichlorohydrin resin modified with a quaternary amino group, cation-modified urea resin, cation-modified epoxy-based polyamide resin, crosslinking agent of multi-valent (trivalent or higher), and peroxotitania solution, peroxotitania sol, zirconia sol and alumina sol as cationic compounds.

49. The natural rubber latex product of controlled protein elution according to item 47, characterized in that the fixing compound which can introduce an anionic and/or cationic group in the natural rubber latex is anionic, ampholytic and/or cationic starch.

50. The natural rubber latex product of controlled protein elution according to any one of items 45 to 48, characterized in that the functional group reactive with protein of the compound which can introduce an anionic group in protein in the natural rubber latex is at least one selected from the group consisting of dichlorotriazine, difluorochlorotriazine, dichloroquinoxaline, monofluorotriazine, β-sulfatoethylsulfone, monochlorotriazine, trichloropyrimidine, carboxypyridino-S-triazine, α-bromoacrylamide, acrylamide, ω-chloroacetyl, epoxy and carboxyl anhydride.

51. A natural rubber latex product of controlled protein elution, characterized by being treated with a waterproofing agent (ketone resin) reactive with protein in natural rubber latex under an alkaline condition and capable of fixing the protein.

52. A detackified natural rubber latex product of controlled protein elution, characterized by being treated in a manner as set forth in any one of items 45 to 51, and also in a manner as set forth in any one of items 1 to 42.

53. A producing method of the detackified natural rubber latex product with one or both surfaces detackified, and/or the natural rubber latex product of controlled protein elution, as set forth in any one of items 1 to 52, characterized by being leaching-treated subsequent to drying at high temperature.

54. The detackified natural rubber latex product with one or both surfaces detackified, and/or the natural rubber latex product of controlled protein elution, according to any one of items 1 to 52, characterized by being a fingerstall, glove, balloon or condom.

55. A finger stall of a detackified natural rubber latex with one or both surfaces detackified, and/or a natural rubber latex of controlled protein elution, characterized in that the finger stall of the detackified natural rubber latex and/or natural rubber latex of controlled protein elution as set forth in item 54 has a shape of being mechanically wound up from a mouth before being released out of a mold.

### BRIEF DESCRIPTION OF THE DRAWINGS

FIG. 1 is an oblique view of the immersion type carrier for the present invention.

FIG. 2 describes a prototype production unit for the fingerstall of the present invention.

FIG. 3 describes functions of the major parts of the winding-up unit.

FIG. 4 shows the cross-section of the wound-up finger stall put on a finger.

FIG. 5 describes the cross-section of the fingerstall wound on the finger.

The symbols are 1: chain, 2: guide rail, 3: immersion mold, 4: rod, 5: guide, 6: immersion tank, 7: drying furnace, 8: winding-up machine, 10: roll type brush, 11: film, 12: fingerstall, 13: fingertip, 14: finger, and 15: wound-up mouth.

### BEST MODE FOR CARRYING OUT THE INVENTION

The present invention is described in detail.

The natural rubber latex for the present invention is not limited, but generally high-ammonium latex and low-ammonium latex. Recently, deprotenized natural rubber latex has been commercialized (e.g., Japanese Patent Laid-Open No. 6-56902), and it is also included in the latex useful for the present invention.

The method of vulcanizing the natural rubber latex is not limited, and the common vulcanization methods, e.g., those aided by sulfur, peroxide or radioactive ray, can be used.

Those latex products for which a measure is required to prevent tackiness include immersion-processed products (e.g., balloon, glove, fingerstall and condom); extruded products (e.g., rubber yarn and tube); formed products (e.g., balloon and toys); totally rubber products (e.g., rubber sheet, hose and cloth), and rubber-lined products, although not limited thereto.

The hydrophilic polymer to be incorporated in the natural rubber latex is not limited. A natural, semi-synthetic or synthetic one can be suitably used.

The hydrophilic polymer is not necessarily soluble in water. A water-dispersible polymer can be also effective. For synthetic polymer, in particular, a water-dispersible polymer molecular-designed to be soluble in alkaline natural rubber latex can be easily synthesized.

A great deal of literature describes hydrophilic polymers, and representative ones include Advanced Technology of Water-Soluble Polymers (edited by Teruo Horiuti, CMC, May 2000)and Chemistry and Technology of Water-Soluble Polymers (edited by Finch, C. A., Plenum Press, 1983).

Hydrophilic natural polymers include polysaccharide-, microorganism- and animal-based water-soluble polymers, represented by alginic acid, gum arabic, carrageenan, guar gum, locust bean gum, pectin, tamarind gum, tragacanth gum, starch, xanthan gum, agar, konjaku mannan, galactomannan, dextran, pullulan, curdlan, welan gum and chondroitin sulfuric acid.

The representative semi-synthetic, hydrophilic polymers include cellulose-, starch- and alginic acid-based water-soluble polymers. Cellulose-based polymers include ethyl cellulose, carboxymethyl cellulose, hydroxyethyl cellulose, ethylhydroxyethyl cellulose, hydroxypropyl cellulose, methylhydroxypropyl cellulose, methyl cellulose, and cationized, anionized and ampholytic cellulose.

Starch-based polymers include oxidized starch, and starch derivatives (esterified starch (e.g., acetylated and phosphate-esterified starches), etherified starch (e.g., methylated and hydroxyethylated starches), carboxymethylated starch, anionic starch substituted with a hydrophobic group, crosslinked starch, anionized starch, cationized starch, ampholytic starch, among others).

Alginic acid-based polymers include propylene glycol alginate, and guar-gum-based polymers include cationized, anionized and ampholytic guar gums.

The method of producing the semisynthetic, water-soluble polymer is not limited, and a known method can be used. For example, a starch-based semisynthetic, water-soluble polymer can be produced by the following methods.

For example, National Publication of International Patent Application No. 10-505135 describes various methods of producing chemically modified starch, including oxidation, phosphorylation, etherification and esterification of starch, and the methods of producing cationized, ampholytic and anionized starch can be also referred to. Japanese Patent Laid-Open No. 9-110902 discloses a method of producing starch substituted with a hydrophobic group.

P. Molyneux discloses hydrophilic polymers, in particular homopolymers and copolymers for water-soluble, synthetic polymers (“Chemistry and technology of water-soluble polymers”, edited by Finch, C. A., p.1 to 13), raising the following representative hydrophilic synthetic polymers.

The hydrophilic or water-soluble homopolymers include water-soluble acrylic-based polymers (polymers of polyacrylic acid, polyacrylate ester, polyacrylamide) and derivatives thereof, nonionic polyacrylamide, anionic polyacrylamide, cationic polyacrylamide, ampholytic polyacrylamide, poly-(N,N-dimethyl-acrylamide, poly-(N-isopropyl-acrylamide), polyaminomethyl acrylamide, polyacrylamide modified by the Mannich reaction, polyacrylamide modified by the Hofmann reaction, polymethacrylic acid and polymethacrylamide), polyimines (polyethyleneimine), polyoxides (polyethylene oxide, polypropylene oxide and polyoxolan), water-soluble vinyl-based polymers (polyethylene sulfonate, polystyrene sulfonate, polyvinyl alcohols and derivatives thereof (polyvinyl alcohol, anion-modified polyvinyl alcohol, cation-modified polyvinyl alcohol and acetal-modified polyvinyl alcohol), polyvinyl amine, polyvinyl methoxyacetal, polyvinyl methyl ether, polyvinyl methyloxazolidone, polyvinylpyrrolidone, poly-4-vinyl-pyridine, poly-4-vinyl-pyridine, poly-4-vinyl-pyridine-N-oxide, poly-4-vinyl-N-alkyl-pyridinium salt, polyvinyl sulfuric acid, polyvinyl imidazoline, carboxyvinyl polymer), water-soluble polyurethane, water-soluble polyester resin, polyamide-based polymer and derivative thereof, and polyamide resin.

The representative water-sensitive homopolymers include acrylic-based polymers (polymethyl acrylate, polymethyl methacrylate, poly-2-hydroxyethyl methacrylate and poly-ethylene glycol monomethacrylate), polyoxides (polyoxymethylene, poly-trimethylene oxide and polyacetoaldehyde), vinyl-based polymers (polyvinyl ethylether, polyvinyl acetate, polyvinyl formal and polyvinyl butyral).

Water-soluble or water-sensitive copolymers include acrylamide/acrylic acid copolymer, acrylic acid/methyl acrylate copolymer, ethylene oxide/propylene oxide copolymer, maleic anhydride-based copolymer, maleic anhydride/acrylic acid copolymer, maleic anhydride/alkene copolymer, maleic anhydride/styrene copolymer, maleic anhydride/vinyl alkyl ether copolymer, methacrylamide/methacrylic acid copolymer, methacrylic acid/methyl methacrylate copolymer, styrene/styrene sulfonate copolymer, styrene/vinyl pyrrolidone copolymer, vinyl pyrrolidone/vinyl acetate copolymer, vinyl pyrrolidone/dimethylaminoethyl methacrylate copolymer, quaternary vinyl pyrrolidone/dimethylaminoethyl methacrylate copolymer, vinyl pyrrolidone/methacrylamidepropyl/trimethyl ammonium chloride copolymer, vinyl acetal/vinyl alcohol copolymer, vinyl acetate/vinyl alcohol copolymer, vinyl alcohol/vinyl sulfate copolymer, styrene/acrylic resin, ethylene/acrylic acid copolymer, and aminoalkyl methacrylate and acrylamide copolymer thereof.

Hydrophilic polymers may be water-dispersible synthetic ones. The examples include polyvinyl acetate, ethylene/vinyl acetate copolymer, styrene/acrylate ester copolymer, styrene/methacrylate ester copolymer, acrylate ester copolymer, methacrylate ester copolymer, vinyl acetate/acrylic acid copolymer, vinyl acetate/acrylate ester copolymer, vinyl acetate/methacrylic acid copolymer, vinyl acetate/methacrylate ester copolymer, polyacrylamide, polymethacrylamide, acrylamide copolymer, methacrylamide copolymer, and anion-, cation- and ampholytic-modifications thereof. These water-dispersible polymers include polymers that dissolve or are designed to dissolve under alkaline conditions when added to natural rubber latex.

Hydrophilic polymers can fall into four categories of nonionic, anionic, cationic and ampholytic by their ionic characteristics. Natural rubber latex is charged negative. Therefore, care must be taken, when a hydrophilic polymer is incorporated in latex, not to be gelated. A nonionic and anionic polymer will be rarely gelated, when incorporated in latex. On the other hand, a cationic and ampholytic polymer tends to be gelated, and hence it is necessary to select the polymer causing no gelation. Such a hydrophilic polymer is referred to as the cationic or ampholytic hydrophilic polymer causing no gelation in this specification. Generally speaking, a low-molecular-weight and weakly cationic hydrophilic polymer is suitable, although tendency to gelation varies depending on, e.g., type and molecular weight of polymer, and type and quantity of the cationic group.

When incorporated with a hydrophilic polymer, natural rubber latex often increases in viscosity. A moderate increase of viscosity should cause no special problem, and can be coped with by, e.g., dilution of the natural rubber latex. An excessive increase, however, is undesirable. It is necessary to take an adequate measure, e.g., selection of a hydrophilic polymer of low molecular weight.

The hydrophilic polymers, in particular natural and semi-synthetic ones, often cause the so-called creaming phenomenon, when incorporated in natural rubber latex. When such a phenomenon occurs, it is necessary to prevent separation of the serum by moving the latex solution.

The nonionic, hydrophilic polymer generally has at least one hydrophilic group of hydroxyl (—OH), ether (—O—) or amide (—CONH₂—).

The anionic, hydrophilic polymer generally has at least one anionic hydrophilic group selected from the group consisting of carboxyl (—COOM), sulfate ester (—OSO₃M), sulfonate (—SO₂OM), phosphate (—PO₃HM or —PO₃M₂), phosphate ester, —SO₂NH₂, and —SO₂NHCOR groups, wherein M is hydrogen atom, and alkali metal, ammonia or organoammonium; and R is an alkyl, phenyl which may be substituted or not, or naphthyl group which may be substituted or not. However, the anionic, hydrophilic polymer for the present invention is not limited by the anionic, hydrophilic group.

The above-described anionic group is introduced as the derivative produced by the known chemical reaction in the presence of an anionic reagent in the case of semi-synthetic polymer, and by the copolymerization with an anionic reagent in the case of synthetic polymer. In the latter case, an anionic group can be introduced by the methods described below for ampholytic polyacrylamide.

The examples of the representative anionic, hydrophilic polymers include natural polymers, e.g., gum arabic, carrageenan, pectin, xanthan gum, chondroitin sulfuric acid and alginate; semi-synthetic polymers, e.g., carboxymethyl cellulose, anionized starch (e.g., phosphate-esterified starch and carboxymethylated starch), anionized guar gum. The anionic, synthetic polymers include homopolymer or copolymer of acrylic acid or methacrylic acid; copolymer of acrylic acid and acrylamide polyhydroxycarboxylate; copolymer of acrylic acid or methacrylic acid and monoethylenic monomer (e.g., ethylene, styrene, vinyl ester, acrylate ester and methacrylate ester); copolymer derived from crotonic acid; copolymer containing at least one monomer of maleic acid, fumaric acid, itaconic acid and anhydride thereof, and at least one monomer of vinyl ester, vinyl ether, halogenated vinyl and phenyl vinyl derivative, and acrylic acid and ester thereof; copolymer containing at least one anhydride of maleic acid, citraconic acid and itaconic acid, and at least one monomer of allyl and methallyl esters; and carboxyl-containing polyacrylamide (National Publication of International Patent Application No. No. 10-511990). The anionic, hydrophilic polymers for the present invention also include even a polyolefin which has carboxyl group introduced by, e.g., copolymerization of the olefin and composition of a monomer containing an unsaturated carboxylic acid, or oxidation of the polyolefin.

The cationic, hydrophilic polymer is characterized by having at least one cationic, hydrophilic group selected from the group consisting of amine salt (primary, secondary or tertiary), quaternary ammonium or pyridinium salt, phosphonium salt and sulfonium salt.

The cationic group can be introduced by a known chemical reaction, as is the case with the anionic group. For cationized starch, for example, diethylaminoethyl ether group is introduced by the reaction with 2-diethylaminoethyl chloride hydrochloride, 3-(trimethyl ammonium chloride)-2-hydroxypropyl ether group is introduced by the reaction with 3-chloro-2-hydroxypropyltrimethyl ammonioum chloride as the representative cationic or cation-producing group, or tertiary amino group is introduced by the reaction with a dialkylaminoalkyl halide and made quaternary to produce ammonium (National Publication of International Patent Application No. 10-505139). Introduction of the cationic group in a semi-synthetic and synthetic polymer is described later for the ampholytic polymer.

The examples of the cationic polymers include cationic polyacrylamide (e.g., aminoalkyl methacrylate and acrylamide copolymers), polyvinyl pyridium ammonium halide, polyallyl ammonium halide, polyaminomethylacrylamide, polyvinyl imidazoline, polyacrylamide modified by the Mannich reaction, polyacrylamide modified by the Hofmann reaction, polyethyleneimine, polydiallylamine, polypiridium halide, cationized starch, cationized cellulose, cationized guar gum, cationized polyvinyl alcohol, epoxyamine-based condensate, ionene-based condensate, cationized polymethacrylate ester resin, alkylene diamine-epichlorohydrin polycondensate, cationized polyvinyl pyrrolidone.

The ampholytic, hydrophilic polymer has both anionic and cationic hydrophilic groups described above. The type and production method are not limited. The synthetic polymers include quaternary copolymer of a monomer containing sulfonic acid (or its salt) with monomer containing tertiary amino group; polymers and copolymers of monomers having quaternary ammonium group and sulfonate group; copolymer of a monomer containing carboxylic acid (or its salt) with monomer containing tertiary amino group, including the copolymer made quaternary (e.g., octylacrylamide/butylaminoethyl methacrylate/acrylate ester copolymer); and polymer and copolymer of a monomer containing carboxyl group and quaternary ammonium (e.g., dialkylaminoethyl methacrylate polymer made ampholytic with monochloroacetic acid, disclosed by Japanese Patent 2571980).

For semi-synthetic polymers, e.g., ampholytic starch, the starch is treated doubly with a cation and anion modifier. In particular, introduction of a cation group by the aid of a tertiary amino or quaternary ammonium group is combined with introduction of an anion group by the aid of an anionic group, e.g., phosphate, sulfonate, sulfate or carboxyl (National Publication of International Patent Application No. 10-505139).

Next, for synthetic polymers, introduction of an anionic and cationic group is described taking an ampholytic polyacrylamide as the example, which can be produced by copolymerizing (a) acrylamide or methacrylamide, (b) anionic vinyl monomer, and (c) cationic vinyl monomer.

The anionic vinyl monomers include α, β-unsaturated monobasic acids, e.g., (meth)acrylic acid, crotonic acid, (meth)allylcarboxylic acid; α,β-unsaturated dibasic acids, e.g., maleic acid, fumaric acid, itaconic acid and muconic acid; and organic sulfonic acid, e.g., vinyl sulfonic acid, styrene sulfonic acid, 2-acrylamide-2-methylpropane sulfonic acid and (meth)allyl sulfonic acid. One or more of these vinyl monomers can be used, without being limited.

The cationic vinyl monomers include vinyl monomers having a tertiary amino group, e.g., N,N-dimethylaminoethyl (meth)acrylate, N,N-diethylaminoethyl (meth)acrylate and N,N-dimethylaminopropyl (meth) acrylamide; and vinyl monomers containing a quaternary ammonium salt, obtained by reacting a vinyl monomer containing a tertiary amino group with an agent, e.g., methyl chloride, benzyl chloride, dimethyl sulfuric acid or epichlorohydrin which works to make the above monomer quaternary.

The other methods of introducing a cationic group include Mannich modification which reacts an anionic polyacrylamide with formalin and a secondary amine, Hofmann modification which reacts an anionic polyacrylamide with hypohalogenic acid, and amide-exchanging reaction with polyamine.

The methods of introducing an anionic group include hydrolysis of amide group under an alkaline condition, and sulfomethylation.

The hydrophilic polymer is incorporated in natural rubber latex, and normally treated with the hydrophilic group sealant, to hydrophobicize the natural rubber latex product. The hydrophilic group sealant works to hydrophobicize the tacky, auxiliary component (e.g., protein or phospholipids) of the natural rubber latex, to detackify the natural rubber latex product.

Incorporation of the hydrophilic polymer is intended to immobilize the tacky, auxiliary component of the natural rubber latex (e.g., protein or phospholipids), to prevent it from leaching to the natural rubber latex product surface. On the other hand, the hydrophilic group in the hydrophilic polymer can form the hydrogen bond, to possibly increase tackiness of the product. Therefore, hydrophobization of the hydrophilic polymer is important, because extent of hydrophilicity and hydrophobicity of the hydrophilic polymer affect detackified extent of the natural rubber latex product. Positive introduction of a hydrophobic group, e.g., anionic starch to introduce the hydrophobic group, is one method. For example, it is necessary to use a polymer made water-soluble by incorporated hydrophobic methyl group (e.g., methyl cellulose) or polymer with controlled extent of the hydrophilic group introduced, in order to control tackiness of the hydrophilic polymer itself. For example, it is known that cationized cellulose can be hydrophobicized by electrostatically bonding thereto a fatty acid salt as an anionic surfactant, to increase its hydrophobicity (Teruo Horiuchi, et al, shougi-shi, 15(1), 83 (1983)).

Even the anionic, hydrophilic polymer can show the hydrophobicizing effect in the presence of calcium ion or the like, conceivably because of formation of the chemical bond with a substance having an anionic surfactant activity. It should be noted that natural rubber latex contains an auxiliary component having a hydrophobic group, e.g., phospholipid. Moreover, there is natural rubber latex dispersed with latex by the aid of a surfactant, e.g., deprotenized natural rubber latex.

Therefore, some natural rubber latex products can be detackified only with the hydrophilic polymer incorporated in the natural rubber latex, when it is treated in the leaching step after being dried under heating at high temperature to evaporate ammonia incorporated in the natural rubber latex. However, it is difficult to judge whether a specific hydrophilic polymer has a detackifying effect. On the other hand, the judgement can be easily done by the tackiness test, conducted in EXAMPLES. In the present invention, the hydrophilic polymer is specifically referred to as the detackifying, hydrophilic polymer, when the product of the natural rubber latex incorporated only therewith is detackified, as judged by the tackiness test. The examples of the detackifying, hydrophilic polymers include methyl cellulose, locust bean gum, xanthan gum, carboxymethyl cellulose, alginate, carrageenan and polyamide derivative.

The hydrophilic group sealant for the present invention is the compound which chemically, physicochemically or physically acts on the hydrophilic group in the natural rubber latex incorporated with the hydrophilic polymer to hydrophobicize the latex, thereby controlling formation of the hydrogen bond derived from the hydrophilic group, hydrophobicizing the natural rubber latex as a whole, and detackifying the natural rubber latex product. The hydrophilic group sealant mainly acts on the tacky, auxiliary components of the natural rubber latex (e.g., protein and phospholipids) and/or the hydrophilic polymer intentionally incorporated to hydrophobicize the latex, but it is still an important function for the sealant to physicochemically or physically hydrophobicize the natural rubber latex itself.

The hydrophilic group sealants are represented by, first of all, crosslinking agents of tri- or tetra-valent detackifying metallic element. Such crosslinking agents are not limited, but it is necessary to sufficiently consider stability of the compound and side-effects, e.g., discoloration. The examples of the crosslinking agents of tri- or tetra-valent metallic element useful for the present invention as the ones to be externally added to the latex include water- or alcohol-soluble, trivalent, detackifying metallic element compounds, e.g., salts of aluminum, ferric iron, chromium and thorium, of which aluminum salts (e.g., aluminum chloride, nitrate, sulfate and acetate) are more practically more suitable.

Polyaluminum chloride (PAC) and water-soluble polyaluminum hydroxide, being tri- or tetra-valent, are still more suitable. In particular, the latter is effective. A salt of metallic acid can be used, when the metal is ampholytic, and sodium aluminate is one example. The observation suggests that sodium aluminate is converted into aluminum hydroxide on the film covering the latex surface and then crosslinked.

The aluminum-based inorganic crosslinking agents to be incorporated in latex beforehand include aluminates of alkali metal (e.g., water-soluble sodium aluminate), aluminates of alkali-earth metal (e.g., sparingly soluble calcium aluminate), and aluminum hydroxide gel. The agents also include various other aluminum compounds, e.g., magnesium methasilicate aluminate, synthesized hydrotalcite, aluminosilica gel and alumino silicate. In other words, these compounds are not dissociated into the ionic aluminum when incorporated, but crosslink the hydrophilic group in the latex with the ions when heated. It is considered that these compounds crosslink the latex by the ions after being converted into aluminum hydroxide.

Common crystalline aluminum hydroxide rarely takes part in the crosslinking reaction, but the so-called amorphous aluminum hydroxide does take part in the reaction, when dispersed by, e.g., ball-milling, to have an increased specific surface area.

An aluminum-based crosslinking agent, when incorporated in natural rubber latex, may be gelated as time passes, depending on, e.g., type of natural rubber latex or anionic, hydrophilic polymer used. It is therefore necessary to individually consider the pot life or the like of the product.

The detackifying compounds of tetravalent metallic element useful for the present invention include zirconium compounds, e.g., zirconium nitrate, zirconium ammonium carbonate, zirconium carbonate W, zirconium ammonium carbonate oxychloride, zirconium oxychloride; trivalent titanium compounds, e.g., titanium trichloride; and tetravalent titanium compounds, e.g., titanium sulfate, titanium tetrachloride, titanium lactate, titanium maleate anhydride and titanium oxalate.

Moreover, there are inorganic compounds which detackify latex by forming a uniform film thereon. These include peroxotitania solution, peroxotitanate solution, peroxotitania sol, zirconia sol and alumina sol.

Peroxotitania in the form of solution is a titanium oxide having peroxo group (—O—O—), existing as the monomer or polymer. The polymer is generally referred to as peroxotitanate, and soluble in water. Zirconium-doped peroxotitanate or the like in the form of aqueous solution is known as one of the peroxotitanates, and is also included as the one useful for the present invention (Japanese Patent Laid-Open No. 7-286114) The commercial products of peroxotitanium complex include Teika's TKS-301 and Sadic's TPA in the form of aqueous solution.

Various methods have been proposed for producing peroxotitania sol, zirconia sol and alumina sol, and the commercial products of titania sol include Teika's TKS-203 and Sadic's TO sol.

The methods for producing alumina sol are disclosed by, e.g., Japanese Patent Laid-Open Nos. 05-02623, 05-024824, 07-291621 and 10-087324, and Nissan Chemical Industries' alumina sol 100, 200 and 520 are known as the commercial products of alumina sol.

These compounds have been originally developed as the coating agents to form a uniform film on the metallic surface or the like. They can form chemical bonds, hydrogen bond or the like with various functional groups, and, when used for surface treatment of natural rubber latex, not only form the coating film on the surface but also form a strong bond with the latex film to control exfoliation of the coating film.

When the crosslinking agents of tri- or tetra-valent detackifying metallic element are water-soluble metallic salts, the metallic ions of many salts are dissociated to be cationic, becoming reactive with the anionic, hydrophilic group even at low temperature. Moreover, they show a strong coagulating function, following the Schultz-Hardy law. The metallic salts, e.g., sodium aluminate and zirconium ammonium carbonate, are anionic, and can be directly incorporated in latex, because they will not immediately react with latex.

The detackifying compounds of tri- or tetra-valent metallic element useful for the present invention also include organic compounds. They are represented by, but not limited to carboxylates, and include aluminum acetate, zirconium acetate, titanium lactate, titanium maleate anhydride, titanium oxalate and titanium butyrate.

The second examples of the hydrophilic group sealants are organic crosslinking agents for detackifying/hydrophobicizing the hydrophilic polymer incorporated in the natural rubber latex and/or auxiliary components (e.g., protein and phospholipids) of the latex.

Polymers of low intermolecular cohesive energy, such as rubber, will have greatly improved mechanical properties, when their molecules are crosslinked with each other. Natural rubber may not exibit the inherent rubber characteristics, until it is crosslinked to form the vulcanizate. Crosslinking agents for vulcanizing rubber are mostly of sulfur by far. There are various non-sulfur crosslinking agents for vulcanization, including sulfur donor, thiuram, thiourea, bis-mercapto, S—Cl compound, resin, compound having a reactive nitrogen group, compound having a reactive olefin group and peroxide, and ionic agents. However, the natural rubber latex product cannot be detackified by vulcanization with these agents.

Any organic crosslinking agent may be used, irrespective of type, so long as it has an effect of detackifying/hydrophobicizing the auxiliary components of the latex or hydrophilic polymer intentionally incorporated in the natural rubber latex. It is however difficult to judge beforehand the properties of the crosslinking agent to be used, e.g., type and number of the functional group therein, and whether or not it has a hydrophobic group, it is self-crosslinking, the decomposed crosslinking agent is detackifying, and it is sufficiently reactive under the natural rubber latex product production conditions to prevent the surfaces of the products being stored from adhering to each other. It is therefore convenient to screen a crosslinking agent capable of detackifying natural rubber latex whether it has a hydrophobicizing effect by the tackiness test. It is necessary to select the detackifying, hydrophobicizing agent from the crosslinking agents of, e.g., epoxy compound; blocked isocyanate, oxazoline-based compound; carbodiimide-based compound; melamine-formaldehyde resin; urea-formaldehyde resin; isocyanate; phenol-formaldehyde resin; glycol and polyol; diamine and polyamine; hexamethoxymethylmelamine; methylol acrylamidemethacry; (Latest Application Technologies of Latex Emulsion, edited by Motoji Okikura, Chunichi-sha, P.323), polyvalent acryloyl compound and polyvalent active ester compound. The polyvalent acryloyl compound is obtained by the dehydration to combine a compound selected from the group consisting of polyhydric alcohol, polyester and polyurethane with acrylic acid through the ester bond, or the ester exchanging reaction between the above-described compound and acrylate ester. The polyvalent active ester compounds specifically include oxalate diester and malonate diester (Japanese Patent Laid-Open No. 09-125023). The crosslinking agent which works to seal hydroxyl group in protein or additive (e.g., hydrophilic polymer) is also useful.

The organic crosslinking agent for detackifying/hydrophobicizing the hydrophilic group generally needs a fairly high reaction temperature. However, it brings about its inherent effect at around 90 to 120° C. for the present invention, because it is incorporated in a small quantity.

The detackifying organic compounds considered to react with the hydrophilic group, although not working as the crosslinking agent for detackifying/hydrophobicizing the hydrophilic group, have the similar effect. These compounds useful for the present invention include glyoxal, polyamide, polyamidepolyurea, polyaminepolyurea, polyamideaminepolyurea, polyamidepolyurea/glyoxal condensate, polyamideamine, polyamideamine/formaldehyde condensate, polyamine/formaldehyde condensate, polyaminepolyurea/formaldehyde condensate, polyamidepolyurea/formaldehyde condensate, polyamideaminepolyurea/formaldehyde condensate, cation-modified urea resin, polyamide epoxy resin, (special)polyaminepolyurea-based resin, (special)polyamidepolyurea-based resin, modified polyamine-based resin, (modified) polyamide-based resin, and amine/polyol reaction product. Many of these compounds are developed for paper as waterproofing agent, printing characteristic improver, wet strength improver and strength improver. They have the common feature of controlling the hydrogen bonding in paper by incorporating a varying functional or hydrophobicizing group. They are effective as are the detackifying, hydrophobicizing organic crosslinking agent under the similar reaction conditions and at a similar content. Of these compounds, those capable of working as the agent for detackifying a natural rubber latex product are referred to as detackifying, hydrogen bonding adjustors in the present invention.

The other compounds which can work as the detackifying, hydrogen bonding adjustors include reactive, cationic compounds, e.g., polyamideamine/epihalohydrin condensate, polyamine/epihalohydrin condensate, polyamide polyurea/epihalohydrin condensate, polyaminepolyurea/epihalohydrin condensate, polyamideaminepolyurea/epihalohydrin condensate, tertiary amino group-modified polyamidepolyamine/epichlorhydrin resin, styrene-based tertiary amino group-modified polyamidepolyamine/epichlorhydrin resin, and cation-modified epoxy-based polyamide resin. They also work, when incorporated in carboxylated synthetic rubber latex, to lubricate the latex film surface, and react with protein in natural rubber latex to give the natural rubber latex product of controlled protein elution.

The methods of producing the above-described compounds are not limited. Those methods generally employed are described below.

A polyamide compound (also referred to as polyamideamine compound) is obtained by the dehydration condensation reaction between an amine compound and compound having carboxyl group.

A polyamidepolyurea, polyaminepolyurea, polyamideaminepolyurea and polyamideamine compound are the reaction products of polyalkylenepolyamine, alkylenepolyamine, urea or dibasic carboxylic acid. They may be modified with a small quantity of aldehyde, epihalohydrin, or α,γ-dihalo-β-hydrin. These methods are disclosed by, e.g., Japanese Patent Publication No. 59-32597 or Japanese Patent Laid-Open No. 4-10097.

The polyamideamine/epihalohydrin condensate, polyamideamine/formaldehyde condensate, polyamine/epihalohydrin condensate, polyamine/formaldehyde condensate, polyamidepolyurea/epihalohydrin condensate, polyamidepolyurea/formaldehyde condensate, polyaminepolyurea/epihalohydrin condensate, polyaminepolyurea/formaldehyde condensate, polyamideaminepolyurea/epihalohydrin condensate, polyamideaminepolyurea/formaldehyde condensate are the reaction products of polyalkylenepolyamine, urea, dibasic carboxylic acid, epihalohydrin or formaldehyde. The methods of producing these compounds are disclosed by, e.g., Japanese Patent Publication Nos. 52-22982, 60-31948 and 61-39435, and Japanese Patent Laid-Open No. 55-127423.

Recently, the effects of organohalogen compounds on the environments have been concerned, and the method of producing the polyamidepolyamine epichlorohydrin resin containing a reduced content of these compounds is disclosed by Japanese Patent Laid-Open No. 10-152556.

Furthermore, various compounds, e.g., epoxy-modified, quaternary epihalohydrin resin (Japanese Patent Laid-Open No. 61-252396) and anion-modified epihalohydrin resin (Japanese Patent Laid-Open No. 61-281127) of these compounds, have been developed.

The method of producing a polyamine epihalohydrin resin is disclosed by, e.g., U.S. Pat. No. 3,949,014.

The monofunctional compound which reacts with the hydrophilic group of the tacky auxiliary component of natural rubber latex or hydrophilic polymer to hydrophobicize them also has the effect as the hydrophilic group sealant. These compounds specifically include monofunctional amine, isocyanate and blocked isocyanate. Being monofunctional, they cannot form the crosslinked structure; nevertheless, however, they can seal a hydrophilic group. Such a compound preferably has a hydrophobic group, in addition to the functional group involved in the reaction with the hydrophilic group, because such a compound can promote hydrophobicizing of the tacky auxiliary component of natural rubber latex and hydrophilic polymer. These include reactive sizing agents, e.g., those of alkyl ketene dimer (AKD), alkenyl ketene dimer, and alkenyl succinic anhydrides (ASA), and a fatty acid anhydride derivative-based sizing agent, described later.

A sizing agent for paper works to hydrophobicize a hydrophilic group in paper to prevent running of ink on paper. It can also detackify the natural rubber latex product, which may be incorporated with a hydrophilic polymer. It conceivably hydrophobicize the hydrophilic group chemically, physicochemically or physically to detackify it. The mechanisms involved in the hydrophobicizing reactions are not fully established. Nevertheless, however, it is developed as a paper hydrophobicizing agent, and has a significant effect and is stable.

The paper sizing agent is either incorporated in paper or coating paper, and either is useful for the present invention. Any substance will be useful, whether it is called sizing agent, so long as it brings about the above effect. Of these sizing agents, those which detackify a natural rubber latex product are referred to as the detackifying sizing agents.

The sizing agents to be incorporated in paper fall into the general categories of those for acidic, neutral and acidic/neutral conditions (Japanese Patent Laid-Open No. 11-61682).

The sizing agents for acidic conditions include rosin-based, fatty acid soap, synthetic and petroleum resin agents.

The rosin-based sizing agents include those of rosins and derivatives thereof. Rosins include gum, wood and tall oil rosins comprising resin acid as the major ingredient, e.g., abietic, palustric, neoabietic, pimaric, isopimaric or dehydroabietic acid.

The rosin derivatives include hydrogenated, disproportionate, polymerized, modified and strengthened rosins, and rosin ester and strengthened rosin ester.

The modified rosins include those modified by (alkyl)phenol/formalin resin, xylene resin, aldehyde or styrene.

The strengthened rosin is obtained by reacting the above-described rosin with an αβ-unsaturated carboxylic acid under heating.

The rosin ester is produced by a known method of esterifying a rosin with a polyhydric alcohol.

The strengthened rosin ester is produced by reacting the above-described rosin and/or modified rosin with a known polyhydric alcohol and αβ-unsaturated carboxylic acid consecutively or simultaneously.

The fatty acid soap sizing agent includes the one comprising a fatty acid of around 8 to 24 carbon atoms, e.g., palmitic or stearic acid, or a mixture thereof neutralized with an alkali.

The synthetic sizing agent includes the one comprising a substituted succinic anhydride (obtained by reacting an oligomer of isobutene dimer or tetramer with maleic anhydride) neutralized with an alkali.

The petroleum resin sizing agent includes the one comprising a petroleum resin modified by an unsaturated carboxylic acid, e.g., maleic acid. The petroleum resins include C5-based one obtained by polymerizing a C5 olefin (e.g., 1,3-pentadiene or isoprene), C9-based one obtained by polymerizing a C9 olefin (e.g., coumarone or indene), C5/C9-based one obtained by polymerizing a C5 and C9 olefin, and dicyclopentadiene-based one obtained by polymerizing dicyclopentadiene or a derivative thereof.

The sizing agents for neutral conditions include alkyl ketene dimer (AKD)-based, alkenylketene dimer-based and alkenyl succinic anhydride (ASA)-based agents, and rosin-based agent for neutral conditions.

The alkyl ketene dimer-based and alkenylketene dimer-based agent can be produced by emulsifying an alkyl ketene dimer and alkenyl ketene dimer, respectively, which are normally produced by treating a chloride of corresponding saturated or unsaturated fatty acid of around 12 to 24 carbon atoms with a base, e.g., triethylamine, for dimerization.

The alkenyl succinic anhydride-based sizing agent can be produced by emulsifying an alkenyl succinic anhydride, produced by adding maleic anhydride to an olefin of around 12 to 24 carbon atoms, located at the terminal or inside.

The rosin-based sizing agents for neutral conditions include ester of rosin with a polyhydric alcohol, and emulsion of a substance contained in a petroleum resin dispersed in water.

The esters of rosin with a polyhydric alcohol include the products containing a rosin ester obtained by the reaction of a rosin with (a) at least one type of compound falling into the category of polyhydric alcohol or with (a) at least one type of compound falling into the category of polyhydric alcohol and (b) at least one compound falling into the category of αβ-unsaturated carboxylic acid or derivative thereof.

The known sizing agents for acidic/neutral conditions include cationized fatty acid bisamide-based, cationized petroleum polymer-based, cationized polymer-based and α-hydroxycarboxylic acid-based agents.

The cationized fatty acid bisamide-based and cationized petroleum resin-based sizing agents are normally synthesized by reacting a fatty acid or maleic acid adduct with a petroleum resin of around 12 to 24 carbon atoms, respectively, with a polyamine (e.g., diethylenetriamine or triethylenetetramine) or a mixture thereof, and then reacting the product with epichlorohydrin or the like.

The cationized polymer-based sizing agent is normally synthesized by the radical copolymerization of a cationic vinyl monomer (e.g., dimethylaminoethyl methacrylate) or hydrophobic monomer (e.g., styrene, acrylonitrile or alkyl (meth)acrylate) in water and/or organic solvent.

The α-hydroxycarboxylic acid-based sizing agent is produced by reacting a higher alcohol or amine with an oxyacid, e.g., citric acid.

The surface sizing agent is generally composed of the hydrophobic section and anionic section (e.g., carboxyl group) Such a surface sizing agent is obtained by, e.g., copolymerizing a hydrophobic monomer and anionic monomer, e.g. αβ-unsaturated carboxylic acid, αβ-unsaturated dicarboxylic acid or unsaturated sulfonic acid (Japanese Patent Laid-Open No. 2000-45197).

The specific examples of the surface sizing agent comprising a copolymer of hydrophobic monomer and anionic monomer include styrene/(meth)acrylic acid, styrene/(meth)acrylic acid/(meth)acrylate ester, styrene/maleic acid, styrene/maleic acid/maleate semi-ester, (di)isobutylene/maleic acid and (di)isobutylene/maleic acid/maleate semi-ester copolymers, and salts thereof.

The other surface sizing agents include those of alkylketene dimer, alkenyl succinic acid (anhydride), styrene/acrylic acid copolymer, acrylate ester/acrylonitrile copolymer and styrene/dialkylaminoalkyl(meth)acrylate copolymer including the product of its reaction with epihalohydrin (Japanese Patent Laid-Open No. 2001-32191).

The surfactant is composed of a hydrophilic and hydrophobic group. When the surfactant is coordinated with the tacky auxiliary component of the natural rubber latex or the hydrophilic polymer intentionally incorporated in the latex with the hydrophobic group positioned outside, it should seal the hydrophilic group on the natural rubber latex product surface, and hence hydrophobicize and detackify the surface. Therefore, extent of hydrophobicity of surfactant should determine to what extent the product is detackified. However, whether the surfactant is coordinated with the product surface with the hydrophobic group positioned outside is determined by various factors, e.g., physical and chemical properties of the surfactant itself, properties of the latex, presence of an inorganic salt (e.g., calcium ion), and hydrophilic polymer incorporated. It is therefore difficult to have the general rule. It is therefore necessary to conduct the tackiness test, as in EXAMPLES, to screen the detackifying surfactant. The test results indicate that few surfactants show the detackifying effect, because it is generally leached out in the leaching step and has a tendency of diffusion through the latex film. Nevertheless, however, it can detackify a natural rubber latex product in some circumstances where elution and diffusion of the surfactant are prevented, e.g., when a cationic hydrophilic polymer is incorporated together with an anionic surfactant. The internal surface coming into contact with the mold is not exposed to water in the leaching step. Therefore, separately detackfying the external surface by an adequate method, e.g., coating with a detackifying polymer layer, halogenation-treated layer or layer treated with a detackifying crosslinking agent of tri- or tetra-valent metallic element should greatly widen a range of surfactants which can detackify the internal surface.

A general tendency is not observed with the nonionic surfactants, except that the one of high HLB shows a low detackifying effect whereas the amine- and amide-based ones a good detackifying effect.

The cationic and ampholytic surfactants are characterized by their cation being bonded to the anion of the carboxyl group through the ionic bond. However, both react chemically with carboxyl group at low temperature, and affect formation of the latex film by the immersion process, when incorporated in the coagulating agent.

It is known that the anionic surfactant, when used together with the cationic, hydrophilic polymer, shows an effect of hydrophobicizing the hydrophilic polymer. Therefore, the anionic surfactant in combination with the cationic, hydrophilic polymer should show a fairly good detackifying effect.

A surfactant will greatly affect each production step and product properties by its inherent nature, e.g., reducing natural rubber latex viscosity. It is therefore necessary to judge whether a surfactant in question is useful for the present invention or not after confirming its detackifying effect by the tackiness test, and, at the same time, to study its effects on film-making process and product properties.

In the coating process for the paper-making industry, starch, protein, casein, varying types of latex, polyvinyl alcohol and so on are used as the adhesives, and a waterproofing agent is used to insolubilize these adhesives by reacting with their hydrophilic groups (e.g., —OH, —CONH, —NH₂ and COOH groups). These compounds correspond to protein as the tacky auxiliary component of the natural rubber latex and hydrophilic polymer intentionally incorporated in the natural rubber latex for the present invention. The waterproofing agent reacting with these compounds to hydrophobicize them is considered to be suitable as the agent for detackifying the natural rubber latex product.

Waterproofing agents used to be those of formaldehyde, glyoxal, urea formaldehyde resin and melamine formaldehyde resin. However, they have been replaced by the new ones developed and commercialized later, because of various problems caused by them, e.g., unstabilized adhesive compositions, emitting a formaldehyde odor, and discoloration.

Waterproofing agents are classified by reactive group involved in the reaction into organic and inorganic agents, the former including compounds having methylol group and lower alkylated compounds thereof (e.g., urea/formaldehyde resin, melamine/formaldehyde resin and polyamidepolyurea/formaldehyde resin), aldehydes (formaldehyde and derivative that liberates thereof, glyoxal, dialdehyde starch, cyclic urea/glyoxal reaction product, blocked glyoxal resin (U.S. Pat. No. 4,695,606), glyoxal/polyol reaction product (U.S. Pat. No. 4,656,296) and copolymer of acrylamide/glyoxal reaction product), compounds having epoxy or chlorohydrin group (e.g., glycerindiglycidyl ether and polyamide/epoxy resin), compounds having ethyleneimine group (e.g., diphenylethane-bis-4,4′-N,N′-diethylene urea and (branched) polyethyleneimine) and polyvinyl butyral; and the latter including multi-valent metallic compounds (e.g., zirconium ammonium carbonate) (Handbook of Latest Paper Processing, Tec Times, P.469). Those useful for detackifying natural rubber latex, and, at the same time, insolubilizing and waterproofing the tacky auxiliary component and intentionally incorporated hydrophilic group under relatively mild conditions include cycloamide, polyhydric alcohol/carbonyl adduct, (special) polyaminepolyurea-based resin, (special) polyamidepolyurea-based resin, (modified) polyamine-based resin, modified polyamide-based resin, ketone resin, cation-modified urea resin, cation-modified epoxy-based polyamide resin, polyglycidyl ether, blocked glyoxal resin (cyclic urea/glyoxal condensate, cyclic urea/glyoxal/polyol condensate), and amine/polyol reaction product. Of these waterproofing agents, those capable of detackifying a natural rubber latex product are referred to as the detackifying waterproofing agents.

Some hydrophilic polymers need specific waterproofing agents. For example, diborate functions as the waterproofing agent for polyvinyl alcohol. These specific waterproofing agents for some hydrophilic polymers also fall into the scope of the present invention (Encyclopaedia of Paper and Paper Processing Agents, Tec Times, P.147).

Water repellents have been developed to impart water repellency to paper. Water repellents are not necessarily suitable for detackifying a natural rubber latex product, due to their insufficient hydrophilicity, although they themselves are highly hydrophobic. It is therefore necessary to select the water repellents which can detackify a natural rubber latex product from various ones. These water repellents are referred to as the detackifying water repellents. It is necessary to select the detackifying water repellents from the agents, e.g., fatty acid amide wax, fatty acid/chromium complex, aluminum stearate, chlorosulfonated polyethylene, ethyleneurea-based resins, acrylic resins, and silicone-based resins.

In the paper processing industry, lining materials for adhesive labels or the like, e.g., releasing paper, adhesive tape, process paper and transfer paper, are coated with a releasing agent. Releasing agents are broadly classified into two general categories of silicone- and nonsilicone-based ones.

The silicone-based agents are basically composed of polydimethyl siloxane as the base polymer and polymethyl hydrogen siloxane as the crosslinking agent. They are sub-classified by crosslinking reaction type into condensing reaction and addition reaction types. Hydroxyl works as the functional group in the polydimethyl siloxane for the former type, and vinyl works as the functional group for the latter type. Polymethyl hydrogen siloxane works as the crosslinking agent for both types. The nonsilicone-based releasing agents, preferable for some purposes, include polymer having a long-chain alkyl group, alkyd resin and acrylic/styrene copolymer, represented by polymer having a long-chain alkyl group. The releasing agent having a long-chain alkyl group is a product of alkylation reaction between a vinyl compound and the polymer. The long-chain alkyl groups are mostly octadecyl. The nonsilicone-based releasing agents are sub-classified into the reaction and non-reaction types, the latter needing no curing step for applying the agent. The reaction type is more preferable for securing the detackifying effect. The known releasing agents of this type include those of adduct of polyethyleneimine and octadecyl isocyanate, adduct of polyvinyl alcohol and isocyanate having a long-chain alkyl group, self-crosslinking acrylic/styrene copolymer. For detackifying a natural rubber latex product, the releasing agent is preferably aqueous.

The suitable compounds for introducing an anionic group in protein in natural rubber latex include those working as the dyes reactive under alkaline or neutral conditions. The reactive dye has the structure composed of a colorant base having a water-soluble group and reactive group. The water-soluble groups are generally sulfone group, although not limited thereto. For example, they may be other anionic groups. The reactive dyes, originally developed for dyeing cellulosic fibers, are used also for protein-based fibers, e.g., wool. The reactive dye introduces an anionic group in protein, when it reacts with protein in natural rubber latex.

The reactive groups for the reactive dye are not limited. Various reactive groups are known, and are also being developed (Basic Dye chemistry, Sadaji Abeta, Sikisen-sha, P.164). The major reactive groups for the reactive dyes are sulfate ethylsulfone-based, s-triazine-based and pyrimidine-based ones. The basic reactive group is sulfate ethylsulfone for the sulfate ethylsulfone-based one, dichlorotriazine and monochlorotriazine for the s-triazine-based one, and trichloropyrimidine for the pyrimidine-based one. The improved types of the major reactive groups include dissimilar bifunctional ones (e.g., sulfate ethylsulfone/monochlorotriazine, sulfate ethylsulfone/difluorochloropyridine and vinyl sulfone/monochlorotriazine), monochlorotriazine-based group of cyanuric chloride whose second chlorine atom is substituted with a substituent, reactive group substituted with two or more halogenotriazine groups, halogenotriazine group whose chlorine atom is substituted with fluorine, reactive group substituted with two or more monochlorotriazine groups, reactive group with chlorine in monochlorotriazine substituted with nicotinic acid to be reactive in a neutral region, and trichloropyrimidine with one or two chlorine atoms out of its three chlorine atoms are substituted with methyl sulfone group or fluorine atom. Recently, the movements are noted for improving dye fixing characteristics by introducing two or more functional groups or developing new functional groups to reduce loads of dye-containing waste water. N-(sulfate ethyl sulfonylalkyl)-anil group is one example of such groups (Japanese Patent Laid-Open No. 7-304981).

A reactive dye of high fixing characteristics is considered to have high capacity of fixing protein in natural rubber latex. Such a reactive dye is desirable for production of the natural rubber latex product of controlled elution of protein.

Elution of protein may not be completely prevented, even when the reactive dye reacts with protein in natural rubber latex. The eluted protein may be still detected by the protein analysis, which involves vigorous stirring of the sample in the phosphate-buffered physiological saline for 2 hours. In such a case, it is preferable to further treat the natural rubber latex with the so-called fixing agent, as is the case with dyeing with a reactive dye.

The fixing agent for the reactive dye, fixing the dye after bonding itself to the anionic group of the dye represented by sulfone group, will also fix protein, when the dye is bonded to the protein.

The chemical structures as the basic skeletons of the fixing agents now being used are dicyanodiamide/formalin polycondensate-based, polyamine-based and polycation-based ones, the polycation-based one being prevailing. The commercial agents with the polycation-based structure include dimethylamine/epichlorohydrin polycondensate, dimethyldiallyl ammonium chloride polymer, (di)allyl amine hydrochlorate polymer, quaternary polymer of dialkylaminoethyl methacrylate, diallyl amine salt/sulfur dioxide copolymer, and dimethyldiallyl ammonium chloride/sulfur dioxide copolymer (Senryo Kenkyu, 44, No.2, P.45, 2000). Many of these compounds overlap the above-described cation-based hydrophilic group sealants, and these sealants work also as the fixing agents. Moreover, the crosslinking agents of tri- or tetra-valent metallic elements also function as the fixing agents.

A natural rubber latex product is not necessarily colored. Therefore, the compound which is reactive with protein in natural rubber latex and introduces an anionic group therein can reduce elution of the protein from the natural rubber latex product. In other words, the compound which having a reactive group and an anionic group or a functional group which forms an anionic group while having no colorant base also falls into the scope of the present invention. In addition, the compound having anhydrous carboxylic group reacts with protein to introduce the carboxylic group therein, thereby reducing elution of the protein.

The water-insoluble, fixing, anionic compound also reduces elution of protein for the rubber product of anionic starch and guar gum.

The cationic group reactive with natural rubber latex protein cationizes the protein, fixing it in the natural rubber latex product to reduce its elution. These compounds, e.g., epichlorohydrin-based polycondensates, overlap those compounds useful as the cationic, detackifying, hydrophilic group sealants or fixing agents, indicating that the hydrophobicization leads to fixing of protein and hence to controlled elution of protein.

The natural saccharide-related products, e.g., those of starch and guar gum, are frequently molten at high temperature to be used in the form of solution. The starch or the like is not molten at normal temperature, when the product is dried. The natural rubber latex products, incorporated with cationized starch or guar gum to utilize the above nature, show controlled elution of protein, conceivably because the cationized starch or the like fixed on the product electrostatically captures the protein to control its elution even under the analysis conditions. Therefore, the natural rubber latex product incorporated with a compound cationic and insoluble under the analysis conditions is of controlled elution of protein.

The cationized polymer will exhibit the effect similar to that of cationized starch, when insolubilized by a known waterproofing agent or the like.

There are various methods of producing the detackified natural rubber latex product of the present invention, and are not limited.

When the natural rubber latex product is detackified only with the hydrophilic polymer and/or hydrophilic group sealant incorporated therein, it can be produced by the common method. However, the starting material for natural rubber latex is inherently strongly alkaline when incorporated with ammonia, and the tacky auxiliary component (e.g., protein) and the hydrophilic polymer and hydrophilic group sealant to be incorporated are highly soluble in water. Therefore, there is a high possibility that the protein is leached or eluted out. It is therefore desirable to control elution of the tacky component towards the product surface by sufficiently drying the natural rubber latex under heating to evaporate ammonia prior to the leaching step, and, at the same time, by sufficiently reacting the incorporated agent with, or bonding it to, the tacky auxiliary component.

The surface of the product already formed into the film can be detackified, when so needed, by bringing one or both surfaces into contact with the hydrophilic group sealant solution to be treated therewith. Some hydrophilic group sealants react with the product very quickly, so that the surface loses tackiness when the latex film is withdrawn from the solution. In some cases, the film needs to be heated after being withdrawn from the solution. In any case, it is desirable to treat the product under heating in order to fully bring about the treatment effect. This surface treatment is applicable to the product produced by the direct immersion process.

The internal surface of an immersion-processed product can be detackified by coating the mold with one or more hydrophilic group sealants and the common mono- or di-valent coagulating agent for the external surface, to simultaneously coagulation and treatment of the latex with the sealant(s), when the surface comes into contact with these agents. It is desirable to adopt this treatment for natural rubber latex, even when it can be detackified only with the incorporated detackifying hydrophilic polymer and/or hydrophilic group sealant, because the treatment of the internal surface with the hydrophilic group sealant is a simple procedure.

When the external surface of the latex film is to be treated with the hydrophilic group sealant, it can be detackified by immersion of the external surface of the film in a hydrophilic group sealant solution the heat treatment effected in a manner similar to the above.

There are three methods for coating the mold with the hydrophilic group sealant. The first method coats the mold with the mixed solution of the common coagulating agent of mono- or di-valent metallic salt for the external surface and one or more hydrophilic group agents of the present invention. The second method coats the mold first with the hydrophilic group sealant of the present invention, and then with the common coagulating agent for the external surface.

Immersion of the coated mold in the emulsified latex solution gives the immersion-processed product whose internal surface coming into contact with the mold is detackified.

The third method coats the mold with the hydrophilic group sealant as the coagulating agent for the external surface to form the thin film of the hydrophilic group sealant, further coats the thin film with the coagulating agent of mono- or di-valent metallic element for the external surface, and immerses again the coated mold in the latex solution. This method, although capable of detackifying the internal surface, may cause interlayer exfoliation of the product.

The natural rubber latex product is generally treated under hydrothermal conditions in the leaching step. This leaches the tacky component of the natural rubber latex to the external surface, and elutes out the incorporated hydrophilic polymer, hydrophilic group sealant and the like from the external surface, to deteriorate the detackifying effect. Therefore, heat treatment at high temperature is frequently required prior to the leaching step for, e.g., evaporation of ammonia. On the other hand, the method which involves no heat-treatment at high temperature can be separately effected for the external surface, which can be easily treated. Halogenation, coating with a detackifying polymer and treatment of the crosslinking agent of tri- or tetra-valent metallic element are some of the methods applicable to the external surface. Each treatment can be effected on-machine.

The external surface can be halogenated by the known method. The applicable methods and their effects are described earlier.

The treatment with the detackifying polymer immerses the external surface of the product in the detackifying polymer solution and then dries it under heating to make the surface detackified with the coating film. The conventional treatment method to form the coating film is already described in Background Art. To explain the coating treatment with the detackifying diene-based carboxylated synthetic rubber latex, developed by the inventors of the present invention, the external surface can be easily detackified by immersing the external surface in the detackifying diene-based carboxylated synthetic rubber latex solution, diluted to a very low concentration of 5%, and then drying the resultant coating film under heating. The coating film accounts for less than 1 part of the natural rubber latex film, even when it is thin at around 0.1 mm; nevertheless, however, it can sufficiently bring about the detackifying effect. Thickness of the coating film can be freely changed for specific surfaces by changing concentration of the detackifying diene-based carboxylated synthetic rubber latex solution.

The diene-based carboxylated synthetic rubber latex needs the carboxyl group sealant to be detackified. This agent can be directly incorporated in the diene-based carboxylated synthetic rubber latex solution or in the natural rubber latex. The natural rubber latex can be also detackified by incorporating the hydrophilic group sealant in the diene-based carboxylated synthetic rubber latex. The hydrophilic group sealants and carboxyl group sealants are functionally interchangeable in many cases. When this is the case, the product can be detackified as a whole by incorporating the hydrophilic group sealant or carboxyl group sealant in the diene-based carboxylated synthetic rubber latex or in the natural rubber latex. The hydrophilic group sealant or carboxyl group sealant may sometimes make the latex unstable, and the extent of unstability is varied depending on properties of each agent or on whether the latex is of the diene-based carboxylated synthetic rubber or natural rubber. Thus, the said sealant is convenient in that the place where the sealant is incorporated can appropriately selected depending on properties of the agent. Another advantage of the coating with the detackifying, carboxylated synthetic rubber latex is that it causes no discoloration of the metallic surface with which the coated natural rubber latex product comes into contact. Therefore, the product is suitably used for handling an electronic part or precision device.

When the external surface is to be treated with the crosslinking agent of tri- or tetra-valent metallic element, it can be treated by being immersed in the natural rubber latex solution and then dried under heating. The reaction between a cationic group and the anionic, tacky component is electrostatic in nature, and has an advantage of proceeding at low temperature. However, taking an aluminum compound as the example, it may be converted into aluminum hydroxide in the presence of ammonia, to lose cationic property. In such a case, deteriorated effect or separation of aluminum hydroxide on the surface may result. It is desirable to take an adequate measure against such possibility, e.g., making the immersion solution acidic, elution treatment prior to the immersion treatment, or drying the latex at high temperature to evaporate ammonia.

As described above, use of the present invention can easily give the natural rubber latex product detackified on one or both surfaces. The product surfaces are not adhered to each other even when they come into contact with each other under heating during the production process or thereafter, a characteristic which can be used for producing novel products.

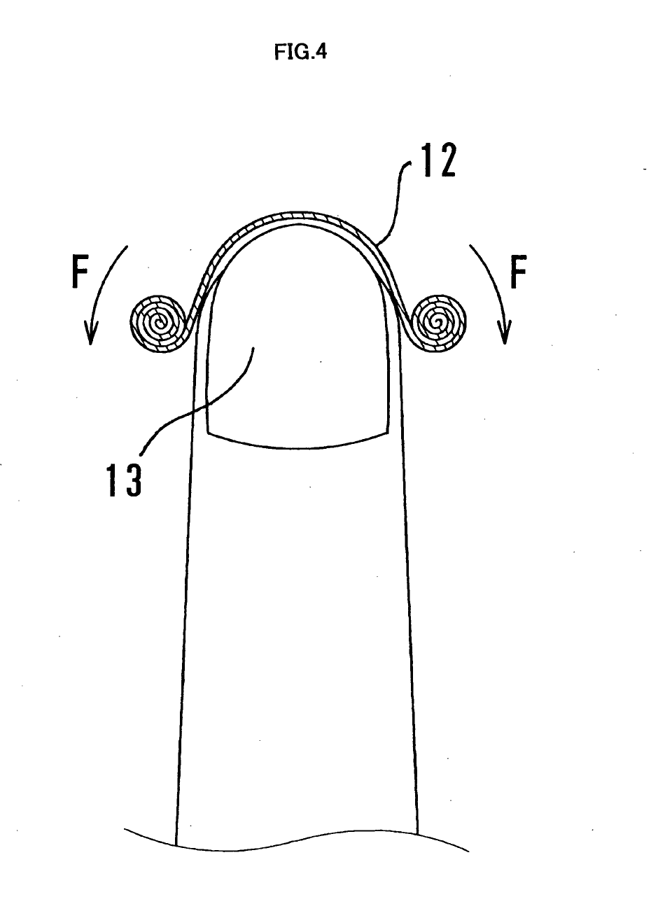

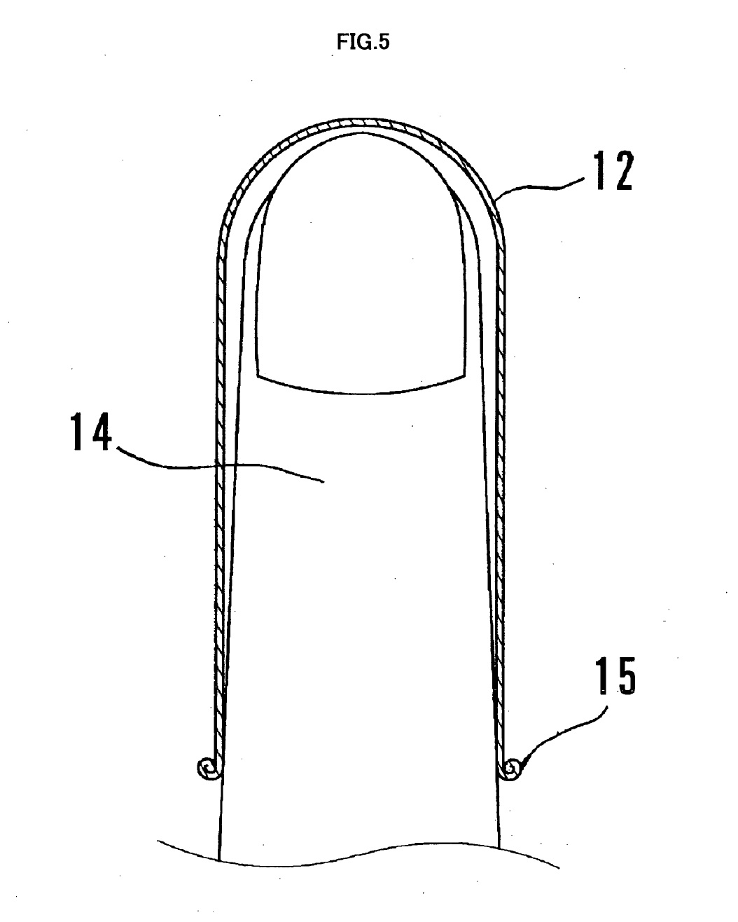

One example is the fingerstall of detackifying natural rubber latex which is wound up from its mouth on-machine before being released out of the mold. The fingerstall wound up from the mouth has been already developed. For example, referring to FIG. 4, the fingerstall 12 put on the fingertip 13 can be worn by simply winding it back on the finger in the arrowed direction F, as shown in FIG. 5. Its usefulness has been recognized, because it can easily cover the finger. However, a fingerstall as a natural rubber latex product is inherently tacky on both surfaces, and the winding-up type is detackified beforehand with powder or post-treatment of chlorination and then manually wound up. Such a product is rarely used in a factory producing precision processed products, because of difficulty in keeping the products highly clean. On the other hand, the present invention provides a fingerstall of natural rubber latex detackified on both surfaces, which can be mechanically wound up on the mold and keep the precision products highly clean. Recently, thinner fingerstalls are increasingly in demand to reduce fatigue of the wearer. A thinner fingerstall, however, is more difficult to wear, and hence thin, powder-free, detackified, clean, wound-up fingerstalls are strongly in demand.

The natural rubber latex detackified on both surfaces can be easily made into the fingerstall with a wound-up mouth. When a fingerstall is produced, the upper portion is left tacky without being provided with the hydrophilic group sealant layer or the like, and wound up totally and then wound back in such a way to leave the tacky portion as the wound-up mouth. In the conventional method, it is necessary to provide the wound-up mouth by first winding up only the upper portion of the fingerstall, and then releasing the fingerstall out of the mold in a separate step. The wound-up mouth is greatly in demand for flat products, because it facilitates wearing/taking-off of the fingerstall. A fingerstall can be detackified, after being provided with the wound-up mouth by the conventional method.

The wound-up fingerstall described earlier can be provided with the wound-up mouth in a similar manner.

Referring to FIG. 5, when the fingerstall 12, wound up from the mouth to have the wound-up mouth, is taken off from the finger 14, it can be wound back on the finger easily except for the wound-up mouth 15, which is left tacky unlike the other portion. The fingerstall provided with a wound-up mouth can be easily worn/taken off by picking the mouth by other fingers. Depending on properties of the fingerstall, the wound-up mouth has a function of clamping the finger to keep the fingerstall held thereon.

It is possible to produce the wound-up fingerstall having no wound-up mouth by winding up the fingerstall which is detackified over the entire surface. The fingerstall having no wound-up mouth has an advantage of reducing fatigue of the person who wears it for a long time, because the finger is not fastened by the mouth.

### EXAMPLES

### 1. Preparation of the Starting Materials

(1) Preparation of Natural Rubber Latex

Natural rubber latex was pre-vulcanized under the following conditions, unless otherwise stated: Starting natural rubber latex:
High-ammonium natural rubber latex
HA-FELDA LATEX
Solid concentration: 60%, pH: almost 10.6

Pre-vulcanization conditions:
Sulfur: 0.7 parts
Zinc oxide: 1.0 part
Zinc di-n-butyldithiocarbamate: 0.6 parts

Curing conditions: 40° C. for 24 hours

(2) Incorporation of the Hydrophilic Polymer

When the hydrophilic polymer was incorporated in the pre-vulcanized natural rubber latex sample, it was dissolved or dispersed in water to have a concentration of around 1 to 2% and added to the latex slowly with stirring. Its content in each EXAMPLE is given in the relevant table.

(3) Incorporation of the Hydrophilic Group Sealant

When the hydrophilic group sealant was incorporated in the natural rubber latex sample, it was added to the pre-vulcanized natural rubber latex sample. Its content in each EXAMPLE is given in the relevant table.

(4) Adjustment of the Natural Rubber Latex Concentration

The immersion-processed natural rubber latex was adjusted to contain the natural rubber latex solids at 40.0%, unless otherwise stated.

The natural rubber latex film was around 0.10 to 0.13 mm thick, when produced by the coagulation method.

(5) Preparation of the Coagulating Solution (or Coagulating Solution Containing the Hydrophilic Group Sealant)

The coagulating solution was an aqueous solution, containing calcium nitrate tetrahydrate at 100 g/1000 g, unless otherwise stated.

When the internal surface was treated with the hydrophilic group sealant, a given quantity of the sealant was added to the coagulating solution. The concentration of the hydrophilic group sealant in each EXAMPLE is given in the relevant table.

(6) Preparation of the Treatment Solution of the Hydrophilic Group Sealant for the External Surface

When the external surface of the natural rubber latex film was treated with the hydrophilic group sealant, the treatment solution was diluted with water to have a given hydrophilic group sealant concentration for each EXAMPLE. Its concentration in each EXAMPLE is given in the relevant table.

(7) Preparation of the Coating Solution of Detackifying Diene-Based Carboxylated Synthetic Rubber Latex for the External Surface

Carboxylated NBR latex was incorporated with 1.5 parts of activated zinc white, 0.25 parts of sodium aluminate (as Al₂O₃) and 2.5 parts of the carboxyl group sealant, and diluted with water to have the solid latex concentration of 5%, unless otherwise stated. The carboxylated NBR latex and carboxyl group sealant used are shown in each EXAMPLE.

### 2. Formation of the Natural Rubber Latex Film (By Use of Coagulating Agent)

The mold was immersed in the above-described coagulating solution containing calcium nitrate tetrahydrate at 100 g/1000 g. The mold held around 0.03 g of the coagulating solution. It was dried, immersed in the natural rubber latex preparation solution for 5 seconds, and withdrawn to form the natural rubber latex film. The dried film was 0.10 to 0.13 mm thick and weighing around 0.3 g. When the internal surface was treated with the hydrophilic group sealant, the above described coagulation solution containing the hydrophilic group sealant was used, to form the natural rubber latex film.

### 3. Post-Treatment of the Formed Natural Rubber Latex Film

The natural rubber latex film prepared by the above procedure was heated, and then treated for leaching and post-vulcanization, unless otherwise stated. Treatment temperature and time are shown in each EXAMPLE.

### 4. Treatment of the External Surface of the Formed Natural Rubber Latex Film with the Hydrophilic Group Sealant

The natural rubber latex film formed on the mold was heated, and then immersed in the above-described treatment solution of the hydrophilic group sealant for the external surface for 5 seconds, unless otherwise stated. Approximately 0.03 g of the solution was held by the film. It was heated, and then treated for leaching and post-vulcanization. Treatment temperature and time are shown in each EXAMPLE.

### 5. Coating Treatment of the External Surface with the Detackifying Diene-Based Carboxylated Synthetic Rubber Latex

The natural rubber latex film formed on the mold was heated, and then immersed in the above-described coating solution of the detackifying diene-based carboxylated synthetic rubber latex for 5 seconds, unless otherwise stated. Approximately 0.05 g of the solution was held by the film. It was heated, and then treated for leaching and post-vulcanization. Treatment temperature and time are shown in each EXAMPLE.

### 6. Chlorination Treatment of the External Surface of the Natural Rubber Latex Film

The natural rubber latex film formed on the mold was heated, and then immersed in chlorine water containing chlorine at 0.4% for 5 seconds, to chlorinate the external surface, unless otherwise stated. It was heated, and then treated for leaching and post-vulcanization. Treatment temperature and time are shown in each EXAMPLE.

### 7. Tackiness Test

The post-vulcanized natural rubber latex film was wound up on the mold. It was heated at 90° C. for 30 minutes while it was kept wound-up, cooled and then wound back. Extent of detackiness was evaluated according to the four-grade system: O: the film can be easily wound back, O′: the film is slightly difficult to wind back on the way, Δ: the film cannot be wound back on the way, and x: the film cannot be wound back.

### 8. Detackiness Test of the Natural Rubber Latex Film

### COMPARATIVE EXAMPLE 1

The natural rubber latex film was prepared only from the pre-vulcanized natural rubber latex, and post-vulcanized for the tackiness test. The result was that the film could not be wound back. The post-treatment conditions are described below:

(Post-treatment)

The natural rubber latex film prepared was treated by the following steps in the order described below:

Heating→Leaching→Post-vulcanization

Post-treatment temperature and treatment time in COMPARATIVE EXAMPLE 1 were:
Heating Leaching Post-vulcanization (COMPARATIVE EXAMPLE 1) 95° C., 7 min. 85° C., 3 min. 110° C., 10 min.

### COMPARATIVE EXAMPLE 2

The natural rubber latex film was prepared from the pre-vulcanized natural rubber latex incorporated with 0.25 parts of the hydrophilic polymer, and post-vulcanized for the tackiness test. The result was that the film could not be wound back. The post-treatment conditions and hydrophilic polymer incorporated are described below:

(Post-treatment)

The natural rubber latex film prepared was treated by the following steps in the order described below:

Heating→Leaching→Post-vulcanization

Post-treatment temperature and treatment time in COMPARATIVE EXAMPLE 2 were:
Heating Leaching Post-vulcanization (COMPARATIVE EXAMPLE 2) 95° C., 7 min. 85° C., 3 min. 110° C., 10 min. (Hydrophilic polymer incorporated in the latex)

### COMPARATIVE EXAMPLE 2

### Polyethylene Oxide

PEO-8 (SUMITOMO SEIKA CHEMICALS) Properties: Nonionic, White powdery or granular
Viscosity (0.5%, 25° C.): 60 mPa.s
pH (0.5%)=7.0

### EXAMPLES 1 to 13

The natural rubber latex film was prepared from the pre-vulcanized natural rubber latex incorporated with the anionic, hydrophilic polymer, and further with the hydrophilic group sealant, and post-treated for the tackiness test. The result, and the anionic, hydrophilic polymer and hydrophilic group sealant used in each EXAMPLE are given in Table 1. The post-treatment conditions in each EXAMPLE are described below:

(Post-treatment)

The natural rubber latex film prepared was treated by the following steps in the order described below:

Heating→Leaching→Post-vulcanization

In order to evaluate the effects of the post-treatment, the film was post-treated under two different sets of conditions for the heating and leaching steps: (1) heating at 50° C. for 2 minutes and leaching at 70° C. for 3 minutes, and (2) heating at 90° C. for 5 minutes and leaching at 85° C. for 3 minutes in each of EXAMPLES 1 to 5. Post-treatment temperature and treatment time in each EXAMPLE were:
Heating Leaching Post-vulcanization (EXAMPLES 1 to 5) (1) 50° C., 2 min. 70° C., 3 min. 90° C., 5 min. (EXAMPLES 1 to 5) (2) 90° C., 5 min. 85° C., 3 min. 90° C., 5 min.

The film prepared in each of EXAMPLES 1 to 5 was further treated for post-vulcanization at 110° C. for 5 minutes for the tackiness test.

Heating Leaching Post-vulcanization (EXAMPLES 6 and 7) 90° C., 5 min. 70° C., 5 min. 110° C., 5 min. (EXAMPLES 8 to 13) 95° C., 7 min. 85° C., 3 min. 110° C., 10 min.

TABLE 1

| | | Incor- | | Incor- | | |
|---|---|---|---|---|---|---|
| | | porated | | porated | Drying | |
| Examples | Anionic, hydrophilic polymer | quantity | Hydrophilic group selants | quantity | prior to | Test |
| NO. | to be incorporated in the latex | (parts) | to be incorporated in the latex | (parts) | leaching | results |
| 1 | Carboxymethyl cellulose | 0.2 | Detackifying waterproofing agent: | 1.0 | 50° C. | o′ |
| | Trade name: CMC DAICEL 1330 | | Blocked glyoxal resin (Product of | | 90° C. | o |
| | (DAICEL CHEMICAL INDUSTRIES) | | polyamide polyurea glyoxal reaction) | | | |
| | Properties: Anionic, White | | Trade name: Sumirez Resin 5001 | | | |
| | powdery, Viscosity (1%, 25° C.): | | (Sumitomo Chemical Group) | | | |
| | 73 cps pH: 6.8, Degree of | | Properties: Nonionic, Light-colored, | | | |
| | etherification: 1.27 | | transparent liquid, Concentration: | | | |
| | | | 30% Viscosity (25° C.): 32 mPa · s, | | | |
| | | | pH (25° C.): 7.7 | | | |
| 2 | Carboxymelhyl cellulose | 0.2 | Detackifying surfactant: | 0.4 | 50° C. | o′ |
| | Trade name: CMC DAICEL 1330 | | β-naphthalene sulfonate/ | | 90° C. | o |
| | (DAICEL CHEMICAL INDUSTRIES) | | formalin condensate | | | |
| | Properties: Anionic, White | | Trade name: DEMOL N (Kao Corporation) | | | |
| | powdery, Viscosity (1%, 25° C.): | | Properties: Anionic, Light yellow/ | | | |
| | 73 cps pH: 6.8, Degree of | | brown powdery | | | |
| | etherification: 1.27 | | | | | |
| 3 | Sodium alginate | 0.2 | Detackifying, hydrophobicizing, organic | 0.4 | 50° C. | o′ |
| | Trade name: ALGITEX AG-LL | | crosslinking agent: Blocked isocyanate | | 90° C. | o |
| | (Kimica Corporation) | | Trade name: Prominate XC-915 (TAKEDA | | | |
| | Properties: Anionic, Brown granular, | | CHEMICAL INDUSTRIES) | | | |
| | Viscosity (1%, 20° C.): 45 cps | | Properties: Nonionic, White emulsion, | | | |
| | pH: 7.0 | | Trifunctional group, Molecular weight: | | | |
| | | | 1000 Concentration: 43.3%, Viscosity: | | | |
| | | | 160 cps, pH: 6.0 | | | |
| 4 | Sodium alginate | 0.2 | Detackifying, reactive sizing agent: | 1.0 | 50° C. | o′ |
| | Trade name: ALGITEX AG-LL | | Alkyl ketene dimer | | 90° C. | o |
| | (Kimica Corporation) | | Trade name: Sizepine K-910 | | | |
| | Properties: Anionic, Brown granular, | | (ARAKAWA CHEMICAL INDUSTRIES) | | | |
| | Viscosity (1%, 20° C.): 45 cps | | Properties: Anionic, White emulsion, | | | |
| | pH: 7.0 | | Concentration: 15% Viscosity (25° C.): | | | |
| | | | 6 cps, pH (25° C.): 5.5 | | | |
| 5 | Ammonium polyacrylate | 0.2 | Detackifying sizing agent: Strength- | 1.0 | 50° C. | o′ |
| | Trade name: ARON A-30 (Toagosei) | | ened rosin sizing agent | | 90° C. | o |
| | Properties: Anionic, Light brown, | | Trade name: Sizepine E-50 (ARAKAWA | | | |
| | viscous liquid, Concentration: 31.1% | | CHEMICAL INDUSTRIES) | | | |
| | Viscosity (30° C.): 9760 cps, | | Properties: Anionic, Brown, transparent | | | |
| | pH (1%, 25° C.): 8.3 | | liquid, Concentration: 50.4% Viscosity | | | |
| | | | (25° C.): 200 cps, pH (5%, 20° C.): 11.0 | | | |
| 6 | Carboxylate-based acrylic copolymer | 0.2 | Detackifying, reactive sizing agent | 1.0 | 90° C. | o |
| | Trade name: ARON A-7180 (Toagosei) | | Alkyl ketene dimer | | | |
| | Properties: Anionic, Semi-transparent, | | Trade name: Sizepine K-910 | | | |
| | viscous liquid, Concentration: 16.4% | | (ARAKAWA CHEMICAL INDUSTRIES) | | | |
| | Viscosity (25° C.): 20950 cps, | | Properties: Anionic, White emulsion, | | | |
| | pH (25° C.): 9.0 | | Concentration: 15% Viscosity (25° C.): | | | |
| | | | 6 cps, pH (25° C.): 5.5 | | | |
| 7 | Carboxylate-based acrylic copolymer | 0.2 | Detackifying waterproofing agent: | 1.0 | 90° C. | o |
| | Trade name: ARON A-7180 (Toagosei) | | Blocked glyoxal resin (Product of | | | |
| | 0 Viscosity (25° C.): 20950 | | polyamide polyurea glyoxal reaction) | | | |
| | cps, pH (25° C.): 9.0 | | Trade name: Sumirez Resin 5001 | | | |
| | | | (Sumitomo Chemical Group) | | | |
| | | | Properties: Nonionic, Light-colored, | | | |
| | | | transparent liquid, Concentration: | | | |
| | | | 30% Viscosity (25° C.): 32 | | | |
| | | | mPa · s, pH (25° C.): 7.7 | | | |
| 8 | Carboxymethyl cellulose | 0.25 | Detackifying waterproofing agent: | 0.5 | 95° C. | o′ |
| | Trade name: CELLOGEN F-SB | | Blocked glyoxal (Cyclic amide | | | |
| | (DAI-ICHI KOGYO SEIYAKU) | | aldehyde condensate) | | | |
| | Properties: Anionic, White powdery, | | Trade name: SUNREZ 700M | | | |
| | Viscosity (2%, 25° C.): 200 mPa · s | | (OMNOVA Solutions) | | | |
| | Degree of etherification: 0.9 | | Properties: Cationic, Brown liquid, | | | |
| | | | Concentration: 45% Viscosity: 25 cps, | | | |
| | | | pH: 6.0 | | | |
| 9 | Carrageenan | 0.25 | Detackifying waterproofing agent: | 0.5 | 95° C. | o′ |
| | Trade name: Soarace WX165 | | Blocked glyoxal (Cyclic amide | | | |
| | (MRC Polysaccharide) | | aldehyde condensate) | | | |
| | Properties: Anionic, White powdery | | Trade name: Sunrez 700M | | | |
| | pH (1.5%): 8.2 | | (OMNOVA Solutions) | | | |
| | | | Properties: Cationic, Brown liquid, | | | |
| | | | Concentration: 45% Viscosity: 25 cps, | | | |
| | | | pH: 6.0 | | | |
| 10 | Urea phosphorylated starch | 0.25 | Detackifying waterproofing agent: | 0.25 | 95° C. | o |
| | Trade name: MS#4600 | | Zirconium ammonium carbonate | (asZrO₂) | | |
| | (Nihon Shokuhin Kako) | | Trade name: Baycoat 20 | | | |
| | Properties: Anionic, Slightly | | (Nippon Light Metal) | | | |
| | yellow powdery Viscosity | | Properties: Anionic, Slightly yellow | | | |
| | (20%, 50° C.): 74 mPa · s, | | liquid, Concentration: 20% (as ZrO2) | | | |
| | pH: 5.5 | | Viscosity: 8 cps, pH: 9.5 | | | |
| 11 | Carboxymethyl cellulose | 0.25 | Detackifying waterproofing agent: | 0.15 | 95° C. | o′ |
| | Trade name: CELLOGEN PL-15 | | Zirconium ammonium carbonate | (asZrO₂) | | |
| | (DAI-ICHI KOGYO SEIYAKU) | | Trade name: AZ Coat 5800MT (SAN NOPCO) | | | |
| | Properties: Anionic, White powdery, | | Properties: Anionic, Slightly yellow | | | |
| | Viscosity (1%, 25° C.): 15 mPa · s | | liquid, Concentration: 20% (as ZrO2) | | | |
| | Degree of etherification: 0.5 | | Viscosity (25° C.): 10 mPa · s, | | | |
| | | | pH (1%): 9.0 | | | |
| 12 | Phosphorylated guar gum | 0.5 | Detackifying waterproofing agent: | 0.15 | 95° C. | o |
| | Trade name: Mayprofilm 222 | | Zirconium ammonium carbonate | (asZrO₂) | | |
| | (Meyhall AG.) | | Trade name: AZ Coat 5800MT (SAN NOPCO) | | | |
| | Properties: Anionic, yellow | | Properties: Anionic, Slightly yellow | | | |
| | powdery Viscosity (2%): | | liquid, Concentration: 20% (as ZrO2) | | | |
| | 45 mPa · s, pH: 8.0 | | Viscosity (25° C.): 10 mPa · s, | | | |
| | | | pH (1%): 9.0 | | | |
| 13 | Alkali-thickening type acrylic | 0.4 | Detackifying, hydrophobicizing cross- | 0.8 | 95° C. | o′ |
| | emulsion | | linking agent: Oxazoline-based cross- | | | |
| | Trade name: Boncoat 3750 | | linking agent | | | |
| | (DAINIPPON INK AND CHEMICALS) | | Trade name: Epocross WS-500 | | | |
| | Properties: Anionic, Milky white | | (NIPPON SHOKUBAI) | | | |
| | emulsion, Concentration: 23% | | Properties: Light yellow, transparent | | | |
| | Viscosity: 35 cps, pH (1%): 3.0 | | liquid, Concentration: 38.9% Viscosity | | | |
| | | | (25° C.): 1230 mPa · s, pH: 9.1 | | | |

### EXAMPLES 14 to 21

The pre-vulcanized natural rubber latex was incorporated with the nonionic, hydrophilic polymer, and further with the hydrophilic group sealant. It was formed into the film and post-treated for the tackiness test. The result, and the nonionic, hydrophilic polymer and hydrophilic group sealant used in each EXAMPLE are given in Table 2. The post-treatment conditions in each EXAMPLE are described below:

(Post-treatment)

The natural rubber latex film prepared was treated by the following steps in the order described below:

Heating→Leaching→Post-vulcanization

In order to evaluate the effects of the post-treatment, the film was post-treated under two different sets of conditions for the heating and leaching steps: (1) heating at 50° C. for 2 minutes and leaching at 70° C. for 3 minutes, and (2) heating at 90° C. for 5 minutes and leaching at 85° C. for 3 minutes in each of EXAMPLES 14 to 19. Post-treatment temperature and treatment time in each EXAMPLE were:
Heating Leaching Post-vulcanization (EXAMPLES 14 to 19) (1) 50° C., 2 min. 70° C., 3 min. 90° C., 5 min. (EXAMPLES 14 to 19) (2) 90° C., 5 min. 85° C., 3 min. 90° C., 5 min.

The film prepared in each of EXAMPLES 14 to 19 was further treated for post-vulcanization at 110° C. for 5 minutes for the tackiness test.

Heating Leaching Post-vulcanization (EXAMPLE 20) 95° C., 5 min. 85° C., 5 min. 110° C., 10 min. (EXAMPLE 21) 95° C., 7 min. 85° C., 3 min. 110° C., 5 min.

TABLE 2

| | | Incor- | | Incor- | | |
|---|---|---|---|---|---|---|
| | | porated | | porated | Drying | |
| Examples | Nonionic, hydrophilic polymers | quantity | Hydrophilic group blocking agent | quantity | prior to | Test |
| NO. | to be incorporated in the latex | (parts) | to be incorporated in the latex | (parts) | leaching | results |
| 14 | Polyvinyl alcohol | 0.2 | Detackifying waterproofing agent: | 1.0 | 50° C. | o′ |
| | Trade name: DENKA POVAL K-05 (DENKI | | Blocked glyoxal resin (Product of | | 90° C. | o |
| | KAGAKU KOGYO KABUSHIKI KAISHA) | | polyamide polyurea glyoxal | | | |
| | Properties: Nonionic, White to light | | reaction) | | | |
| | yellow powdery, Viscosity: 6.0 mPa · s | | Trade name: Sumirez Resin 5001 | | | |
| | pH: 6.0 | | (Sumitomo Chemical Group) | | | |
| | | | Properties: Nonionic, Light-colored, | | | |
| | | | transparent liquid, Concentration: 30% | | | |
| | | | Viscosity (25° C.): 32 mPa · s, | | | |
| | | | pH (25° C.): 7.7 | | | |
| 15 | Polyvinyl alcohol | 0.2 | Detackifying surfactant: | 0.4 | 50° C. | o′ |
| | Trade name: DENKA POVAL K-05 (DENKI | | β-naphthalene sulfonate/formalin | | 90° C. | o |
| | KAGAKU KOGYO KABUSHIKI KAISHA) | | condensate | | | |
| | Properties: Nonionic, White to light | | Trade name: DEMOL N (Kao Corporation) | | | |
| | yellow powdery, Viscosity: 6.0 mPa · s | | Properties: Anionic, Light yellow/brown | | | |
| | pH: 6.0 | | powdery | | | |
| 16 | Methyl cellulose | 0.2 | Detackifying, hydrophobicizing, organic | 0.4 | 50° C. | o′ |
| | Trade name: Metolose SM-400 | | crosslinking agent: Blocked isocyanate | | 90° C. | o |
| | (Shin-Etsu Chemical) | | Trade name: Prominate XC-915 | | | |
| | Properties: Nonionic, White powdery | | (TAKEDA CHEMICAL INDUSTRIES) | | | |
| | Viscosity (2%, 20° C.): 436 mPa · s | | Properties: Nonionic, White emulsion, | | | |
| | | | Trifunctional group, Molecular weight: | | | |
| | | | 1000 Concentration: 43.3%, Viscosity: | | | |
| | | | 160 cps, pH: 6.0 | | | |
| 17 | Methyl cellulose | 0.2 | Detackifying, reactive sizing agent: | 1.0 | 50° C. | o′ |
| | Trade name: Metolose SM-400 | | Alkyl ketene dimer | | 90° C. | o |
| | (Shin-Etsu Chemical) | | Trade name: Sizepine K-910 | | | |
| | Properties: Nonionic, White powdery | | (ARAKAWA CHEMICAL INDUSTRIES) | | | |
| | Viscosity (2%, 20° C.): 436 mPa · s | | Properties: Anionic, White emulsion, | | | |
| | | | Concentration: 15% Viscosity (25° C.): | | | |
| | | | 6 cps, pH (25° C.): 5.5 | | | |
| 18 | Polyethylene oxide | 0.2 | Detackifying surfactant: Polyoxyethylene | 0.4 | 50° C. | o′ |
| | Trade name: PEO-8 (SUMITOMO | | derivative | | 90° C. | o |
| | SEIKA CHEMICALS) | | Trade name: Emulgen A-60 | | | |
| | Properties: Nonionic, White powdery | | (Kao Corporation) | | | |
| | or granular, pH (0.5%): 7.0 | | Properties: Nonionic, Light yellow | | | |
| | Viscosity (0.5%, 25° C.): 60 mPa · s | | liquid pH (5%): 6.5 | | | |
| 19 | Polyethylene oxide | 0.2 | Detackifying sizing agent: Alkenyl | 1.0 | 50° C. | o′ |
| | Trade name: PEO-8 (SUMITOMO | | succinate | | 90° C. | o |
| | SEIKA CHEMICALS) | | Trade name: Coloparl SS-40 | | | |
| | Properties: Nonionic, White powdery | | (Seiko Chemical Industries) | | | |
| | or granular, pH (0.5%): 7.0 | | Properties: Anionic, Brown liquid, | | | |
| | Viscosity (0.5%, 25° C.): 60 mPa · s | | Concentration: 40.4% Viscosity: 80 cps, | | | |
| | | | pH: 10.4 | | | |
| 20 | Methyl cellulose | 0.25 | Detackifying, waterproofing agent: | 0.1 | 95° C. | o |
| | Trade name: Metolose SM-400 | | Zirconium ammonium carbonate | (asZrO₂) | | |
| | (Shin-Etsu Chemical) | | Trade name: AZ Coat 5800MT (SAN NOPCO) | | | |
| | Properties: Nonionic, White powdery | | Properties: Anionic, Slightly yellow | | | |
| | Viscosity (2%, 20° C.): 436 mPa · s | | liquid, Concentration: 20% (as ZrO2) | | | |
| | | | Viscosity (25° C.): 10 mPa · s, | | | |
| | | | pH (1%): 9.0 | | | |
| 21 | N-methoxymethylated polyamide | 0.25 | Detackifying epoxy compound: Glycerol | 1.0 | 95° C. | o |
| | modification (Water-soluble nylon) | | polyglycidyl ether | | | |
| | Trade name: Toresin Fs-350 | | Trade name: Denacol EX-313 | | | |
| | (Nagase ChemteX Corporation) | | (Nagase Chemtex Corporation) | | | |
| | Properties: Nonionic, Milky white, | | Properties: Anionic, Light yellow | | | |
| | viscous liquid, Concentration: 20% | | liquid Viscosity (25° C.): 150 mPa · s, | | | |
| | Viscosity (30° C.): 350 cps, pH: 7 | | Epoxy equivalents: 141WPE | | | |

### EXAMPLES 22 to 26

The pre-vulcanized natural rubber latex was incorporated with the cationic or ampholytic, hydrophilic polymer which causes no gelation of the natural rubber latex, and further with the hydrophilic group sealant. It was formed into the film and post-treated for the tackiness test. The result, and the cationic or ampholytic, hydrophilic polymer which causes no gelation of the natural rubber latex and hydrophilic group sealant used in each EXAMPLE are given in Table 3. The post-treatment conditions in each EXAMPLE are described below:

(Post-treatment)

The natural rubber latex film prepared was treated by the following steps in the order described below:

Heating→Leaching→Post-vulcanization

Post-treatment temperature and treatment time in each EXAMPLE were:

Heating Leaching Post-vulcanization (EXAMPLES 22 to 26) 95° C., 5 min. 85° C., 5 min. 110° C., 10 min.

TABLE 3

| | | Incorporated | | Incorporated | |
|---|---|---|---|---|---|
| Examples | Cationic or ampholytic, hydrophilic | quantity | Hydrophilic group blocking agent | quantity | Test |
| NO. | polymers to be incorporated in the latex | (parts) | to be incorporated in the latex | (parts) | results |
| 22 | Cationized tapioca starch | 0.25 | Detackifying surfactant: Coconut oil | 0.5 | ◯ |
| | Trade name: Catesize 350 (Nippon NSC) | | fatty acid sodium sarcosine | | |
| | Properties: Cationic, White powdery | | Trade name: Neoscope SCN-35 | | |
| | Viscosity (5%, 40° C.): 17 cps | | (Toho Chemical Industry) | | |
| | | | Properties: Anionic, Light yellow, | | |
| | | | transparent liquid, Concentration: 35% | | |
| | | | pH (1%): 8.2 | | |
| 23 | Cationic styrene/acrylic copolymer | 0.25 | Detackifying waterproofing agent: | 0.25 | ◯ |
| | Trade name: Pearl gum CS (Seiko | | Zirconium ammonium carbonate | (asZrO₂) | |
| | Chemical Industries) | | Trade name: Baycoat 20 | | |
| | Properties: Cationic, Light-colored, | | (Nippon Light Metal) | | |
| | transparent, viscous liquid, | | Properties: Anionic, Slightly yellow | | |
| | Concentration: 20.1% Viscosity (25%): | | liquid, Concentration: 20% (as ZrO2) | | |
| | 10 cps, pH (2%): 4.3 | | Viscosity: 8 cps, pH: 9.5 | | |
| 24 | Cationic acrylate ester copolymer | 0.25 | Detackifying waterproofing agent: | 0.15 | ◯ |
| | Trade name: Aquabrid 46753 | | Zirconium ammonium carbonate | (asZrO₂) | |
| | (DAICEL CHEMICAL INDUSTRIES) | | Trade name: AZ Coat 5800MT (SAN NOPCO) | | |
| | Properties: Cationic, Milky white | | Properties: Anionic, Slightly yellow | | |
| | emulsion, Concentration: 30% Viscosity | | liquid, Concentration: 20% (as ZrO2) | | |
| | (23° C.): 320 mPa · s, pH: 6.7 | | Viscosity (25° C.): 10 mPa · s, | | |
| | | | pH (1%): 9.0 | | |
| 25 | Ampholytic polyacryloamide | 0.4 | Detackifying sizing agent: Strengthened | 1.0 | ◯ |
| | Trade name: Fixter K-6LS | | rosin sizing agent | | |
| | (Seiko Chemical Industries) | | Trade name: Sizepine E-50 | | |
| | Properties: Ampholytic, Light brown, | | (ARAKAWA CHEMICAL INDUSTRIES) | | |
| | transparent, viscous liquid, | | Properties: Anionic, Brown, transparent | | |
| | Concentration: 15.2% Viscosity | | liquid, Concentration: 50.4% Viscosity | | |
| | (25° C.): 680 cps, pH (1.5%): 4.7 | | (25° C.): 200 cps, pH (5%, 20° C.): 11.0 | | |
| 26 | Ampholytic polyacryloamide | 0.25 | Detackifying waterproofing agent: | 0.25 | ◯ |
| | Trade name: Fixter K-6LS | | Zirconium ammonium carbonate | (asZrO₂) | |
| | (Seiko Chemical Industries) | | Trade name: Baycoat 20 | | |
| | Properties: Ampholytic, Light brown, | | (Nippon Light Metal) | | |
| | transparent, viscous liquid, | | Properties: Anionic, Slightly yellow | | |
| | Concentration: 15.2% Viscosity | | liquid, Concentration: 20% (as ZrO2) | | |
| | (25° C.): 680 cps, pH (1.5%): 4.7 | | Viscosity: 8 cps, pH: 9.5 | | |

### EXAMPLES 27 to 36

The pre-vulcanized natural rubber latex was incorporated with the anionic, hydrophilic polymer, and further surface treated with the hydrophilic group sealant. It was formed into the film for the tackiness test. The result, and the anionic, hydrophilic polymer and hydrophilic group sealant used in each EXAMPLE are given in Table 4. The post-treatment conditions in each EXAMPLE are described below:

(Post-treatment)

The natural rubber latex film film prepared was surface-treated for both surfaces by the following procedure in the order described below, unless otherwise stated:

Heating→Immersion in the solution for treating the external surface→Drying→Leaching→Post-vulcanization

Post-treatment temperature and treatment time in each EXAMPLE were:

### EXAMPLES 27 to 31

Heating: 50° C., 2 min., Drying: 90° C., 5 min. Leaching: 75° C., 3 min., Post-vulcanization: 90° C., 3 min.

The film prepared in each of EXAMPLES 27 to 31 was further treated for post-vulcanization at 110° C. for 5 minutes for the tackiness test.

### EXAMPLE 32

The film was heated at 50° C. for 2 minutes, and leached at 70° C. for 3 minutes. Then, it was heated at 90° C. for 1 minute, and immersed in the hydrophilic group sealant solution for treating the external surface for 5 seconds. Furthermore, it was dried at 90° C. for 3 minutes, and finally post-vulcanized at 110° C. for 5 minutes.

### EXAMPLE 33

Heating: 90° C., 5 min., Drying: 90° C., 3 min. Leaching: 70° C., 3 min., Post-vulcanization: 110° C., 5 min.

### EXAMPLE 34

Heating: 50° C., 2 min., Drying: 90° C., 5 min. Leaching: 70° C., 3 min., Post-vulcanization: 120° C., 5 min.

### EXAMPLE 35

The film was heated at 50° C. for 3 minutes, and leached at 75° C. for 3 minutes. Then, it was heated at 90° C. for 1 minute, and immersed in the hydrophilic group sealant solution for treating the external surface for 5 seconds. Furthermore, it was post-vulcanized at 95° C. for 5 minutes.

### EXAMPLE 36

Heating: 50° C., 1 minute, Drying: 90° C., 5 min. Leaching: 75° C., 5 min., Post-vulcanization: 90° C., 12 min.

TABLE 4

| | | Incorporated | | | |
|---|---|---|---|---|---|
| Examples | Anionic, hydrophilic polymers | quantity | Hydrophilic group blocking agent | Concen- | Test |
| NO. | to be incorporated in the latex | (parts) | for treating both surfaces | tration (%) | results |
| 27 | Carboxymethyl cellulose | 0.2 | Detackifying sizing agent: Strengthened | 0.5 | o |
| | Trade name: CMC DAICEL 1330 | | rosin sizing agent | | |
| | (DAICEL CHEMICAL INDUSTRIES) | | Trade name: Sizepine E-50 | | |
| | Properties: Anionic, White powdery, | | (ARAKAWA CHEMICAL INDUSTRIES) | | |
| | Viscosity (1%, 25° C.): 73 cps | | Properties: Anionic, Brown, transparent | | |
| | pH: 6.8, Degree of etherification: 1.27 | | liquid, Concentration: 50.4% Viscosity | | |
| | | | (25° C.): 200 cps, pH (5%, 20° C.): 11.0 | | |
| 28 | Carboxymethyl cellulose | 0.2 | Detackifying surfactant: Polyoxyethylene | 0.4 | o |
| | Trade name: CMC DAICEL 1330 | | derivative | | |
| | (DAICEL CHEMICAL INDUSTRIES) | | Trade name: Emulgen A-60 (Kao Corporation) | | |
| | Properties: Anionic, White powdery, | | Properties: Nonionic, Light yellow liquid | | |
| | Viscosity (1%, 25° C.): 73 cps | | pH (5%): 6.5 | | |
| | pH: 6.8, Degree of etherification: 1.27 | | | | |
| 29 | Sodium alginate | 0.2 | Detackifying crosslinking agent of metallic | 0.5 | o |
| | Trade name: ALGITEX AG-LL | | element: Polyaluminum hydroxide | (asAl₂O₃) | |
| | (Kimica Corporation) | | Trade name: Paho#2S (Asada Kagaku Kogyo) | | |
| | Properties: Anionic, Brown granular, | | Properties: Cationic, Light yellow, | | |
| | Viscosity (1%, 20° C.): 45 cps | | transparent liquid, Viscosity (30° C.): | | |
| | pH: 7.0 | | 7 cps Concentration: 10.5% (as Al2O3), pH: 3.5 | | |
| 30 | Sodium alginate | 0.2 | Detackifying, hydrogen bond adjustor: | 0.3 | o |
| | Trade name: ALGITEX AG-LL | | Polyamide/polyamine epichlorohydrin resin | | |
| | (Kimica Corporation) | | Trade name: Sumirez Resin 675 | | |
| | Properties: Anionic, Brown granular, | | (Sumitomo Chemical Group) | | |
| | Viscosity (1%, 20° C.): 45 cps | | Properties: Cationic, Brown, transparent | | |
| | pH: 7.0 | | liquid, Concentration: 25% Viscosity | | |
| | | | (25° C.): 200 mPa · s, pH (25° C.): 4.1 | | |
| 31 | Ammonium polyacrylate | 0.2 | Detackifying, reactive sizing agent | 1.0 | o |
| | Trade name: ARON A-30 (Toagosei) | | (waterproofing agent): Alkyl ketene dimer | | |
| | Properties: Anionic, Light brown, | | Trade name: Sizepine K-287 | | |
| | viscous liquid, Concentration: 31.1% | | (ARAKAWA CHEMICAL INDUSTRIES) | | |
| | Viscosity (30° C.): 9760 cps, | | Properties: Cationic, White emulsion, | | |
| | pH (1%, 25° C.): 8.3 | | Concentration: 20% Viscosity (25° C.): | | |
| | | | 40 cps, pH (20° C.): 3.7 | | |
| 32 | Carboxymethyl cellulose | 1.0 | Detackifying crosslinking agent of | 0.5 | o |
| | Trade name: CMC DAICEL 1330 | | metallic element: Polyaluminum hydroxide | (asAl₂O₃) | |
| | (DAICEL CHEMICAL INDUSTRIES) | | Trade name: Paho#2S (Asada Kagaku Kogyo) | | |
| | Properties: Anionic, White powdery, | | Properties: Cationic, Light yellow, | | |
| | Viscosity (1%, 25° C.): 73 cps | | transparent liquid, Viscosity (30° C.): | | |
| | pH: 6.8, Degree of etherification: 1.27 | | 7 cps Concentration: 10.5% (as Al2O3), pH: 3.5 | | |
| 33 | Carboxymethyl cellulose | 1.0 | Detackifying crosslinking agent of | 0.5 | o |
| | Trade name: CMC DAICEL 1330 | | metallic element: Polyaluminum hydroxide | (asAl₂O₃) | |
| | (DAICEL CHEMICAL INDUSTRIES) | | Trade name: Paho#2S (Asada Kagaku Kogyo) | | |
| | Properties: Anionic, White powdery, | | Properties: Cationic, Light yellow, | | |
| | Viscosity (1%, 25° C.): 73 cps | | transparent liquid, Viscosity (30° C.): | | |
| | pH: 6.8, Degree of etherification: 1.27 | | 7 cps Concentration: 10.5% (as Al2O3), | | |
| | | | pH: 3.5 | | |
| 34 | Carboxymethyl cellulose | 0.25 | Detackifying, hydrogen bond adjustor: | 1.0 | o |
| | Trade name: CMC DAICEL 1330 | | Polyamide/polyamine epichlorohydrin resin | | |
| | (DAICEL CHEMICAL INDUSTRIES) | | Trade name: Sumirez Resin 675 | | |
| | Properties: Anionic, White powdery, | | (Sumitomo Chemical Group) | | |
| | Viscosity (1%, 25° C.): 73 cps | | Properties: Cationic, Brown, transparent | | |
| | pH: 6.8, Degree of etherification: 1.27 | | liquid, Concentration: 25% Viscosity | | |
| | | | (25° C.): 200 mPa · s, pH (25° C.): 4.1 | | |
| 35 | Carboxylate-based acrylic copolymer | 0.2 | Detackifying, reactive sizing agent | 0.5 | o |
| | Trade name: ARON A-7180 (Toagosei) | | (waterproofing agent): Alkyl ketene dimer | | |
| | Properties: Anionic, Semi-transparent, | | Trade name: Sizepine K-287 | | |
| | viscous liquid, Concentration: 16.4% | | (ARAKAWA CHEMICAL INDUSTRIES) | | |
| | Viscosity (25° C.): 20950 cps, | | Properties: Cationic, White emulsion, | | |
| | pH (25° C.): 9.0 | | Concentration: 20% Viscosity (25° C.): | | |
| | | | 40 cps, pH (20° C.): 3.7 | | |
| 36 | Carboxylate-based acrylic copolymer | 0.2 | Detackifying, hydrogen bond adjustor: | 0.3 | o |
| | Trade name: ARON A-7180 (Toagosei) | | Polyamide/polyamine epichlorohydrin resin | | |
| | Properties: Anionic, Semi-transparent, | | Trade name: Sumirez Resin 6615 | | |
| | viscous liquid, Concentration: 16.4% | | (Sumitomo Chemical Group) | | |
| | Viscosity (25° C.): 20950 cps, | | Properties: Cationic, Brown, transparent | | |
| | pH (25° C.): 9.0 | | liquid, Concentration: 15% Viscosity | | |
| | | | (25° C.): 40 mPa · s, pH (25° C.): 4.0 | | |

### EXAMPLES 37 to 49

The pre-vulcanized natural rubber latex was incorporated with the nonionic, hydrophilic polymer, and further surface treated with the hydrophilic group sealant. It was formed into the film for the tackiness test. The result, and the nonionic, hydrophilic polymer and hydrophilic group sealant used in each EXAMPLE are given in Table 5. The post-treatment conditions in each EXAMPLE are described below:

(Post-treatment)

The natural rubber latex film film prepared was surface-treated for both surfaces by the following procedure in the order described below, unless otherwise stated:

Heating→Immersion in the solution for treating the external surface→Drying→Leaching→Post-vulcanization

Post-treatment temperature and treatment time in each EXAMPLE were:

### EXAMPLES 37 to 42

Heating: 50° C., 2 min., Drying: 90° C., 5 min. Leaching: 85° C., 3 min., Post-vulcanization: 90° C., 3 min.

The film prepared in each of EXAMPLES 37 to 42 was further treated for post-vulcanization at 110° C. for 5 minutes for the tackiness test.

### EXAMPLE 43

The film was heated at 50° C. for 2 minutes, and leached at 70° C. for 3 minutes. Then, it was heated at 90° C. for 1 minute, and immersed in the hydrophilic group sealant solution for treating the external surface for 5 seconds. Furthermore, it was dried at 90° C. for 3 minutes, and finally post-vulcanized at 110° C. for 5 minutes.

### EXAMPLE 44

Heating: 90° C., 5 min., Drying: 90° C., 3 min. Leaching: 70° C., 3 min., Post-vulcanization: 110° C., 5 min.

### EXAMPLE 45

Heating: 40° C., 1 minute, Drying: 95° C., 5 min. Leaching: 50° C., 3 min., Post-vulcanization: 110° C., 5 min.

### EXAMPLES 46 and 47

Heating: 40° C., 1 minute, Drying: 90° C., 7 min. Leaching: 85° C., 3 min., Post-vulcanization: 110° C., 5 min.

### EXAMPLES 48 and 49

The film was heated at 50° C. for 5 minutes, and leached at 85° C. for 3 minutes. Then, it was heated at 95° C. for 1 minute, and immersed in the hydrophilic group sealant solution for treating the external surface for 5 seconds. Furthermore, it was dried at 95° C. for 3 minutes, leached at 85° C. for 1 minute and finally post-vulcanized at 110° C. for 5 minutes.

TABLE 5

| | | Incorporated | | | |
|---|---|---|---|---|---|
| Examples | Nonionic, hydrophilic polymers | quantity | Hydrophilic group blocking agent | Concen- | Test |
| NO. | to be incorporated in the latex | (parts) | for treating both surfaces | tration (%) | results |
| 37 | Polyvinyl alcohol | 0.2 | Detackifying sizing agent: Strengthened | 0.5 | o |
| | Trade name: DENKA POVAL K-05 | | rosin sizing agent | | |
| | (DENKI KAGAKU KOGYO KABUSHIKI | | Trade name: Sizepine E-50 | | |
| | KAISHA) | | (ARAKAWA CHEMICAL INDUSTRIES) | | |
| | Properties: Nonionic, While to | | Properties: Anionic, Brown, transparent | | |
| | light yellow powdery, Viscosity: | | liquid, Concentration: 50.4% Viscosity | | |
| | 6.0 mPa · s pH: 6.0 | | (25° C.): 200 cps, pH (5%, 20° C.): 11.0 | | |
| 38 | Polyvinyl alcohol | 0.2 | Detackifying, reactive sizing agent | 0.5 | o |
| | Trade name: DENKA POVAL K-05 | | (waterproofing agent): Alkyl ketene dimer | | |
| | (DENKI KAGAKU KOGYO KABUSHIKI | | Trade name: Sizepine K-287 | | |
| | KAISHA) | | (ARAKAWA CHEMICAL INDUSTRIES) | | |
| | Properties: Nonionic, White to | | Properties: Cationic, White emulsion, | | |
| | light yellow powdery, Viscosity: | | Concentration: 20% Viscosity (25° C.): | | |
| | 6.0 mPa · s pH: 6.0 | | 40 cps, pH (20° C.): 3.7 | | |
| 39 | Methyl cellulose | 0.2 | Detackifying surfactant: Polyoxyethylene | 0.4 | o |
| | Trade name: Metolose SM-400 | | derivative | | |
| | (Shin-Etsu Chemical) | | Trade name: Emulgen A-60 | | |
| | Properties: Nonionic, White | | (Kao Corporation) | | |
| | powdery Viscosity (2%, 20° C.): | | Properties: Nonionic, Light yellow | | |
| | 436 mPa · s | | liquid pH (5%): 6.5 | | |
| 40 | Methyl cellulose | 0.2 | Detackifying, hydrogen bond adjustor: | 0.3 | o |
| | Trade name: Metolose SM-400 | | Polyamide/polyamine epichlorohydrin | | |
| | (Shin-Etsu Chemical) | | resin | | |
| | Properties: Nonionic, White | | Trade name: Sumirez Resin 675 | | |
| | powdery Viscosity (2%, 20° C.): | | (Sumitomo Chemical Group) | | |
| | 436 mPa · s | | Properties: Cationic, Brown, transparent | | |
| | | | liquid, Concentration: 25% Viscosity | | |
| | | | (25° C.): 200 mPa · s, pH (25° C.): 4.1 | | |
| 41 | Polyethylene oxide | 0.2 | Detackifying crosslinking agent of | 0.5 | o |
| | Trade name: PEO-8 | | metallic element: Aluminum nitrate | (asAl₂O₃) | |
| | (SUMITOMO SEIKA CHEMICALS) | | | | |
| | Properties: Nonionic, White | | | | |
| | powdery or granular, pH (0.5%): | | | | |
| | 7.0 Viscosity (0.5%, 25° C.): | | | | |
| | 60 mPa · s | | | | |
| 42 | Polyethylene oxide | 0.2 | Detackifying sizing agent: Alkenyl | 0.5 | o |
| | Trade name: PEO-8 | | succinate | | |
| | (SUMITOMO SEIKA CHEMICALS) | | Trade name: Coloparl SS-40 | | |
| | Properties: Nonionic, White | | (Seiko Chemical Industries) | | |
| | powdery or granular, pH (0.5%): | | Properties: Anionic, Brown liquid, | | |
| | 7.0 Viscosity (0.5%, 25° C.): | | Concentration: 40.4% Viscosity: 80 cps, | | |
| | 60 mPa · s | | pH: 10.4 | | |
| 43 | Polyvinyl alcohol | 0.25 | Detackifying crosslinking agent of | 0.5 | o |
| | Trade name: DENKA POVAL K-05 | | metallic element: Aluminum nitrate | (asAl₂O₃) | |
| | (DENKI KAGAKU KOGYO KABUSHIKI | | | | |
| | KAISHA) | | | | |
| | Properties: Nonionic, White | | | | |
| | to light yellow powdery, Viscosity: | | | | |
| | 6.0 mPa · s, pH: 6.0 | | | | |
| 44 | Polyvinyl alcohol | 0.25 | Detackifying crosslinking agent of | 0.5 | o |
| | Trade name: DENKA POVAL K-05 | | metallic element: Aluminum nitrate | (asAl₂O₃) | |
| | (DENKI KAGAKU KOGYO KABUSHIKI | | | | |
| | KAISHA) | | | | |
| | Properties: Nonionic, White | | | | |
| | to light yellow powdery, Viscosity: | | | | |
| | 6.0 mPa · s pH: 6.0 | | | | |
| 45 | Polyvinyl alcohol | 0.25 | Detackifying, reactive sizing agent: | 1.0 | o |
| | Trade name: DENKA POVAL K-05 | | Alkyl ketene dimer | | |
| | (DENKI KAGAKU KOGYO KABUSHIKI | | Trade name: Sizepine K-910 | | |
| | KAISHA) | | (ARAKAWA CHEMICAL INDUSTRIES) | | |
| | Properties: Nonionic, White | | Properties: Anionic, White emulsion, | | |
| | to light yellow powdery, Viscosity: | | Concentration: 15% Viscosity (25° C.): | | |
| | 6.0 mPa · s pH: 6.0 | | 6 cps, pH (25° C.): 5.5 | | |
| 46 | Polyethylene oxide | 0.2 | Detackifying, reactive sizing agent: | 1.0 | o |
| | Trade name: PEO-8 | | Alkyl ketene dimer | | |
| | (SUMITOMO SEIKA CHEMICALS) | | Trade name: Sizepine K-910 | | |
| | Properties: Nonionic, White | | (ARAKAWA CHEMICAL INDUSTRIES) | | |
| | powdery or granular, pH (0.5%): | | Properties: Anionic, White emulsion, | | |
| | 7.0 Viscosity (0.5%, 25° C.): | | Concentration: 15% Viscosity (25° C.): | | |
| | 60 mPa · s | | 6 cps, pH (25° C.): 5.5 | | |
| 47 | Polyvinyl alcohol | 0.2 | Internal surface | 1.0 | o |
| | Trade name: DENKA POVAL K-24E | | Detackifying, reactive sizing agent: | | |
| | (DENKI KAGAKU KOGYO KABUSHIKI | | Alkyl ketene dimer | | |
| | KAISHA) | | Trade name: Sizepine K-910 | | |
| | Properties: Nonionic, White | | (ARAKAWA CHEMICAL INDUSTRIES) | | |
| | to light yellow powdery, Viscosity: | | Properties: Anionic, White emulsion, | | |
| | 27 mPa · s, pH: 6.0 | | Concentration: 15% Viscosity (25° C.): | | |
| | | | 6 cps, pH (25° C.): 5.5 | | |
| | | | External surface | | |
| | | | Detackifying, waterproofing agent: | 1.0 | |
| | | | Soudium borate | | |
| 48 | Copolymerized polyamide emulsion | 0.25 | Detackifying crosslinking agent of | 1.0 | o |
| | Trade name: Griltex 2 Suspension | | metallic element: Alumina sol | (asAl₂O₃) | |
| | (EMS SHOWA DENKO K.K.) | | Trade name: Alumina sol 200 | | |
| | Properties: Nonionic, Milky white | | (Nissan Chemical Industries) | | |
| | aqueous solution, Concentration: 40%, | | Properties: Cationic, Milky white, | | |
| | Viscosity: 1500 cps, pH: 9.5 | | colloidal solution, Concentration: | | |
| | | | 10.1% (as Al2O3) Viscosity (20° C.): | | |
| | | | 530 mPa · s, pH (20° C.): 4.8 | | |
| 49 | Polyvinyl butyral resin emulsion | 0.25 | Detackifying crosslinking agent of | 1.0 | o |
| | Trade name: Rezem VB-1 | | metallic element: Alumina sol | (asAl₂O₃) | |
| | (CHUKYO YUSHI) | | Trade name: Alumina sol 200 | | |
| | Properties: Nonionic, White liquid, | | (Nissan Chemical Industries) | | |
| | Concentration: 35% Viscosity | | Properties: Cationic, Milky white, | | |
| | (25° C.): 20 mPa · s, | | colloidal solution, Concentration: | | |
| | pH (diluted 10 times): 7.2 | | 10.1% (as Al2O3) Viscosity (20° C.): | | |
| | | | 530 mPa · s, pH (20° C.): 4.8 | | |

### EXAMPLES 50 to 53

The pre-vulcanized natural rubber latex was incorporated with the cationic or ampholytic, hydrophilic polymer which causes no gelation of the natural rubber latex, and further surface treated with the hydrophilic group sealant. It was formed into the film for the tackiness test. The result, and the cationic or ampholytic, hydrophilic polymer which causes no gelation of the natural rubber latex and hydrophilic group sealant used in each EXAMPLE are given in Table 6. The post-treatment conditions in each EXAMPLE are described below:

(Post-treatment)

The natural rubber latex film film prepared was surface-treated for both surfaces by the following procedure in the order described below, unless otherwise stated:

Heating→Immersion in the solution for treating the external surface→Drying→Leaching→Post-vulcanization

Post-treatment temperature and treatment time in each EXAMPLE were:

### EXAMPLE 50

Heating: 40° C., 5 min., Drying: 95° C., 7 min. Leaching: 85° C., 3 minutes, Post-vulcanization: 110° C., 10 minutes

### EXAMPLES 51 and 53

Heating: 50° C., 5 min., Drying: 95° C., 5 min. Leaching: 85° C., 3 min., Post-vulcanization: 110° C., 10 min.

### EXAMPLE 52

Heating: 40° C., 5 min., Drying: 90° C., 10 min. Leaching: 85° C., 3 min., Post-vulcanization: 110° C., 10 min.

TABLE 6

| | | Incorporated | | | |
|---|---|---|---|---|---|
| Examples | Cationic or ampholytic, hydrophilic | quantity | Hydrophilic group selants for | Concen- | Test |
| NO. | polymers to be incorporated in the latex | (parts) | treating both surfaces | tration (%) | results |
| 50 | Cationic styrene/acrylic copolymer | 0.3 | Detackifying surfactant: β-naphthalene | 1.0 | o |
| | Trade name: Pearl gum CS(Seiko | | sulfonate/formalin condensate | | |
| | Chemical Industries) | | Trade name: DEMOL N (Kao Corporation) | | |
| | Properties: Cationic, Light-colored, | | Properties: Anionic, Light yellow/brown | | |
| | transparent, viscous liquid, | | powdery | | |
| | Concentration: 20.1% | | | | |
| | Viscosity (25%): 10 cps, pH (2%): 4.3 | | | | |
| 51 | Cationic polyamide resin | 0.25 | Detackifying, hydrogen bond adjustor: | 0.5 | o′ |
| | Trade name: Arafix 255 (ARAKAWA | | Polyamide/polyamine epichlorohydrin resin | | |
| | CHEMICAL INDUSTRIES) | | Trade name: Euramine P5600 (Mitsui Chemicals) | | |
| | Properties: Cationic, Brown, | | Properties: Cationic, Light yellow, | | |
| | transparent liquid, Concentration: 26% | | transparent liquid, Concentration: 31% | | |
| | Viscosity (25° C.): 183 mPa · s, | | Viscosity (25° C.): 71.3 mPa · s, | | |
| | pH (20° C.): 3.05 | | pH (25° C.): 4.5 | | |
| 52 | Ampholytic guar gum | 0.4 | Detackifying, hydrophobicizing, organic | 2.0 | o |
| | Trade name: Meyprobond 120 (SANSHO) | | crosslinking agent: Blocked isocyanate | | |
| | Properties: Ampholytic, yellow powdery | | Trade name: Prominate XC-915 (TAKEDA | | |
| | Viscosity (1%, 25° C.): 800 cps, pH: 10 | | CHEMICAL INDUSTRIES) | | |
| | | | Properties: Nonionic, White emulsion, | | |
| | | | Trifunctional group, Molecular weight: 1000 | | |
| | | | Concentration: 43.3%, Viscosity: | | |
| | | | 160 cps, pH: 6.0 | | |
| 53 | Ampholytic polyacryloamide | 0.3 | Detackifying waterproofing agent: | 0.5 | o |
| | Trade name: Polymerjet 902 (ARAKAWA | | Branched polyethyleneimine | | |
| | CHEMICAL INDUSTRIES) | | Trade name: Epomine P-1000 (NIPPON SHOKUBAI) | | |
| | Properties: Ampholytic, Light yellow, | | Properties: Cationic, Light yellow, | | |
| | slightly turbid liquid | | transparent, viscous liquid, Concentration: 29.9% | | |
| | Viscosity (25° C.): 1800 mPa · s, | | Viscosity (25° C.): 633 mPa · s, | | |
| | pH (20° C.): 3.1 | | pH (5%): 10.6 | | |

### EXAMPLES 54 and 55

The pre-vulcanized deproteinized natural rubber latex was incorporated with 0.25 parts of the hydrophilic polymer, and further surface treated with the hydrophilic group sealant. It was formed into the film for the tackiness test. The result, and the hydrophilic polymer and hydrophilic group sealant used in each EXAMPLE are given in Table 7. The post-treatment conditions and deproteinized natural rubber latex used in each EXAMPLE are described below:

(Deproteinized natural rubber latex)

SELATEX FDPNR2100 (Sumitomo Rubber Ind.)
Solid concentration: 61.7%, pH: almost 10.9
Pre-vulcanization conditions:
Sulfur: 0.7 parts
Zinc oxide: 1.0 part
Zinc di-n-butyldithiocarbamate: 0.8 parts

Curing conditions: 40° C. for 48 hours

(Post-treatment)

The natural rubber latex film film prepared was surface-treated for both surfaces by the following procedure in the order described below, unless otherwise stated:

Heating→Immersion in the solution for treating the external surface→Drying→Leaching→Post-vulcanization

Post-treatment temperature and treatment time in each EXAMPLE were:

### EXAMPLE 54

Heating: 50° C., 5 min., Drying: 95° C., 7 min. Leaching: 85° C., 3 min., Post-vulcanization: 110° C., 10 min.

### EXAMPLES 55

Heating: 95° C., 2 min., Drying: 95° C., 5 min. Leaching: 70° C., 3 min., Post-vulcanization: 110° C., 10 min.

TABLE 7

| | | Incorporated | | | |
|---|---|---|---|---|---|
| Examples | Hydrophilic polymers to be | quantity | Hydrophilic group selants for | Concen- | Test |
| NO. | incorporated in the latex | (parts) | treating both surfaces | tration (%) | results |
| 54 | Carboxymethyl cellulose | 0.25 | Detackifying, reactive sizing agent | 1.0 | o |
| | Trade name: CMC DAICEL 1330 | | (waterproofing agent): Alkyl ketene dimer | | |
| | (DAICEL CHEMICAL INDUSTRIES) | | Trade name: Sizepine K-287 | | |
| | Properties: Anionic, White powdery, | | (ARAKAWA CHEMICAL INDUSTRIES) | | |
| | Viscosity (1%, 25° C.): 73 cps | | Properties: Cationic, White emulsion, | | |
| | pH: 6.8, Degree of etherification: 1.27 | | Concentration: 20% Viscosity (25° C.): | | |
| | | | 40 cps, pH (20° C.): 3.7 | | |
| 55 | Methyl cellulose | 0.25 | Detackifying crosslinking agent of | 0.5 | o |
| | Trade name: Metolose SM-400 | | metallic element: Polyaluminum hydroxide | (asAl₂O₃) | |
| | (Shin-Etsu Chemical) | | Trade name: Paho#2S (Asada Kagaku Kogyo) | | |
| | Properties: Nonionic, White | | Properties: Cationic, Light yellow, | | |
| | powdery Viscosity (2%, 20° C.): | | transparent liquid, Viscosity (30° C.): | | |
| | 436 mPa · s | | 7 cps Concentration: 10.5% (as Al2O3), | | |
| | | | pH: 3.5 | | |

### EXAMPLES 56 to 62

The pre-vulcanized natural rubber latex was incorporated with the detackifying, hydrophilic polymer. It was formed into the film and post-treated for the tackiness test. The sample whose external surface was coating-treated with the detackifying, carboxylated, synthetic rubber latex and halogenation-treated was also tested by the tackiness test. The tackiness test result, and the detackifying, hydrophilic polymer used in each EXAMPLE are given in Table 8. The post-treatment, external surface coating treatment, carboxylated NBR used, carboxyl group sealant used, and halogenation treatment are described below:

(Post-treatment)

The natural rubber latex film prepared was treated by the following steps in the order described below:

Heating→Leaching→Post-vulcanization

Post-treatment temperature and treatment time in each EXAMPLE were:
Heating Leaching Post-vulcanization (EXAMPLES 56 to 62) 90° C., 5 min. 85° C., 3 min. 110° C., 5 min.
   (External Surface Coating Treatment Step)

The natural rubber latex film prepared was treated by the following steps in the order described below:

Heating (1)→Immersion in the solution for treating the external surface→Heating (2)→Leaching→Post-vulcanization

The treated latex film was 0.1 to 0.13 mm thick, and weighing almost 0.3 g.

Post-treatment temperature and treatment time in each EXAMPLE were:

### EXAMPLES 56 to 62

Heating (1): 50° C., 2 min., Heating (2): 90° C., 5 min., Leaching: 85° C., 3 min., Post-vulcanization: 110° C., 5 min.

(Carboxylated NBR Latex)

Nipol LX-551 (Zeon Corporation)

(Carboxyl Group Sealant)

Detackifying, reactive sizing agent (waterproofing agent): Alkyl ketene dimer

Sizepine K-910 (ARAKAWA CHEMICAL INDUSTRIES)

(External Surface Halogenation Treatment Step)

The natural rubber latex film film prepared was treated by the following steps in the order described below:

Heating (1)→Immersion in chlorine water→Heating (2)→Leaching→Post-vulcanization

Post-treatment temperature and treatment time in each EXAMPLE were:

### EXAMPLES 56 to 62

Heating (1): 50° C., 5 min., Heating (2): 50° C., 2 min., Leaching: 70° C., 3 min., Post-vulcanization: 90° C., 5 min.

Each was further post-vulcanized at 110° C. for 5 min. for the tackiness test.

TABLE 8

| | | | Test results | | |
|---|---|---|---|---|---|
| | | Incorporated | Method of external surface treatment | | |
| Examples | Detackifying, hydrophilic polymers | quantity | No | Coating | Haloge- |
| NO. | to be incorporated in the latex | (parts) | treatment | treatment | nation |
| 56 | Methyl cellulose | 0.25 | o | o | o |
| | Trade name: Metolose SM-400 | | | | |
| | (Shin-Etsu Chemical) | | | | |
| | Properties: Nonionic, White powdery | | | | |
| | Viscosity (2%, 20° C.): 436 mPa · s | | | | |
| 57 | Locust bean gum | 0.2 | o | o | o |
| | Trade name: Soar Locust A120F | | | | |
| | (MRC Polysaccharides) | | | | |
| | Properties: Nonionic, White powdery | | | | |
| | Viscosity (1%, 25° C.): 1200 cps | | | | |
| 58 | Xanthan gum | 0.2 | o | o | o |
| | Trade name: Soar Xan XG550 | | | | |
| | (MRC Polysaocharides) | | | | |
| | Properties: Anionic, White powdery | | | | |
| | Viscosity (1%, 25° C.): 1500 cps, pH (1%): 7.5 | | | | |
| 59 | Carboxymethyl cellulose | 0.2 | o | o | o |
| | Trade name: Earnet gum FDM | | | | |
| | (DAICEL CHEMICAL INDUSTRIES) | | | | |
| | Properties: Anionic, White powdery | | | | |
| | Viscosity (1%, 25° C.): 161 cps, pH: 7.5 | | | | |
| 60 | Sodium alginate | 0.2 | o | o | o |
| | Trade name: ALGITEX AG-LL | | | | |
| | (Kimica Corporation) | | | | |
| | Properties: Anionic, Brown granular, | | | | |
| | Viscosity (1%, 20° C.): 45 cps pH: 7.0 | | | | |
| 61 | Carrageenan | 0.2 | o | o | o |
| | Trade name: Soar Ace WX165 | | | | |
| | (MRC Polysaccharides) | | | | |
| | Properties: Anionic, White powdery | | | | |
| | pH (1.5%): 8.2 | | | | |
| 62 | Polyamide derivative: Polyoxyethylen | 0.5 | o | o | o |
| | ealkyl ether | | | | |
| | Trade name: Elsoft A | | | | |
| | (Ipposha Oil Industries) | | | | |
| | Properties: Nonionic, Light yellow, | | | | |
| | pasty, Concentration: 15% | | | | |

### EXAMPLES 63 to 78

The pre-vulcanized natural rubber latex was incorporated with the hydrophilic group sealant. It was formed into the film and post-treated for the tackiness test. The result, and the hydrophilic group sealant used in each EXAMPLE are given in Table 9. The post-treatment for each EXAMPLE is described below:

(Post-treatment)

The natural rubber latex film prepared was treated by the following steps in the order described below:

Heating→Leaching→Post-vulcanization

Post-treatment temperature and treatment time in each EXAMPLE were:

Heating Leaching Post-vulcanization (EXAMPLES 63 to 67) 90° C., 5 min. 85° C., 3 min. 110° C., 5 min. (EXAMPLE 68) 90° C., 7 min. 85° C., 3 min. 110° C., 10 min. (EXAMPLES 69 to 71) 95° C., 7 min. 85° C., 3 min. 110° C., 10 min. (EXAMPLE 72) 38° C., 10 min. 70° C., 3 min. 110° C., 10 min. (EXAMPLES 73 to 78) 95° C., 7 min. 85° C., 3 min. 110° C., 10 min.

TABLE 9

| | | Incorporated | |
|---|---|---|---|
| Examples | | quantity | Test |
| NO. | Hydrophilic group blocking agents to be incorporated in the latex | (parts) | results |
| 63 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 64 | Detackifying surfactant: β-naphthalene sulfonate/formalin condensate | 0.4 | o |
| | Trade name: DEMOL N (Kao Corporation) | | |
| | Properties: Anionic, Light yellow/brown powdery | | |
| 65 | Detackifying, hydrophobicizing, organic crosslinking agent: Blocked isocyanate | 0.4 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 66 | Detackifying, reactive sizing agent: Alkyl ketene dimer | 1.0 | o |
| | Trade name: Sizepine K-910 (ARAKAWA CHEMICAL INDUSTRIES) | | |
| | Properties: Anionic, White emulsion, Concentration: 15% | | |
| | Viscosity (25° C.): 6 cps, pH (25° C.): 5.5 | | |
| 67 | Detackifying sizing agent: Strengthened rosin sizing agent | 1.0 | o |
| | Trade name: Sizepine E-50 (ARAKAWA CHEMICAL INDUSTRIES) | | |
| | Properties: Anionic, Brown, transparent liquid, Concentration: 50.4% | | |
| | Viscosity (25° C.): 200 cps, pH (5%, 20° C.): 11.0 | | |
| 68 | Detackifying waterproofing agent: Zirconium ammonium carbonate | 0.5 | o |
| | Trade name: Baycoat 20 (Nippon Light Metal) | (asZrO₂) | |
| | Properties: Anionic, Slightly yellow liquid, Concentration: 20% (as ZrO2) | | |
| | Viscosity: 8 cps, pH: 9.5 | | |
| 69 | Detackifying, hydrophobicizing crosslinking agent: Oxazoline-based crosslinking agent | 1.0 | o′ |
| | Trade name: Epocross WS-500 (NIPPON SHOKUBAI) | | |
| | Properties: Light yellow, transparent liquid, Concentration: 38.9% | | |
| | Viscosity (25° C.): 1230 mPa · s, pH: 9.1 | | |
| 70 | Detackifying, hydrogen bond adjustor: Polyaminepolyurea-based resin | 1.5 | o′ |
| | Trade name: Sumirez Resin 703 (Sumitomo Chemical Group) | | |
| | Properties: Weakly cationic, Brown, transparent liquid, Concentration: 50% | | |
| | Viscosity (25° C.): 65 mPa · s, pH (25° C.): 7.0 | | |
| 71 | Detackifying, hydrogen bond adjustor: Polyamide polyurea-based resin | 1.0 | o′ |
| | Trade name: Sumirez Resin 302 (Sumitomo Chemical Group) | | |
| | Properties: Nonionic, Light yellow, transparent liquid, Concentration: 60% | | |
| | Viscosity (25° C.): 320 mPa · s, pH (25° C.): 6.8 | | |
| 72 | Detackifying, reactive sizing agent: Alkyl ketene dimer | 1.0 | o′ |
| | Trade name: Sizepine K-910 (ARAKAWA CHEMICAL INDUSTRIES) | | |
| | Properties: Anionic, White emulsion, Concentration: 15% | | |
| | Viscosity (25° C.): 6 cps, pH (25° C.): 5.5 | | |
| 73 | Detackifying water repellent: Zirconium-based special wax | 0.25 | o |
| | Trade name: Coat Sizer NZ (DAIWA CHEMICAL INDUSTRIES) | | |
| | Properties: Anionic, Milky white emulsion, Concentration: 30% | | |
| 74 | Detackifying water repellent: Olefin-based resin | 0.3 | o′ |
| | Trade name: Coat Sizer MS-115 (DAIWA CHEMICAL INDUSTRIES) | | |
| | Properties: Anionic, Light brown emulsion, Concentration: 30% | | |
| | pH: 10.0 | | |
| 75 | Detackifying water repellent: Special wax | 0.5 | o′ |
| | Trade name: Coat Sizer MN2L (DAIWA CHEMICAL INDUSTRIES) | | |
| | Properties: Anionic, White emulsion, Concentration: 50% | | |
| | pH: 9.0 | | |
| 76 | Detackifying water repellent: Styrene/acrylate ester copolymer | 0.5 | o′ |
| | Trade name: Polysol AM-600 (SHOWA HIGHPOLYMER) | | |
| | Properties: Anionic, White emulsion, Concentration: 47.1% | | |
| | Viscosity (23° C.): 46.0, pH: 7.5 | | |
| 77 | Detackifying waterproofing agent: Ketone resin | 0.5 | o |
| | Trade name: SI-668 (Nippon PMC corporation) | | |
| | Properties: Nonionic, Slightly white turbid solution, Concentration: 50% | | |
| | Viscosity: 40 cps, pH: 7 | | |
| 78 | Detackifying waterproofing agent: Polyamine epichlorohydrin resin | 0.5 | o |
| | Trade name: PA-625 (Nippon PMC corporation) | | |
| | Properties: Weakly cationic, Light brown, transparent liquid, Concentration: 60% | | |
| | Viscosity: 250 cps, pH (20° C.): 7.0 | | |

### EXAMPLES 79 to 96

The pre-vulcanized natural rubber latex was surface-treated with the hydrophilic group sealant, and formed into the film for the tackiness test. The result, and the hydrophilic group sealant used in each EXAMPLE are given in Table 10. The post-treatment for each EXAMPLE is described below:

(Post-treatment)

The natural rubber latex film film prepared was treated by the following procedure in the order described below, unless otherwise stated:

Heating (1)→Immersion in the solution for treating the external surface→Heating (2)→Leaching→Post-vulcanization

Post-treatment temperature and treatment time in each EXAMPLE were:

### EXAMPLES 79 to 82

Heating (1): 50° C., 2 min., Heating (2): 90° C., 5 min., Leaching: 85° C., 3 min., Post-vulcanization: 110° C., 5 min.

### EXAMPLE 83

Heating (1): 40° C., 5 minutes, Heating (2): 95° C., 5 minutes, Leaching: 85° C., 3 min., Post-vulcanization: 110° C., 5 min.

### EXAMPLE 84

The film was heated at 95° C. for 5 minutes, and leached at 85° C. for 3 minutes. Then, it was heated at 95° C. for 1 minute, and immersed in the hydrophilic group sealant solution for treating the external surface for 5 seconds. Furthermore, it was post-vulcanized at 110° C. for 10 minutes.

### EXAMPLE 85

Heating (1): 95° C., 3 min., Heating (2): 95° C., 10 min., Leaching: 85° C., 3 min., Post-vulcanization: 110° C., 10 min.

### EXAMPLE 86

Heating (1): 95° C., 3 min., Heating (2): 95° C., 7 min., Leaching: 85° C., 3 min., Post-vulcanization: 110° C., 10 min.

### EXAMPLES 87 to 89

Heating (1): 50° C., 5 min., Heating (2): 95° C., 5 min., Leaching: 85° C., 3 min., Post-vulcanization: 110° C., 10 min.

### EXAMPLE 90

The film was heated at 50° C. for 2 minutes, and leached at 85° C. for 3 minutes. Then, it was heated at 90° C. for 1 minute, and immersed in the hydrophilic group sealant solution for treating the external surface for 5 seconds. Furthermore, it was dried at 90° C. for 5 minutes, and finally post-vulcanized at 110° C. for 5 minutes.

### EXAMPLE 91

Heating (1): 38° C., 5 min., Heating (2): 38° C., 5 min., Leaching: 70° C., 3 min., Post-vulcanization: 110° C., 10 min.

### EXAMPLES 92 and 93

Heating (1): 40° C., 5 min., Heating (2): 95° C., 5 min., Leaching: 85° C., 3 min., Post-vulcanization: 110° C., 10 min.

### EXAMPLES 94 and 95

Heating (1): 50° C., 2 min., Heating (2): 95° C., 5 min., Leaching: 85° C., 3 min., Post-vulcanization: 110° C., 10 min.

### EXAMPLE 96

Heating (1): 50° C., 5 min., Heating (2): 95° C., 5 min., Leaching: 85° C., 3 min., Post-vulcanization: 110° C., 10 min.

TABLE 10

| Examples | Hydrophilic group blocking agents | Concen- | Hydrophilic group blocking agents | Concen- | Test |
|---|---|---|---|---|---|
| NO. | for treating the internal surface | tration (%) | for treating the external surface | tration (%) | results |
| 79 | Detackifying surfactant: | 0.5 | Detackifying surfactant: | 0.5 | o |
| | β-naphthalene sulfonate/formalin | | β-naphthalene sulfonate/formalin | | |
| | condensate | | condensate | | |
| | Trade name: DEMOL N (Kao Corporation) | | Trade name: DEMOL N (Kao Corporation) | | |
| | Properties: Anionic, Light yellow/brown | | Properties: Anionic, Light yellow/brown | | |
| | powdery | | powdery | | |
| 80 | Detackifying crosslinking agent of | 0.5 | Detackifying crosslinking agent of | 0.5 | o |
| | metallic element: Polyaluminum hydroxide | (asAl₂O₃) | metallic element: Polyaluminum hydroxide | (asAl₂O₃) | |
| | Trade name: Paho#2S (Asada Kagaku Kogyo) | | Trade name: Paho#2S (Asada Kagaku Kogyo) | | |
| | Properties: Cationic, Light yellow, | | Properties: Cationic, Light yellow, | | |
| | transparent liquid, Viscosity (30° C.): | | transparent liquid, Viscosity (30° C.): | | |
| | 7 cps Concentration: 10.5% (as Al2O3), | | 7 cps Concentration: 10.5% (as Al2O3), | | |
| | pH: 3.5 | | pH: 3.5 | | |
| 81 | Detackifying, hydrogen bond adjustor: | 0.3 | Detackifying, hydrogen bond adjustor: | 0.3 | o |
| | Polyamide/polyamine epichlorohydrin | | Polyamide/polyamine epichlorohydrin resin | | |
| | resin | | Trade name: Sumirez Resin 675 | | |
| | Trade name: Sumirez Resin 675 | | (Sumitomo Chemical Group) | | |
| | (Sumitomo Chemical Group) | | Properties: Cationic, Brown, transparent | | |
| | Properties: Cationic, Brown, | | liquid, Concentration: 25% Viscosity | | |
| | transparent liquid, Concentration: | | (25° C.): 200 mPa · s, pH (25° C.): 4.1 | | |
| | 25% Viscosity (25° C.): 200 mPa · s, | | | | |
| | pH (25° C.): 4.1 | | | | |
| 82 | Detackifying, reactive sizing agent: | 0.5 | Detackifying, reactive sizing agent: | 0.5 | o |
| | Alkyl ketene dimer | | Alkyl ketene dimer | | |
| | Trade name: Sizepine K-910 | | Trade name: Sizepine K-910 | | |
| | (ARAKAWA CHEMICAL INDUSTRIES) | | (ARAKAWA CHEMICAL INDUSTRIES) | | |
| | Properties: Anionic, White emulsion, | | Properties: Anionic, White emulsion, | | |
| | Concentration: 15% Viscosity (25° C.): | | Concentration: 15% Viscosity (25° C.): | | |
| | 6 cps, pH (25° C.): 5.5 | | 6 cps, pH (25° C.): 5.5 | | |
| 83 | Detackifying crosslinking agent of | 0.5 | Detackifying waterproofing agent: | 0.5 | o |
| | metallic element: Polyaluminum hydroxide | (asAl₂O₃) | Zirconium ammonium carbonate | (asAl₂O₃) | |
| | Trade name: Paho#2S (Asada Kagaku Kogyo) | | Trade name: AZ Coat 5800MT (SAN NOPCO) | | |
| | Properties: Cationic, Light yellow, | | Properties: Anionic, Slightly yellow | | |
| | transparent liquid, Viscosity (30° C.): | | liquid, Concentration: 20% (as ZrO2) | | |
| | 7 cps Concentration: 10.5% (as Al2O3), | | Viscosity (25° C.): 10 mPa · s, | | |
| | pH: 3.5 | | pH (1%): 9.0 | | |
| 84 | Detackifying crosslinking agent of | 0.5 | Detackifying crosslinking agent of | 0.5 | o |
| | metallic element: Polyaluminum hydroxide | (asAl₂O₃) | metallic element: Polyaluminum hydroxide | (asAl₂O₃) | |
| | Trade name: Paho#2S (Asada Kagaku Kogyo) | | Trade name: Paho#2S (Asada Kagaku Kogyo) | | |
| | Properties: Cationic, Light yellow, | | Properties: Cationic, Light yellow, | | |
| | transparent liquid, Viscosity (30° C.): | | transparent liquid, Viscosity (30° C.): | | |
| | 7 cps Concentration: 10.5% (as Al2O3), | | 7 cps Concentration: 10.5% (as Al2O3), | | |
| | pH: 3.5 | | pH: 3.5 | | |
| 85 | Detackifying, hydrogen bond adjustor: | 1.5 | Detackifying, hydrogen bond adjustor: | 1.5 | o |
| | Polyamide/polyamine epichlorohydrin | | Polyamide/polyamine epichlorohydrin resin | | |
| | resin | | Trade name: Sumirez Resin 6615 | | |
| | Trade name: Sumirez Resin 6615 | | (Sumitomo Chemical Group) | | |
| | (Sumitomo Chemical Group) | | Properties: Cationic, Brown, transparent | | |
| | Properties: Cationic, Brown, transparent | | liquid, Concentration: 15% Viscosity | | |
| | liquid, Concentration: 15% Viscosity | | (25° C.): 40 mPa · s, pH (25° C.): 4.0 | | |
| | (25° C.): 40 mPa · s, pH (25° C.): 4.0 | | | | |
| 86 | Detackifying, hydrophobicizing, organic | 2.0 | Detackifying, hydrophobicizing, organic | 2.0 | o |
| | crosslinking agent: Blocked isocyanate | | crosslinking agent: Blocked isocyanate | | |
| | Trade name: Prominate XC-915 | | Trade name: Prominate XC-915 | | |
| | (TAKEDA CHEMICAL INDUSTRIES) | | (TAKEDA CHEMICAL INDUSTRIES) | | |
| | Properties: Nonionic, White emulsion, | | Properties: Nonionic, White emulsion, | | |
| | Trifunctional group, Molecular weight: | | Trifunctional group, Molecular weight: | | |
| | 1000 Concentration: 43.3%, Viscosity: | | 1000 Concentration: 43.3%, Viscosity: | | |
| | 160 cps, pH: 6.0 | | 160 cps, pH: 6.0 | | |
| 87 | Detackifying waterproofing agent: | 0.5 | Detackifying waterproofing agent: | 0.5 | o |
| | Branched poryethyleneimine | | Branched poryethyleneimine | | |
| | Trade name: Epomine P-1000 | | Trade name: Epomine P-1000 | | |
| | (NIPPON SHOKUBAI) | | (NIPPON SHOKUBAI) | | |
| | Properties: Cationic, Light yellow, | | Properties: Cationic, Light yellow, | | |
| | transparent, viscous liquid, | | transparent, viscous liquid, | | |
| | Concentration: 29.9% Viscosity (25° C.): | | Concentration: 29.9% Viscosity (25° C.): | | |
| | 633 mPa · s, pH (5%): 10.6 | | 633 mPa · s, pH (5%): 10.6 | | |
| 88 | Detackifying waterproofing agent: | 0.5 | Detackifying waterproofing agent: | 0.5 | o′ |
| | Branched polyethyleneimine | | Branched polyethyleneimine | | |
| | Trade name: Epomine SP-018 | | Trade name: Epomine SP-018 | | |
| | (NIPPON SHOKUBAI) | | (NIPPON SHOKUBAI) | | |
| | Properties: Cationic, Light yellow, | | Properties: Cationic, Light yellow, | | |
| | transparent liquid, Concentration: | | transparent liquid, Concentration: 99.8% | | |
| | 99.8% Viscosity (25° C.): 11000 | | Viscosity (25° C.): 11000 mPa · s, | | |
| | mPa · s, pH (5%): 11.1 | | pH (5%): 11.1 | | |
| 89 | Detackifying, hydrogen bond adjustor: | 0.5 | Detackifying, hydrogen bond adjustor | 0.5 | o |
| | Polyamide/polyamine epichlorohydrin | | Polyamide/polyamine epichlorohydrin | | |
| | resin | | resin | | |
| | Trade name: Euramine P5600 | | Trade name: Euramine P5600 | | |
| | (Mitsui Chemicals) | | (Mitsui Chemicals) | | |
| | Properties: Cationic, Light yellow, | | Properties: Cationic, Light yellow, | | |
| | transparent liquid, Concentration: 31% | | transparent liquid, Concentration: 31% | | |
| | Viscosity (25° C.): 71.3 mPa · s, | | Viscosity (25° C.): 71.3 mPa · s, | | |
| | pH (25° C.): 4.5 | | pH (25° C.): 4.5 | | |
| 90 | Detackifying crosslinking agent of | 0.5 | Detackifying crosslinking agent of | 0.5 | o |
| | metallic element: Polyaluminum hydroxide | (asAl₂O₃) | metallic element: Polyaluminum hydroxide | (asAl₂O₃) | |
| | Trade name: Paho#2S (Asada Kagaku Kogyo) | | Trade name: Paho#2S (Asada Kagaku Kogyo) | | |
| | Properties: Cationic, Light yellow, | | Properties: Cationic, Light yellow, | | |
| | transparent liquid, Viscosity (30° C.): | | transparent liquid, Viscosity (30° C.): | | |
| | 7 cps Concentration: 10.5% (as Al2O3), | | 7 cps Concentration: 10.5% (as Al2O3), | | |
| | pH: 3.5 | | pH: 3.5 | | |
| 91 | Detackifying, reactive sizing agent | 1.0 | Detackifying, reactive sizing agent | 1.0 | o′ |
| | (waterproofing agent): Alkyl ketene | | (waterproofing agent): Alkyl ketene | | |
| | dimer | | dimer | | |
| | Trade name: Sizepine K-287 | | Trade name: Sizepine K-287 | | |
| | (ARAKAWA CHEMICAL INDUSTRIES) | | (ARAKAWA CHEMICAL INDUSTRIES) | | |
| | Properties: Cationic, White emulsion, | | Properties: Cationic, White emulsion, | | |
| | Concentration: 20% Viscosity (25° C.): | | Concentration: 20% Viscosity (25° C.): | | |
| | 40 cps, pH (20° C.): 3.7 | | 40 cps, pH (20° C.): 3.7 | | |
| 92 | Detackifying, hydrogen bond adjustor | 0.5 | Detackifying, hydrogen bond adjustor | 0.5 | o |
| | Polyamidepolyamine epichlorohydrin | | Polyamidepolyamine epichlorohydrin | | |
| | resin | | resin | | |
| | Trade name: Euramine P5600 | | Trade name: Euramine P5600 | | |
| | (Mitsui Chemicals) | | (Mitsui Chemicals) | | |
| | Properties: Cationic, Light yellow, | | Properties: Cationic, Light yellow, | | |
| | transparent liquid, Concentration: 31% | | transparent liquid, Concentration: 31% | | |
| | Viscosity (25° C.): 71.3 mPa · s, | | Viscosity (25° C.): 71.3 mPa · s, | | |
| | pH (25° C.): 4.5 | | pH (25° C.): 4.5 | | |
| 93 | Detackifying waterproofing agent: | 0.5 | Detackifying water repellent: Wax | 0.5 | o |
| | Branched polyethyleneimine | | emulsion | | |
| | Trade name: Epomine P-1000 | | Trade name: Coat Sizer MS-365 | | |
| | (NIPPON SHOKUBAI) | | (DAIWA CHEMICAL INDUSTRIES) | | |
| | Properties: Cationic, Light yellow, | | Properties: Cationic, White emulsion, | | |
| | transparent, viscous liquid, Concen- | | Concentration: 60% pH: 7.0 | | |
| | tration: 29.9% Viscosity (25° C.): | | | | |
| | 633 mPa · s, pH (5%): 10.6 | | | | |
| 94 | Detackifying waterproofing agent: | 0.5 | Detackifying waterproofing agent: | 0.5 | o |
| | Ketone resin | | Ketone resin | | |
| | Trade name: SI-668 | | Trade name: SI-668 | | |
| | (Nippon PMC corporation) | | (Nippon PMC corporation) | | |
| | Properties: Nonionic, Slightly white | | Properties: Nonionic, Slightly white | | |
| | turbid solution, Concentration: 50% | | turbid solution, Concentration: 50% | | |
| | Viscosity: 40 cps, pH: 7 | | Viscosity: 40 cps, pH: 7 | | |
| 95 | Detackifying, reactive sizing agent | 1.0 | Detackifying waterproofing agent: | 0.5 | o |
| | (waterproofing agent): Alkyl ketene | | Polyamine epichlorohydrin resin | | |
| | dimer | | Trade name: PA-625 | | |
| | Trade name: Sizepine K-287 | | (Nippon PMC corporation) | | |
| | (ARAKAWA CHEMICAL INDUSTRIES) | | Properties: Weakly cationic, Light brown, | | |
| | Properties: Cationic, White emulsion, | | transparent liquid, Concentration: 60% | | |
| | Concentration: 20% Viscosity (25° C.): | | Viscosity: 250 cps, pH (20° C.): 7.0 | | |
| | 40 cps, pH (20° C.): 3.7 | | | | |
| 96 | Detackifying releasing agent: | 0.5 | Detackifying releasing agent: | 0.5 | o |
| | Polyethyleneimine octadecyl isocyanate | | Polyethyleneimine octadecyl isocyanate | | |
| | adduct | | adduct | | |
| | Trade name: RP-10W (NIPPON SHOKUBAI) | | Trade name: RP-10W (NIPPON SHOKUBAI) | | |
| | Properties: Cationic, Milky white | | Properties: Cationic, Milky white | | |
| | emulsion, Concentration: 18% Viscosity | | emulsion, Concentration: 18% | | |
| | (25° C.): 98 mPa · s, pH: 8.0 | | Viscosity (25° C.): 98 mPa · s, | | |
| | | | pH: 8.0 | | |

### EXAMPLES 97 to 99

The pre-vulcanized natural rubber latex was treated with the hydrophilic group sealant for the internal surface, and formed into the film. It was then treated with alumina sol, peroxytitania sol or peroxy titania solution for the tackiness test. The result, and the hydrophilic group sealant used in each EXAMPLE are given in Table 11. The post-treatment for each EXAMPLE is described below:

(Post-treatment)

The natural rubber latex film film prepared was treated for both surfaces by the following procedure in the order described below, unless otherwise stated:

Heating (1)→Immersion in the solution for treating the external surface→Heating (2)→Leaching→Post-vulcanization

Post-treatment temperature and treatment time in each EXAMPLE were:

### EXAMPLE 97

The film was heated at 50° C. for 5 minutes, and leached at 85° C. for 3 minutes. Then, it was heated at 95° C. for 1 minute, and immersed in the hydrophilic group sealant solution for treating the external surface for 5 seconds. Furthermore, it was dried at 95° C. for 3 minutes, leached at 85° C. for 1 minute, and finally post-vulcanized at 110° C. for 5 minutes.

### EXAMPLE 98

Heating (1): 50° C., 5 min., Heating (2): 95° C., 5 min., Leaching: 85° C., 3 min., Post-vulcanization: 110° C., 5 min.

### EXAMPLE 99

The film was heated at 50° C. for 5 minutes, and leached at 85° C. for 5 minutes. Then, it was heated at 95° C. for 1 minute, and immersed in the hydrophilic group sealant solution for treating the external surface for 5 seconds. Furthermore, it was dried at 95° C. for 3 minutes, leached at 85° C. for 1 minute and finally post-vulcanized at 110° C. for 5 minutes.

TABLE 11

| Examples | Hydrophilic group blocking agents | Concen- | Hydrophilic group blocking agents | Concen- | Test |
|---|---|---|---|---|---|
| NO. | for treating the internal surface | tration (%) | for treating the external surface | tration (%) | results |
| 97 | Detackifying crosslinking agent | | Detackifying crosslinking agent | | |
| | | | of metallic element: Alumina sol | | |
| | of metallic element: Alumina sol | 1.0 | Trade name: Alumina sol 200 | 1.0 | o |
| | Trade name: Alumina sol 200 | (asAl₂O₃) | (Nissan Chemical Industries) | (asAl₂O₃) | |
| | (Nissan Chemical Industries) | | Properties: Cationic, Milky white, | | |
| | Properties: Cationic, Milky white, | | colloidal solution, Concentration: | | |
| | colloidal solution, Concentration: 10.1% | | 10.1% (as Al2O3) Viscosity (20° C.): | | |
| | (as Al2O3) Viscosity (20° C.): | | 530 mPa · s, pH (20° C.): 4.8 | | |
| | 530 mPa · s, pH (20° C.): 4.8 | | | | |
| 98 | Detackifying crosslinking agent of | 2.0 | Detackifying crosslinking agent of | 1.0 | o |
| | metallic element: Polyaluminum hydroxide | (asAl₂O₃) | metallic element: Peroxy titania sol | (asTiO₂) | |
| | Trade name: Paho#2S (Asada Kagaku Kogyo) | | Trade name: TKS-203 | | |
| | Properties: Cationic, Light yellow, | | (Tayca Corporation) | | |
| | transparent liquid, Viscosity (30° C.): 7 cps | | Properties: Cationic, Milky white | | |
| | Concentration: 10.5% (as Al2O3), pH: 3.5 | | emulsion, Concentration: 20.1% | | |
| | | | (as TiO2) | | |
| 99 | Detackifying crosslinking agent of | 2.0 | Detackifying crosslinking agent of | 1.4 | o |
| | metallic element: Polyaluminum hydroxide | (asAl₂O₃) | metallic element: Peroxy titania | (asTiO₂) | |
| | Trade name: Paho#2S (Asada Kagaku Kogyo) | | solution | | |
| | Properties: Cationic, Light yellow, | | Trade name: TKC-301 | | |
| | transparent liquid, Viscosity (30° C.): 7 cps | | (Tayca Corporation) | | |
| | Concentration: 10.5% (as Al2O3), pH: 3.5 | | Properties: Cationic, yellow, | | |
| | | | transparent liquid, Concentration: | | |
| | | | 1.4% (as TiO2) | | |

### EXAMPLE 100

The pre-vulcanized natural rubber latex was incorporated with the hydrophilic group sealant, and further treated with the hydrophilic group sealant for both surfaces. It was formed into the film for the tackiness test. The result, and the hydrophilic group sealant used in each EXAMPLE are given in Table 12. The post-treatment for each EXAMPLE is described below:

(Post-treatment)

The natural rubber latex film film prepared was dried at 95° C. for 5 minutes, and leached at 85° C. for 3 minutes. Then, it was heated at 95° C. for 1 minute, and immersed in the hydrophilic group sealant solution for treating the external surface for 5 seconds. Furthermore, it was post-vulcanized at 110° C. for 10 minutes.

TABLE 12

| | | Incorporated | | | |
|---|---|---|---|---|---|
| Examples | Hydrophilic group blocking agents | quantity | Hydrophilic group blocking agents | Concen- | Test |
| NO. | to be incorporated in the latex | (parts) | for treating the surface | tration (%) | results |
| 100 | Detackifying waterproofing agent: | 0.5 | Internal surface | 0.5 | o |
| | Zirconium ammonium carbonate | (asZrO₂) | Detackifying crosslinking agent | (asAl₂O₃) | |
| | Trade name: Baycoat 20 | | of metallic element: Polyaluminum | | |
| | (Nippon Light Metal) | | hydroxide | | |
| | Properties: Anionic, Slightly | | Trade name: Paho#2S | | |
| | yellow liquid, Concentration: 20% | | (Asada Kagaku Kogyo) | | |
| | (as ZrO2) Viscosity: 8 cps, pH: 9.5 | | Properties: Cationic, Light yellow, | | |
| | | | transparent liquid, Viscosity (30° C.): | | |
| | | | 7 cps,Concentration: 10.5% (as Al2O3), | | |
| | | | pH: 3.5 | | |
| | | | External Surface | | |
| | | | Detackifying waterproofing agent: | 0.44 | |
| | | | Zirconium ammonium carbonate | (asZrO₂) | |
| | | | Trade name: AZ Coat 5800MT (SAN NOPCO) | | |
| | | | Properties: Anionic, Slightly yellow | | |
| | | | liquid, Concentration: 20% (as ZrO2) | | |
| | | | Viscosity (25° C.): 10 mPa · s, | | |
| | | | pH (1%): 9.0 | | |

### EXAMPLES 101 to 110

The pre-vulcanized natural rubber latex was incorporated with the hydrophilic polymer and hydrophilic group sealant. It was formed into the film, and coating-treated with the detackifying, carboxylated NBR for the external surface. The tackiness test result, and the hydrophilic polymer and hydrophilic group sealant used in each EXAMPLE are given in Table 13. The post-treatment for, and carboxylated NBR and carboxyl group sealant used in, each EXAMPLE are described below:

(Post-treatment)

The natural rubber latex film prepared was treated by the following steps in the order described below:

Heating (1)→Immersion in the solution for treating the external surface→Heating (2)→Leaching→Post-vulcanization

The treated latex film was 0.1 to 0.13 mm thick, and weighing almost 0.3 g.

Post-treatment temperature and treatment time in each EXAMPLE were:

### EXAMPLES 101 to 109

Heating (1): 50° C., 2 min., Heating (2): 50° C., 2 min., Leaching: 70° C., 3 min., Post-vulcanization: 90° C., 5 min.

The film prepared in each of EXAMPLES 101 to 109 was further post-vulcanized at 110° C. for 5 minutes for the tackiness test.

### EXAMPLE 110

Heating (1): 38° C., 5 min., Heating (2): 38° C., 5 min., Leaching: 70° C., 3 min., Post-vulcanization: 110° C., 10 min.

(Carboxylated NBR Latex)

Nipol LX-551 (Zeon Corporation)

(Carboxyl Group Sealant)

Detackifying, reactive sizing agent (waterproofing agent): Alkyl ketene dimer

Sizepine K-910 (ARAKAWA CHEMICAL INDUSTRIES)

TABLE 13

| | Hydrophilic polymers to | | Hydrophilic group blocking agents | | |
|---|---|---|---|---|---|
| | be incorporated in the latex | | to be incorporated in the latex | | |
| | | Incorporated | | Incorporated | |
| Examples | | quantity | | quantity | Test |
| NO. | | (parts) | | (parts) | results |
| 101 | Carboxymethyl cellulose | 0.2 | Detackifying surfactant: | 0.4 | o |
| | Trade name: CMC DAICEL 1330 | | β-naphthalene sulfonate/formalin | | |
| | (DAICEL CHEMICAL INDUSTRIES) | | condensate | | |
| | Properties: Anionic, White | | Trade name: DEMOL N (Kao Corporation) | | |
| | powdery, Viscosity (1%, 25° C.): | | Properties: Anionic, Light yellow/ | | |
| | 73 cps pH: 6.8, Degree of | | brown powdery | | |
| | etherification: 1.27 | | | | |
| 102 | Carboxymethyl cellulose | 0.2 | Detackifying, reactive sizing | 1.0 | o |
| | Trade name: CMC DAICEL 1330 | | agent: Alkyl ketene dimer | | |
| | (DAICEL CHEMICAL INDUSTRIES) | | Trade name: Sizepine K-910 | | |
| | Properties: Anionic, White | | (ARAKAWA CHEMICAL INDUSTRIES) | | |
| | powdery, Viscosity (1%, 25° C.): | | Properties: Anionic, White | | |
| | 73 cps pH: 6.8, Degree of | | emulsion, Concentration: 15% | | |
| | etherification: 1.27 | | Viscosity (25° C.): 6 cps, | | |
| | | | pH (25° C.): 5.5 | | |
| 103 | Carboxymethyl cellulose | 0.2 | Detackifying waterproofing agent: | 1.0 | o |
| | Trade name: CMC DAICEL 1330 | | Blocked glyoxal resin (Product of | | |
| | (DAICEL CHEMICAL INDUSTRIES) | | polyamide polyurea glyoxal reaction) | | |
| | Properties: Anionic, White | | Trade name: Sumirez Resin 5001 | | |
| | powdery, Viscosity (1%, 25° C.): | | (Sumitomo Chemical Group) | | |
| | 73 cps pH: 6.8, Degree of | | Properties: Nonionic, Light- | | |
| | etherification: 1.27 | | colored, transparent liquid, | | |
| | | | Concentration: 30% Viscosity | | |
| | | | (25° C.): 32 mPa · s, pH | | |
| | | | (25° C.): 7.7 | | |
| 104 | Polyethylene oxide | 0.2 | Detackifying surfactant: | 0.4 | o |
| | Trade name: PEO-8 | | Polyoxyethylene derivative | | |
| | SUMITOMO SEIKA CHEMICALS) | | Trade name: Emulgen A-60 | | |
| | Properties: Nonionic, White | | (Kao Corporation) | | |
| | powdery or granular, pH (0.5%): | | Properties: Nonionic, Light | | |
| | 7.0 Viscosity (0.5%, 25° C.): | | yellow liquid pH (5%): 6.5 | | |
| | 60 mPa · s | | | | |
| 105 | Polyethylene oxide | 0.2 | Detackifying, hydrophobicizing, | 0.4 | o |
| | Trade name: PEO-8 | | organic crosslinking agent: | | |
| | (SUMITOMO SEIKA CHEMICALS) | | Blocked isocyanate | | |
| | Properties: Nonionic, White | | Trade name: Prominate XC-915 | | |
| | powdery or granular, pH (0.5%): | | (TAKEDA CHEMICAL INDUSTRIES) | | |
| | 7.0 Viscosity (0.5%, 25° C.): | | Properties: Nonionic, White | | |
| | 60 mPa · s | | emulsion, Trifunctional group, | | |
| | | | Molecular weight: 1000 | | |
| | | | Concentration: 43.3%, Viscosity: | | |
| | | | 160 cps, pH: 6.0 | | |
| 106 | Polyethylene oxide | 0.2 | Detackifying, reactive sizing | 1.0 | o |
| | Trade name: PEO-8 | | agent: Alkyl ketene dimer | | |
| | (SUMITOMO SEIKA CHEMICALS) | | Trade name: Sizepine K-910 | | |
| | Properties: Nonionic, White | | (ARAKAWA CHEMICAL INDUSTRIES) | | |
| | powdery or granular, pH (0.5%): | | Properties: Anionic, White | | |
| | 7.0 Viscosity (0.5%, 25° C.): | | emulsion, Concentration: 15% | | |
| | 60 mPa · s | | Viscosity (25° C.): 6 cps, | | |
| | | | pH (25° C.): 5.5 | | |
| 107 | Polyvinyl alcohol | 0.2 | Detackifying surfactant: | 0.4 | o |
| | Trade name: DENKA POVAL K-05 | | Polyoxyethylene derivative | | |
| | (DENKI KAGAKU KOGYO KABUSHIKI | | Trade name: Emulgen A-60 | | |
| | KAISHA) | | (Kao Corporation) | | |
| | Properties: Nonionic, White | | Properties: Nonionic, Light | | |
| | to light yellow powdery, Viscosity: | | yellow liquid pH (5%): 6.5 | | |
| | 6.0 mPa · s pH: 6.0 | | | | |
| 108 | Polyvinyl alcohol | 0.2 | Detackifying waterproofing agent: | 1.0 | o |
| | Trade name: DENKA POVAL K-05 | | Blocked glyoxal resin (Product of | | |
| | (DENKI KAGAKU KOGYO KABUSHIKI | | polyamide polyurea glyoxal reaction) | | |
| | KAISHA) | | Trade name: Sumirez Resin 5001 | | |
| | Properties: Nonionic, White | | (Sumitomo Chemical Group) | | |
| | to light yellow powdery, Viscosity: | | Properties: Nonionic, Light- | | |
| | 6.0 mPa · s pH: 6.0 | | colored, transparent liquid, | | |
| | | | Concentration: 30% Viscosity | | |
| | | | (25° C.): 32 mPa · s, pH | | |
| | | | (25° C.): 7.7 | | |
| 109 | Polyvinyl alcohol | 0.2 | Detackifying sizing agent: | 1.0 | o |
| | Trade name: DENKA POVAL K-05 | | Alkenyl succinate | | |
| | (DENKI KAGAKU KOGYO KABUSHIKI | | Trade name: Coloparl SS-40 | | |
| | KAISHA) | | (Seiko Chemical Industries) | | |
| | Properties: Nonionic, White | | Properties: Anionic, Brown | | |
| | to light yellow powdery, Viscosity: | | liquid, Concentration: 40.4% | | |
| | 6.0 mPa · s pH: 6.0 | | Viscosity: 80 cps, pH: 10.4 | | |
| 110 | Urea phosphorylated starch | 0.25 | Detackifying waterproofing agent: | 0.25 | o |
| | Trade name: MS#4600 | | Zirconium ammonium carbonate | (asZrO₂) | |
| | (Nihon Shokuhin Kako) | | Trade name: Baycoat 20 | | |
| | Properties: Anionic, Slightly | | (Nippon Light Metal) | | |
| | yellow Powdery Viscosity (20%, | | Properties: Anionic, Slightly | | |
| | 50° C.): 74 mPa · s, pH: 5.5 | | yellow liquid, Concentration: 20% | | |
| | | | (as ZrO2) Viscosity: 8 cps, pH: 9.5 | | |

### EXAMPLES 111 to 122

The pre-vulcanized natural rubber latex was incorporated with the hydrophilic group sealant. It was formed into the film, and coating-treated with the detackifying, carboxylated NBR for the external surface. The tackiness test result, and the hydrophilic group sealant used in each EXAMPLE are given in Table 14. The post-treatment for, and carboxylated NBR and carboxyl group sealant used in, each EXAMPLE are described below:

(Post-treatment)

The natural rubber latex film prepared was treated by the following steps in the order described below:

Heating (1)→Immersion in the solution for treating the external surface→Heating (2)→Leaching→Post-vulcanization

The treated latex film was 0.1 to 0.13 mm thick, and weighing almost 0.3 g.

Post-treatment temperature and treatment time in each EXAMPLE were:

### EXAMPLES 111 to 115

Heating (1): 50° C., 2 min., Heating (2): 90° C., 5 min., Leaching: 85° C., 3 min., Post-vulcanization: 110° C., 5 min.

### EXAMPLES 116 to 120

Heating (1): 50° C., 2 min., Heating (2): 50° C., 2 min., Leaching: 70° C., 3 min., Post-vulcanization: 90° C., 5 min.

The film prepared in each of EXAMPLES 116 to 120 was further post-vulcanized at 110° C. for 5 minutes for the tackiness test.

### EXAMPLES 121 and 122

Heating (1): 38° C., 5 min., Heating (2): 38° C., 5 min., Leaching: 70° C., 3 min., Post-vulcanization: 110° C., 10 min.

(Carboxylated NBR Latex)

Nipol LX-551 (Zeon Corporation)

(Carboxyl Group Sealant)

Detackifying, reactive sizing agent (waterproofing agent): Alkyl ketene dimer

Sizepine K-910 (ARAKAWA CHEMICAL INDUSTRIES)

TABLE 14

| | | Incorporated | |
|---|---|---|---|
| Examples | | quantity | Test |
| NO. | Hydrophilic group blocking agents to be incorporated in the latex | (parts) | results |
| 111 | Detackifying surfactant: β-naphthalene sulfonate/formalin condensate | 0.4 | o |
| | Trade name: DEMOL N (Kao Corporation) | | |
| | Properties: Anionic, Light yellow/brown powdery | | |
| 112 | Detackifying surfactant: Polyoxyethylene derivative | 0.4 | o |
| | Trade name: Emulgen A-60 (Kao Corporation) | | |
| | Properties: Nonionic, Light yellow liquid | | |
| | pH (5%): 6.5 | | |
| 113 | Detackifying sizing agent: Strengthened rosin sizing agent | 1.0 | o |
| | Trade name: Sizepine E-50 (ARAKAWA CHEMICAL INDUSTRIES) | | |
| | Properties: Anionic, Brown, transparent liquid, Concentration: 50.4% | | |
| | Viscosity (25° C.): 200 cps, pH (5%, 20° C.): 11.0 | | |
| 114 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 115 | Detackifying, hydrophobicizing, organic crosslinking agent: Blocked isocyanate | 0.4 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 116 | Detackifying surfactant: β-naphthalene sulfonate/formalin condensate | 0.4 | o |
| | Trade name: DEMOL N (Kao Corporation) | | |
| | Properties: Anionic, Light yellow/brown powdery | | |
| 117 | Detackifying surfactant: Polyoxyethylene derivative | 0.4 | o |
| | Trade name: Emulgen A-60 (Kao Corporation) | | |
| | Properties: Nonionic, Light yellow liquid | | |
| | pH (5%): 6.5 | | |
| 118 | Detackifying, reactive sizing agent: Alkyl ketene dimer | 1.0 | o |
| | Trade name: Sizepine K-910 (ARAKAWA CHEMICAL INDUSTRIES) | | |
| | Properties: Anionic, White emulsion, Concentration: 15% | | |
| | Viscosity (25° C.): 6 cps, pH (25° C.): 5.5 | | |
| 119 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 120 | Detackifying, hydrophobicizing, organic crosslinking agent: Blocked isocyanate | 0.4 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 121 | Detackifying waterproofing agent: Blocked glyoxal | 2.0 | o |
| | (Cyclic amide aldehyde condensate) | | |
| | Trade name: Sumirez 700 M (OMNOVA Solutions) | | |
| | Properties: Cationic, Brown liquid, Concentration: 45% | | |
| | Viscosity: 25 cps, pH: 6.0 | | |
| 122 | Detackifying, hydrogen bond adjustor: Polyamide polyurea-based resin | 1.0 | o |
| | Trade name: Sumirez Resin 302 (Sumitomo Chemical Group) | | |
| | Properties: Nonionic, Light yellow, transparent liquid, Concentration: 60% | | |
| | Viscosity (25° C.): 320 mPa · s, pH (25° C.): 6.8 | | |

### EXAMPLES 123 and 124

The pre-vulcanized natural rubber latex was incorporated with the hydrophilic polymer and/or hydrophilic group sealant. It was formed into the film, and coating-treated with the carboxylated NBR free of the hydrophilic group sealant for the external surface. The tackiness test result, and the hydrophilic polymer and hydrophilic group sealant used in each EXAMPLE are given in Table 15. The post-treatment step in each EXAMPLE is described below. The carboxylated NBR coating solution was a mixture of carboxylated NBR latex and Nipol LX-551 (Zeon Corporation) incorporated with 1.5 parts of zinc white and diluted with water to have the solid content of 5%.

(Post-treatment)

The natural rubber latex film prepared was treated by the following steps in the order described below:

Heating (1)→Immersion in the solution for treating the external surface→Heating (2)→Leaching→Post-vulcanization

The treated latex film was 0.1 to 0.13 mm thick, and weighing almost 0.3 g.

Post-treatment temperature and treatment time in each EXAMPLE were:

### EXAMPLES 123 and 124

Heating (1): 50° C., 2 min., Heating (2): 95° C., 5 min., Leaching: 70° C., 3 min., Post-vulcanization: 95° C., 5 min.

The film prepared in each of EXAMPLES 123 and 124 was further post-vulcanized at 110° C. for 5 minutes for the tackiness test.

TABLE 15

| | Hydrophilic polymers to | | Hydrophilic group blocking agents | | |
|---|---|---|---|---|---|
| | be incorporated in the latex | | to be incorporated in the latex | | |
| | | Incorporated | | Incorporated | |
| Examples | | quantity | | quantity | Test |
| NO. | | (parts) | | (parts) | results |
| 123 | Carboxymethyl cellulose | 0.2 | Detackifying surfactant: | 0.4 | o |
| | Trade name: CMC DAICEL | | β-naphthalene sulfonate/ | | |
| | 1330 (DAICEL CHEMICAL INDUSTRIES) | | formalin condensate | | |
| | Properties: Anionic, White | | Trade name: DEMOL N | | |
| | powdery, Viscosity (1%, 25° C.): | | (Kao Corporation) | | |
| | 73 cps pH: 6.8, Degree of | | Properties: Anionic, Light | | |
| | etherification: 1.27 | | yellow/brown powdery | | |
| 124 | Not used | | Detackifying waterproofing agent: | 0.5 | o |
| | | | Polyamine epichlorohydrin resin | | |
| | | | Trade name: PA-625 (Nippon | | |
| | | | PMC corporation) | | |
| | | | Properties: Weakly cationic, | | |
| | | | Light brown, transparent liquid, | | |
| | | | Concentration: 60% | | |
| | | | Viscosity: 250 cps, pH (20° C.): 7.0 | | |

### EXAMPLES 125 to 127

The pre-vulcanized natural rubber latex was formed into the film, and coating-treated with the detackifying carboxylated NBR for the external surface. The tackiness test result, and the carboxyl group sealant used in each EXAMPLE are given in Table 16. The post-treatment step and carboxylated NBR used in each EXAMPLE are described below.

(Post-treatment)

The natural rubber latex film prepared was treated by the following steps in the order described below:

Heating (1)→Immersion in the solution for treating the external surface→Heating (2)→Leaching→Post-vulcanization

The treated latex film was 0.1 to 0.13 mm thick, and weighing almost 0.3 g.

Post-treatment temperature and treatment time in each EXAMPLE were:

### EXAMPLES 125 to 127

Heating (1): 50° C., 2 min., Heating (2): 95° C., 5 min., Leaching: 85° C., 3 min., Post-vulcanization: 110° C., 5 min.

(Carboxylated NBR Latex)

Nipol LX-551 (Zeon Corporation)

TABLE 16

| | | Incorporated | |
|---|---|---|---|
| Examples | Carboxyl group blocking agents to be incorporated in the coating | quantity | Test |
| NO. | solution of diene-based carboxylated synthetic rubber latex | (parts) | results |
| 125 | Detackifying surfactant: Coconut oil fatty acid sodium sarcosine | 2.5 | o |
| | Trade name: Neoscope SCN-35 (Toho Chemical Industry) | | |
| | Properties: Anionic, Light yellow, transparent liquid, Concentration: 35% | | |
| | pH (1%): 8.2 | | |
| 126 | Detackifying sizing agent: Strengthened rosin sizing agent | 2.5 | o |
| | Trade name: Sizepine E-50 (ARAKAWA CHEMICAL INDUSTRIES) | | |
| | Properties: Anionic, Brown, transparent liquid, Concentration: 50.4% | | |
| | Viscosity (25° C.): 200 cps, pH (5%, 20° C.): 11.0 | | |
| 127 | Detackifying waterproofing agent: Zirconium ammonium carbonate | 2.5 | o |
| | Trade name: Baycoat 20 (Nippon Light Metal) | (asZrO₂) | |
| | Properties: Anionic, Slightly yellow liquid, Concentration: 20% (as ZrO2) | | |
| | Viscosity: 8 cps, pH: 9.5 | | |

### EXAMPLES 128 to 140

The pre-vulcanized natural rubber latex was incorporated with the hydrophilic polymer or hydrophilic group sealant, and treated with the hydrophilic group sealant for the internal surface. It was formed into the film, and coating-treated with the detackifying carboxylated NBR for the external surface. The tackiness test result, and the hydrophilic polymer and hydrophilic group sealant used in each EXAMPLE are given in Table 17. The post-treatment step, and carboxylated NBR, carboxyl group sealant, hydrophilic polymer and hydrophilic group sealant used in each EXAMPLE are described below.

(Post-treatment)

The natural rubber latex film prepared was treated by the following steps in the order described below:

Heating (1)→Immersion in the solution for treating the external surface→Heating (2)→Leaching→Post-vulcanization

Post-treatment temperature and treatment time in each EXAMPLE were:

### EXAMPLES 128 to 136

Heating (1): 50° C., 2 min., Heating (2): 50° C., 2 min., Leaching: 70° C., 3 min., Post-vulcanization: 90° C., 5 min.

The film prepared in each of EXAMPLES 128 to 136 was further post-vulcanized at 110° C. for 5 minutes for the tackiness test.

### EXAMPLES 137 and 138

Heating (1): 40° C., 3 min., Heating (2): 40° C., 3 min., Leaching: 70° C., 3 min., Post-vulcanization: 110° C., 10 min.

### EXAMPLE 139

Heating (1): 38° C., 3 min., Heating (2): 38° C., 5 min., Leaching: 70° C., 3 min., Post-vulcanization: 110° C., 10 min.

### EXAMPLE 140

Heating (1): 50° C., 5 min., Heating (2): 95° C., 5 min., Leaching: 85° C., 3 min., Post-vulcanization: 110° C., 5 min.

(Carboxylated NBR Latex)

Nipol LX-551 (Zeon Corporation)

(Carboxyl Group Sealant)

Detackifying, reactive sizing agent (waterproofing agent): Alkyl ketene dimer

Sizepine K-910 (ARAKAWA CHEMICAL INDUSTRIES)

TABLE 17

| | Hydrophilic polymers or hydrophilic | | | | |
|---|---|---|---|---|---|
| | group blocking agents to be | | | | |
| | incorporated in the latex | | Hydrophilic group blocking agents | | |
| | | Incorporated | for treating the internal surface | | |
| Examples | | quantity | | Concen- | Test |
| NO. | | (parts) | | tration (%) | results |
| 128 | Carboxymethyl cellulose | 0.2 | Detackifying surfactant: | 0.5 | o |
| | Trade name: CMC DAICEL 1330 | | β-naphthalene sulfonate/ | | |
| | (DAICEL CHEMICAL INDUSTRIES) | | formalin condensate | | |
| | Properties: Anionic, White | | Trade name: DEMOL N | | |
| | powdery, Viscosity (1%, 25° C.): | | (Kao Corporation) | | |
| | 73 cps pH: 6.8, Degree of | | Properties: Anionic, Light | | |
| | etherification: 1.27 | | yellow/brown powdery | | |
| 129 | Carboxymethyl cellulose | 0.2 | Detackifying crosslinking agent | 0.5 | o |
| | Trade name: CMC DAICEL 1330 | | of metallic element: Polyaluminum | (asAl₂O₃) | |
| | (DAICEL CHEMICAL INDUSTRIES) | | hydroxide | | |
| | Properties: Anionic, White | | Trade name: Paho#2S | | |
| | powdery, Viscosity (1%, 25° C.): | | (Asada Kagaku Kogyo) | | |
| | 73 cps pH: 6.8, Degree of | | Properties: Cationic, Light | | |
| | etherification: 1.27 | | yellow, transparent liquid, | | |
| | | | Viscosity (30° C.): 7 cps | | |
| | | | Concentration: 10.5% (as Al2O3), | | |
| | | | pH: 3.5 | | |
| 130 | Carboxymethyl cellulose | 0.2 | Detackifying, reactive sizing | 0.5 | o |
| | Trade name: CMC DAICEL 1330 | | agent (waterproofing agent): | | |
| | (DAICEL CHEMICAL INDUSTRIES) | | Alkyl ketene dimer | | |
| | Properties: Anionic, White | | Trade name: Sizepine K-287 | | |
| | powdery, Viscosity (1%, 25° C.): | | (ARAKAWA CHEMICAL INDUSTRIES) | | |
| | 73 cps pH: 6.8, Degree of | | Properties: Cationic, White | | |
| | etherification: 1.27 | | emulsion, Concentration: 20% | | |
| | | | Viscosity (25° C.): 40 cps, | | |
| | | | pH (20° C.): 3.7 | | |
| 131 | Polyethylene oxide | 0.2 | Detackifying surfactant: | 0.4 | o |
| | Trade name: PEO-8 | | Polyoxyethylene derivative | | |
| | (SUMITOMO SEIKA CHEMICALS) | | Trade name: Emulgen A-60 | | |
| | Properties: Nonionic, White | | (Kao Corporation) | | |
| | powdery or granular, pH (0.5%): | | Properties: Nonionic, Light | | |
| | 7.0 Viscosity (0.5%, 25° C.): | | yellow liquid pH (5%): 6.5 | | |
| | 60 mPa · s | | | | |
| 132 | Polyethylene oxide | 0.2 | Detackifying crosslinking agent | 0.5 | o |
| | Trade name: PEO-8 | | of metallic element: Aluminum | (asAl₂O₃) | |
| | (SUMITOMO SEIKA CHEMICALS) | | nitrate | | |
| | Properties: Nonionic, White | | | | |
| | powdery or granular, pH (0.5%): | | | | |
| | 7.0 Viscosity (0.5%, 25° C.): | | | | |
| | 60 mPa · s | | | | |
| 133 | Polyethylene oxide | 0.2 | Detackifying, hydrogen bond | 0.3 | o |
| | Trade name: PEO-8 | | adjustor: Polyamide/polyamine | | |
| | (SUMITOMO SEIKA CHEMICALS) | | epichlorohydrin resin | | |
| | Properties: Nonionic, White | | Trade name: Sumirez Resin 675 | | |
| | powdery or granular, pH (0.5%): | | (Sumitomo Chemical Group) | | |
| | 7.0 Viscosity (0.5%, 25° C.): | | Properties: Cationic, Brown, | | |
| | 60 mPa · s | | transparent liquid, Concentration: | | |
| | | | 25% Viscosity (25° C.): 200 | | |
| | | | mPa · s, pH (25° C.): 4.1 | | |
| 134 | Polyvinyl alcohol | 0.2 | Detackifying, reactive sizing | 0.5 | o |
| | Trade name: DENKA POVAL K-05 | | agent: Alkyl ketene dimer | | |
| | (DENKI KAGAKU KOGYO KABUSHIKI | | Trade name: Sizepine K-910 | | |
| | KAISHA) | | (ARAKAWA CHEMICAL INDUSTRIES) | | |
| | Properties: Nonionic, White | | Properties: Anionic, White | | |
| | to light yellow powdery, | | emulsion, Concentration: 15% | | |
| | Viscosity: 6.0 mPa · s pH: 6.0 | | Viscosity (25° C.): 6 cps, | | |
| | | | pH (25° C.): 5.5 | | |
| 135 | Polyvinyl alcohol | 0.2 | Detackifying waterproofing agent: | 1.0 | o |
| | Trade name: DENKA POVAL K-05 | | Blocked glyoxal resin (Product of | | |
| | (DENKI KAGAKU KOGYO KABUSHIKI | | polyamide polyurea glyoxal reaction) | | |
| | KAISHA) | | Trade name: Sumirez Resin 5001 | | |
| | Properties: Nonionic, White | | (Sumitomo Chemical Group) | | |
| | to light yellow powdery, | | Properties: Nonionic, Light- | | |
| | Viscosity: 6.0 mPa · s pH: 6.0 | | colored, transparent liquid, | | |
| | | | Concentration: 30% Viscosity | | |
| | | | (25° C.): 32 mPa · s, pH | | |
| | | | (25° C.): 7.7 | | |
| 136 | Polyvinyl alcohol | 0.2 | Detackifying sizing agent: | 0.5 | o |
| | Trade name: DENKA POVAL K-05 | | Alkenyl succinate | | |
| | (DENKI KAGAKU KOGYO KABUSHIKI | | Trade name: Coloparl SS-40 | | |
| | KAISHA) | | (Seiko Chemical Industries) | | |
| | Properties: Nonionic, White | | Properties: Anionic, Brown | | |
| | to light yellow powdery, | | liquid, Concentration: 40.4% | | |
| | Viscosity: 6.0 mPa · s pH: 6.0 | | Viscosity: 80 cps, pH: 10.4 | | |
| 137 | Ampholytic polyacryloamide | 0.3 | Detackifying waterproofing agent: | 0.5 | o |
| | Trade name: Polymerjet 902 | | Ketone resin | | |
| | (ARAKAWA CHEMICAL INDUSTRIES) | | Trade name: SI-668 (Nippon | | |
| | Properties: Ampholytic, Light | | PMC corporation) | | |
| | yellow, slightly turbid liquid, | | Properties: Nonionic, Slightly | | |
| | Concentration: 15.4%, Viscosity | | white turbid solution, Concentration: | | |
| | (25° C.): 1800 mPa · s, | | 50% Viscosity: 40 cps, pH: 7 | | |
| | pH (20° C.): 3.1 | | | | |
| 138 | Cationic polyamide resin | 0.25 | Detackifying waterproofing agent: | 0.5 | o |
| | Trade name: Arafix 255 | | Ketone resin | | |
| | (ARAKAWA CHEMICAL INDUSTRIES) | | Trade name: SI-668 (Nippon PMC | | |
| | Properties: Cationic, Brown, | | corporation) | | |
| | transparent liquid, Concentration: | | Properties: Nonionic, Slightly | | |
| | 26% Viscosity (25° C.): 183 | | white turbid solution, Concentration: | | |
| | mPa · s, pH (20° C.): 3.05 | | 50% Viscosity: 40 cps, pH: 7 | | |
| 139 | Detackifying waterproofing agent: | 0.5 | Detackifying, reactive sizing | 1.0 | o |
| | Zirconium ammonium carbonate | (asZrO₂) | agent (waterproofing agent): Alkyl | | |
| | Trade name: AZ Coat 5800MT | | ketene dimer | | |
| | (SAN NOPCO) | | Trade name: Sizepine K-287 | | |
| | Properties: Anionic, Slightly | | (ARAKAWA CHEMICAL INDUSTRIES) | | |
| | yellow liquid, Concentration: | | Properties: Cationic, White | | |
| | 20% (as ZrO2) Viscosity (25° C.): | | emulsion, Concentration: 20% | | |
| | 10 mPa · s, pH (1%): 9.0 | | Viscosity (25° C.): 40 cps, | | |
| | | | pH (20° C.): 3.7 | | |
| 140 | Detackifying, hydrogen bond | 0.25 | Detackifying waterproofing agent: | 1.0 | o |
| | adjustor: Polyamide/polyamine | | Polyamine epichlorohydrin resin | | |
| | epichlorohydrin resin | | Trade name: WS-564 (Nippon | | |
| | Trade name: Sumirez Resin 6625 | | PMC corporation) | | |
| | (Sumitomo Chemical Group) | | Properties: Cationic, Light amber | | |
| | Properties: Cationic, Brown, | | liquid, Concentration: 20% | | |
| | transparent liquid, Concentration: | | Viscosity (25° C.): 50 cps, | | |
| | 25% Viscosity (25° C.): 200 | | pH (20° C.): 3.7 | | |
| | mPa · s, pH (25° C.): 4.0 | | | | |

### EXAMPLES 141 to 152

The pre-vulcanized natural rubber latex was treated with the hydrophilic group sealant for the internal surface. It was formed into the film, and coating-treated with the detackified carboxylated NBR for the external surface for the tackiness test. The test result and the hydrophilic group sealant used in each EXAMPLE are given in Table 18. The post-treatment step, and carboxylated NBR and carboxyl group sealant used in each EXAMPLE are described below.

(Post-treatment)

The natural rubber latex film prepared was treated by the following steps in the order described below, unless otherwise stated:

Heating (1)→Immersion in the solution for treating the external surface→Heating (2)→Leaching→Post-vulcanization

The treated film was 0.1 to 0.13 mm thick and weighing around 0.3 g.

Post-treatment temperature and treatment time in each EXAMPLE were:

### EXAMPLES 141 to 145

Heating (1): 50° C., 2 min., Heating (2): 90° C., 5 min., Leaching: 85° C., 3 min., Post-vulcanization: 110° C., 5 min.

### EXAMPLES 146 to 150

The natural rubber latex film formed on the mold was dried at 50° C. for 2 minutes, and leached at 85° C. for 5 minutes. Then, it was heated at 90° C. for 1 minute, and immersed in the coating solution of the detackifying, carboxylated synthetic latex for 5 seconds. Approximately 0.05 g of the solution was held by the film. Furthermore, it was dried at 90° C. for 5 minutes and post-vulcanized at 110° C. for 5 minutes.

### EXAMPLES 151 and 152

Heating (1): 38° C., 3 min., Heating (2): 38° C., 5 min., Leaching: 70° C., 3 min., Post-vulcanization: 110° C., 10 min.

(Carboxylated NBR Latex)

Nipol LX-551 (Zeon Corporation)

(Carboxyl Group Sealants)

(1) Detackifying, reactive sizing agent (waterproofing agent): Alkyl ketene dimer
Sizepine K-910 (ARAKAWA CHEMICAL INDUSTRIES)

The latex was treated with 2.5 parts of the above carboxyl group sealant.

The tackiness test results are given in Table 18 as the test results (1).

(2) Detackifying waterproofing agent: Polyamidepolyamine epichlorohydrin resin

Sumirez Resin 6625 (Sumitomo Chemical Group)

The latex was treated with 0.25 parts of the above carboxyl group sealant.

The tackiness test results are given in Table 18 as the test results (2).

TABLE 18

| | | | Test | Test |
|---|---|---|---|---|
| Examples | | Concen- | results | results |
| NO. | Hydrophilic group blocking agents for treating the internal surface | tration (%) | (1) | (2) |
| 141 | Detackifying surfactant: β-naphthalene sulfonate/formalin condensate | 0.4 | o | o |
| | Trade name: DEMOL N (Kao Corporation) | | | |
| | Properties: Anionic, Light yellow/brown powdery | | | |
| 142 | Detackifying crosslinking agent of metallic element: Polyaluminum hydroxide | 0.5 | o | o |
| | Trade name: Paho#2S (Asada Kagaku Kogyo) | (asAl₂O₃) | | |
| | Properties: Cationic, Light yellow, transparent liquid, Viscosity (30° C.): 7 cps | | | |
| | Concentration: 10.5% (as Al2O3), pH: 3.5 | | | |
| 143 | Detackifying, reactive sizing agent (waterproofing agent): Alkyl ketene dimer | 0.5 | o | o |
| | Trade name: Sizepine K-287 (ARAKAWA CHEMICAL INDUSTRIES) | | | |
| | Properties: Cationic, White emulsion, Concentration: 20% | | | |
| | Viscosity (25° C.): 40 cps, pH (20° C.): 3.7 | | | |
| 144 | Detackifying surfactant: Polyoxyethylene derivative | 0.4 | o | o |
| | Trade name: Emulgen A-60 (Kao Corporation) | | | |
| | Properties: Nonionic, Light yellow liquid | | | |
| | pH (5%): 6.5 | | | |
| 145 | Detackifying, hydrogen bond adjustor: Polyamide/polyamine epichlorohydrin resin | 0.3 | o | o |
| | Trade name: Sumirez Resin 675 (Sumitomo Chemical Group) | | | |
| | Properties: Cationic, Brown, transparent liquid, Concentration: 25% | | | |
| | Viscosity (25° C.): 200 mPa · s, pH (25° C.): 4.1 | | | |
| 146 | Detackifying surfactant: Polyoxyethylene derivative | 0.4 | o | o |
| | Trade name: Emulgen A-60 (Kao Corporation) | | | |
| | Properties: Nonionic, Light yellow liquid | | | |
| | pH (5%): 6.5 | | | |
| 147 | Detackifying, hydrophobicizing, organic crosslinking agent: Blocked isocyanate | 1.0 | o | o |
| | Trade name: Prominate XC-915 (TAKEDA CHEMICAL INDUSTRIES) | | | |
| | Properties: Nonionic, White emulsion, Trifunctional group, Molecular weight: 1000 | | | |
| | Concentration: 43.3%, Viscosity: 160 cps, pH: 6.0 | | | |
| 148 | Detackifying, hydrogen bond adjustor: Polyamide/polyamine epichlorohydrin resin | 0.3 | o | o |
| | Trade name: Sumirez Resin 675 (Sumitomo Chemical Group) | | | |
| | Properties: Cationic, Brown, transparent liquid, Concentration: 25% | | | |
| | Viscosity (25° C.): 200 mPa · s, pH (25° C.): 4.1 | | | |
| 149 | Detackifying, monofunctional epoxy compound | 1.0 | o | o |
| | Trade name: Denacast EM-103 (Nagase ChemteX Corporation) | | | |
| | Properties: Milky white emulsion, Concentration: 40%, Epoxy equivalents: 1463WPE | | | |
| | Viscosity (20° C.): 3100 mPa · s, pH: 5.7 | | | |
| 150 | Detackifying, reactive sizing agent (waterproofing agent): Alkyl ketene dimer | 0.5 | o | o |
| | Trade name: Sizepine K-287 (ARAKAWA CHEMICAL INDUSTRIES) | | | |
| | Properties: Cationic, White emulsion, Concentration: 20% | | | |
| | Viscosity (25° C.): 40 cps, pH (20° C.): 3.7 | | | |
| 151 | Detackifying waterproofing agent: Branched polyethyleneimine | 0.5 | o | o |
| | Trade name: Epomine P-1000 (NIPPON SHOKUBAI) | | | |
| | Properties: Cationic, Light yellow, transparent, viscous liquid, Concentration: 29.9% | | | |
| | Viscosity (25° C.): 633 mPa · s, pH (5%): 10.6 | | | |
| 152 | Detackifying waterproofing agent: Blocked glyoxal resin | 2.5 | o′ | o |
| | (Polyhydric alcohol/carbonyl adduct) | | | |
| | Trade name: SEQUARES 755 (OMNOVA Solutions) | | | |
| | Properties: Cationic, Light yellow, transparent liquid, Concentration: 55% | | | |
| | Viscosity (25° C.): 200 cps, pH: 4.5 | | | |

### EXAMPLES 153 and 154

The pre-vulcanized natural rubber latex was treated with the hydrophilic group sealant for the internal surface. It was formed into the film, and external surface was coating-treated with the detackified polymer for the tackiness test. The test result, and the detackified polymer coating agent and hydrophilic group sealant used in each EXAMPLE are given in Table 19. The post-treatment step in each EXAMPLE is described below.

(Post-treatment)

The natural rubber latex film prepared was treated by the following steps in the order described below:

Heating (1)→Immersion in the solution for treating the external surface→Heating (2)→Leaching→Post-vulcanization

The treated film was 0.1 to 0.13 mm thick and weighing around 0.3 g.

Post-treatment temperature and treatment time in each EXAMPLE were:

### EXAMPLES 153 and 154

Heating (1): 50° C., 2 min., Heating (2): 90° C., 5 min., Leaching: 85° C., 3 min., Post-vulcanization: 110° C., 10 min.

TABLE 19

| | Hydrophilic group blocking agents | | Polymer coating agents for | | |
|---|---|---|---|---|---|
| | for treating the internal surface | | treating the external surface | | |
| Examples | | Concen- | | Concen- | Test |
| NO. | | tration (%) | | tration (%) | results |
| 153 | Detackifying, reactive sizing | 1.0 | Detackifying waterproofing agent: | 5.0 | o |
| | agent (waterproofing agent): | | Self-crosslinking type acrylic/ | | |
| | Alkyl ketene dimer | | styrene copolymer | | |
| | Trade name: Sizspine K-287 | | Trade name: Sibinol EK-20 | | |
| | (ARAKAWA CHEMICAL INDUSTRIES) | | (Saiden Chemical Industry) | | |
| | Properties: Cationic, White | | Properties: Anionic, Milky white | | |
| | emulsion, Concentration: 20% | | emulsion, Concentration: 39.5% | | |
| | Viscosity (25° C.): 40 cps, | | Viscosity (30° C.): 2000 | | |
| | pH (20° C.): 3.7 | | mPa · s, pH: 9.5 | | |
| 154 | Detackifying, reactive sizing | 1.0 | Detackifying releasing agent: | 5.0 | o |
| | agent (waterproofing agent): | | Long-chain alkyl pendant polymer | | |
| | Alkyl ketene dimer | | Trade name: peeloil 406 | | |
| | Trade name: Sizepine K-287 | | (Ipposha Oil Industries) | | |
| | (ARAKAWA CHEMICAL INDUSTRIES) | | Properties: Cationic, Milky white | | |
| | Properties: Cationic, White | | emulsion, Concentration: 15% | | |
| | emulsion, Concentration: 20% | | Viscosity: 500 cps | | |
| | Viscosity (25° C.): 40 cps, | | | | |
| | pH (20° C.): 3.7 | | | | |

### EXAMPLES 155 to 164

The pre-vulcanized natural rubber latex was incorporated with the hydrophilic polymer and hydrophilic group sealant. It was formed into the film, and halogenation-treated for the external surface. The tackiness test result, and the hydrophilic polymer and hydrophilic group sealant used in each EXAMPLE are given in Table 20. The post-treatment step in each EXAMPLE is described below.

(Post-treatment)

The natural rubber latex film film prepared was treated by the following steps in the order described below:

Heating (1)→Immersion in chlorine water→Heating(2)→Leaching→Post-vulcanization

Post-treatment temperature and treatment time in each EXAMPLE were:

### EXAMPLES 155 to 164

Heating (1): 50° C., 2 min., Heating (2): 50° C., 2 min., Leaching: 70° C., 3 min., Post-vulcanization: 90° C., 5 min.

Furthermore, each film was post-vulcanized at 110° C. for 5 minutes for the tackiness test.

TABLE 20

| | Hydrophilic polymers to | | Hydrophilic group blocking agents | | |
|---|---|---|---|---|---|
| | be incorporated in the latex | | to be incorporated in the latex | | |
| | | Incorporated | | Incorporated | |
| Examples | | quantity | | quantity | Test |
| NO. | | (parts) | | (parts) | results |
| 155 | Carboxymethyl cellulose | 0.2 | Detackifying, hydrophobicizing, | 0.4 | o |
| | Trade name: CMC DAICEL 1330 | | organic crosslinking agent: | | |
| | (DAICEL CHEMICAL INDUSTRIES) | | Blocked isocyanate | | |
| | Properties: Anionic, White | | Trade name: Prominate XC-915 | | |
| | powdery, Viscosity (1%, 25° C.): | | (TAKEDA CHEMICAL INDUSTRIES) | | |
| | 73 cps pH: 6.8, Degree of | | Properties: Nonionic, White | | |
| | etherification: 1.27 | | emulsion, Trifunctional group, | | |
| | | | Molecular weight: 1000 | | |
| | | | Concentration: 43.3%, Viscosity: | | |
| | | | 160 cps, pH: 6.0 | | |
| 156 | Carboxymethyl cellulose | 0.2 | Detackifying waterproofing agent: | 1.0 | o |
| | Trade name: CMC DAICEL 1330 | | Blocked glyoxal resin | | |
| | (DAICEL CHEMICAL INDUSTRIES) | | (Product of polyamide polyurea | | |
| | Properties: Anionic, White | | glyoxal reaction) | | |
| | powdery, Viscosity (1%, 25° C.): | | Trade name: Sumirez Resin 5001 | | |
| | 73 cps pH: 6.8, Degree of | | (Sumitomo Chemical Group) | | |
| | etherification: 1.27 | | Properties: Nonionic, Light-colored, | | |
| | | | transparent liquid, Concentration: | | |
| | | | 30% Viscosity (25° C.): 32 | | |
| | | | mPa · s, pH (25° C.): 7.7 | | |
| 157 | Carrageenan | 0.2 | Detackifying surfactant: | 0.4 | o |
| | Trade name: Soarace WX165 | | Polyoxyethylene derivative | | |
| | (MRC Polysaccharide) | | Trade name: Emulgen A-60 | | |
| | Properties: Anionic, White | | (Kao Corporation) | | |
| | powdery pH (1.5%): 8.2 | | Properties: Nonionic, Light | | |
| | | | yellow liquid pH (5%): 6.5 | | |
| 158 | Carrageenan | 0.2 | Detackifying sizing agent: | 1.0 | o |
| | Trade name: Soarace WX165 | | Strengthened rosin sizing agent | | |
| | (MRC Polysaccharide) | | Trade name: Sizepine E-50 | | |
| | Properties: Anionic, White | | (ARAKAWA CHEMICAL INDUSTRIES) | | |
| | powdery pH (1.5%): 8.2 | | Properties: Anionic, Brown, | | |
| | | | transparent liquid, Concentration: | | |
| | | | 50.4% Viscosity (25° C.): 200 | | |
| | | | cps, pH (5%, 20° C.): 11.0 | | |
| 159 | Guar gum | 0.2 | Detackifying, hydrophobicizing, | 0.4 | o |
| | Trade name: Soar Guar RG100 | | organic crosslinking agent: | | |
| | (MRC Polysaccharide) | | Blocked isocyanate | | |
| | Properties: Nonionic, White | | Trade name: Prominate XC-915 | | |
| | powdery Viscosity (1%, 25° C.): | | (TAKEDA CHEMICAL INDUSTRIES) | | |
| | 1250 cps | | Properties: Nonionic, White emulsion, | | |
| | | | Trifunctional group, Molecular | | |
| | | | weight: 1000 Concentration: 43.3%, | | |
| | | | Viscosity: 160 cps, pH: 6.0 | | |
| 160 | Guar gum | 0.2 | Detackifying waterproofing agent: | 1.0 | o |
| | Trade name: Soar Guar RG100 | | Blocked glyoxal resin | | |
| | (MRC Polysaccharide) | | (Product of polyamide polyurea | | |
| | Properties: Nonionic, White | | glyoxal reaction) | | |
| | powdery Viscosity (1%, 25° C.): | | Trade name: Sumirez Resin 5001 | | |
| | 1250 cps | | (Sumitomo Chemical Group) | | |
| | | | Properties: Nonionic, Light- | | |
| | | | colored, transparent liquid, | | |
| | | | Concentration: 30% Viscosity | | |
| | | | (25° C.): 32 mPa · s, pH | | |
| | | | (25° C.): 7.7 | | |
| 161 | Locust bean gum | 0.2 | Detackifying surfactant: | 0.4 | o |
| | Trade name: Soar Locust A120F | | Polyoxyethylene derivative | | |
| | (MRC Polysaccharides) | | Trade name: Emulgen A-60 | | |
| | Properties: Nonionic, White | | (Kao Corporation) | | |
| | powdery Viscosity (1%, 25° C.): | | Properties: Nonionic, Light | | |
| | 1200 cps | | yellow liquid pH (5%): 6.5 | | |
| 162 | Locust bean gum | 0.2 | Detackifying sizing agent: | 1.0 | o |
| | Trade name: Soar Locust A120F | | Strengthened rosin sizing agent | | |
| | (MRC Polysaccharides) | | Trade name: Sizepine E-50 | | |
| | Properties: Nonionic, White | | (ARAKAWA CHEMICAL INDUSTRIES) | | |
| | powdery Viscosity (1%, 25° C.): | | Properties: Anionic, Brown, | | |
| | 1200 cps | | transparent liquid, Concentration: | | |
| | | | 50.4% Viscosity (25° C.): 200 | | |
| | | | cps, pH (5%, 20° C.): 11.0 | | |
| 163 | Xanthan gum | 0.2 | Detackifying, monofunctional | 1.0 | o |
| | Trade name: Soar Xan XG550 | | epoxy compound | | |
| | (MRC Polysaccharides) | | Trade name: Denacast EM-103 | | |
| | Properties: Anionic, White | | (Nagase ChemteX Corporation) | | |
| | powdery Viscosity (1%, 25° C.): | | Properties: Milky white emulsion, | | |
| | 1500 cps, pH (1%): 7.5 | | Concentration: 40%, Epoxy equivalents: | | |
| | | | 1463WPE Viscosity (20° C.): 3100 | | |
| | | | mPa · s, pH: 5.7 | | |
| 164 | Xanthan gum | 0.2 | Detackifying surfactant: | 0.4 | o |
| | Trade name: Soar Xan XG550 | | β-naphthalene sulfonate/formalin | | |
| | (MRC Polysaccharides) | | condensate | | |
| | Properties: Anionic, White | | Trade name: DEMOL N | | |
| | powdery Viscosity (1%, 25° C.): | | (Kao Corporation) | | |
| | 1500 cps, pH (1%): 7.5 | | Properties: Anionic, Light | | |
| | | | yellow/brown powdery | | |

### EXAMPLES 165 to 174

The pre-vulcanized natural rubber latex was incorporated with the hydrophilic group sealant. It was formed into the film, and halogenation-treated for the external surface. The tackiness test result, and the hydrophilic group sealant used in each EXAMPLE are given in Table 21. The post-treatment step in each EXAMPLE is described below.

(Post-treatment)

The natural rubber latex film film prepared was treated by the following steps in the order described below, unless otherwise stated:

Heating (1)→Immersion in chlorine water→Heating(2)→Leaching→Post-vulcanization

Post-treatment temperature and treatment time in each EXAMPLE were:

### EXAMPLES 165 to 168

Heating (1): 50° C., 2 min., Heating (2): 50° C., 2 min., Leaching: 70° C., 3 min., Post-vulcanization: 90° C., 5 min.

Furthermore, each was post-vulcanized at 110° C. for 5 minutes for the tackiness test.

### EXAMPLES 169 to 174

Heating (1): 50° C., 5 min., Heating (2): 50° C., 2 min., Leaching: 70° C., 3 min., Post-vulcanization: 90° C., 5 min.

Furthermore, each was post-vulcanized at 110° C. for 5 minutes for the tackiness test.

TABLE 21

| | | Incorporated | |
|---|---|---|---|
| Examples | | quantity | Test |
| NO. | Hydrophilic group blocking agents to be incorporated in the latex | (parts) | results |
| 165 | Detackifying, hydrophobicizing, organic crosslinking agent: Blocked isocyanate | 0.4 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 166 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 167 | Detackifying surfactant: Polyoxyethylene derivative | 0.4 | o |
| | Trade name: Emulgen A-60 (Kao Corporation) | | |
| | Properties: Nonionic, Light yellow liquid | | |
| | pH (5%): 6.5 | | |
| 168 | Detackifying sizing agent: Strengthened rosin sizing agent | 1.0 | o |
| | Trade name: Sizepine E-50 (ARAKAWA CHEMICAL INDUSTRIES) | | |
| | Properties: Anionic, Brown, transparent liquid, Concentration: 50.4% | | |
| | Viscosity (25° C.): 200 cps, pH (5%, 20° C.): 11.0 | | |
| 169 | Detackifying surfactant: β-naphthalene sulfonate/formalin condensate | 0.4 | o |
| | Trade name: DEMOL N (Kao Corporation) | | |
| | Properties: Anionic, Light yellow/brown powdery | | |
| 170 | Detackifying, reactive sizing agent: Alkyl ketene dimer | 1.0 | o |
| | Trade name: Sizepine K-910 (ARAKAWA CHEMICAL INDUSTRIES) | | |
| | Properties: Anionic, White emulsion, Concentration: 15% | | |
| | Viscosity (25° C.): 6 cps, pH (25° C.): 5.5 | | |
| 171 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 172 | Detackifying surfactant: Polyoxyethylene derivative | 0.4 | o |
| | Trade name: Emulgen A-60 (Kao Corporation) | | |
| | Properties: Nonionic, Light yellow liquid | | |
| | pH (5%): 6.5 | | |
| 173 | Detackifying, hydrophobicizing, organic crosslinking agent: Blocked isocyanate | 0.4 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 174 | Crosslinking agent of detackifying, aqueous resin: Carbodiimide | 0.5 | o |
| | Trade name: CARBODILITE V-02 (Nisshinbo Industries) | | |
| | Properties: Yellow, transparent liquid, Carbodiimide equivalents: 597 | | |
| | Concentration: 40%, pH: 10.1 | | |

### EXAMPLES 175 to 185

The pre-vulcanized natural rubber latex was incorporated with the hydrophilic polymer, and treated with the hydrophilic group sealant for the internal surface. It was formed into the film, and halogenation-treated for the external surface. The tackiness test result, and the hydrophilic polymer and hydrophilic group sealant used in each EXAMPLE are given in Table 22. The post-treatment step in each EXAMPLE is described below.

(Post-treatment)

The natural rubber latex film film prepared was treated by the following steps in the order described below:

Heating (1)→Immersion in chlorine water→Heating(2)→Leaching→Post-vulcanization

Post-treatment temperature and treatment time in each EXAMPLE were:

### EXAMPLES 175 to 185

Heating (1): 50° C., 2 min., Heating (2): 50° C., 2 min., Leaching: 70° C., 3 min., Post-vulcanization: 90° C., 5 min.

Furthermore, each was post-vulcanized at 110° C. for 5 minutes for the tackiness test.

TABLE 22

| | Hydrophilic polymers to | | | | |
|---|---|---|---|---|---|
| | be incorporated in the latex | | Hydrophilic group blocking agents | | |
| | | Incorporated | for treating the internal surface | | |
| Examples | | quantity | | Concen- | Test |
| NO. | | (parts) | | tration (%) | results |
| 175 | Carboxymethyl cellulose | 0.2 | Detackifying crosslinking agent | 0.5 | o |
| | Trade name: CMC DAICEL 1330 | | of metallic element: Polyaluminum | (asAl₂O₃) | |
| | (DAICEL CHEMICAL INDUSTRIES) | | hydroxide | | |
| | Properties: Anionic, White | | Trade name: Paho#2S | | |
| | powdery, Viscosity (1%, 25° C.): | | (Asada Kagaku Kogyo) | | |
| | 73 cps pH: 6.8, Degree of | | Properties: Cationic, Light yellow, | | |
| | etherification: 1.27 | | transparent liquid, Viscosity | | |
| | | | (30° C.): 7 cps Concentration: 10.5% | | |
| | | | (as Al2O3), pH: 3.5 | | |
| 176 | Carboxymethyl cellulose | 0.2 | Detackifying, hydrogen bond adjustor: | 0.3 | o |
| | Trade name: CMC DAICEL 1330 | | Polyamide/polyamine epichlorohydrin | | |
| | (DAICEL CHEMICAL INDUSTRIES) | | resin | | |
| | Properties: Anionic, White | | Trade name: Sumirez Resin 675 | | |
| | powdery, Viscosity (1%, 25° C.): | | (Sumitomo Chemical Group) | | |
| | 73 cps pH: 6.8, Degree of | | Properties: Cationic, Brown, | | |
| | etherification: 1.27 | | transparent liquid, Concentration: 25% | | |
| | | | Viscosity (25° C.): 200 mPa · s, | | |
| | | | pH (25° C.): 4.1 | | |
| 177 | Carrageenan | 0.2 | Detackifying surfactant: | 0.4 | o |
| | Trade name: Soarace WX165 | | Polyoxyethylene derivative | | |
| | (MRC Polysaccharide) | | Trade name: Emulgen A-60 | | |
| | Properties: Anionic, White | | (Kao Corporation) | | |
| | powdery pH (1.5%): 8.2 | | Properties: Nonionic, Light yellow | | |
| | | | liquid pH (5%): 6.5 | | |
| 178 | Carrageenan | 0.2 | Detackifying, reactive sizing agent | 0.5 | o |
| | Trade name: Soarace WX165 | | (waterproofing agent) Alkyl ketene | | |
| | (MRC Polysaccharide) | | dimer | | |
| | Properties: Anionic, White | | Trade name: Sizepine K-287 | | |
| | powdery pH (1.5%): 8.2 | | (ARAKAWA CHEMICAL INDUSTRIES) | | |
| | | | Properties: Cationic, White | | |
| | | | emulsion, Concentration: 20% | | |
| | | | Viscosity (25° C.): 40 cps, | | |
| | | | pH (20° C.): 3.7 | | |
| 179 | Methyl cellulose | 0.25 | Detackifying crosslinking agent | 0.5 | o |
| | Trade name: Metolose SM-400 | | of metallic element: Polyaluminum | (asAl₂O₃) | |
| | (Shin-Etsu Chemical) | | hydroxide | | |
| | Properties: Nonionic, White | | Trade name: Paho#2S | | |
| | powdery Viscosity (2%, 20° C.): | | (Asada Kagaku Kogyo) | | |
| | 436 mPa · s | | Properties: Cationic, Light yellow, | | |
| | | | transparent liquid, Viscosity (30° C.): | | |
| | | | 7 cps Concentration: 10.5% (as Al2O3), | | |
| | | | pH: 3.5 | | |
| 180 | Methyl cellulose | 0.25 | Detackifying, hydrogen bond adjustor: | 0.3 | o |
| | Trade name: Metolose SM-400 | | Polyamide/polyamine epichlorohydrin | | |
| | (Shin-Etsu Chemical) | | resin | | |
| | Properties: Nonionic, White | | Trade name: Sumirez Resin 675 | | |
| | powdery Viscosity (2%, 20° C.): | | (Sumitomo Chemical Group) | | |
| | 436 mPa · s | | Properties: Cationic, Brown, transparent | | |
| | | | liquid, Concentration: 25% Viscosity | | |
| | | | (25° C.): 200 mPa · s, pH (25° C.): 4.1 | | |
| 181 | Polyethylene oxide | 0.2 | Detackifying surfactant: | 0.4 | o |
| | Trade name: PEO-8 | | Polyoxyethylene derivative | | |
| | (SUMITOMO SEIKA CHEMICALS) | | Trade name: Emulgen A-60 | | |
| | Properties: Nonionic, White | | (Kao Corporation) | | |
| | powdery or granular, pH (0.5%): | | Properties: Nonionic, Light yellow | | |
| | 7.0 Viscosity (0.5%, 25° C.): | | liquid pH (5%): 6.5 | | |
| | 60 mPa · s | | | | |
| 182 | Polyethylene oxide | 0.2 | Detackifying, reactive sizing agent | 0.5 | o |
| | Trade name: PEO-8 | | (waterproofing agent) Alkyl ketene | | |
| | (SUMITOMO SEIKA CHEMICALS) | | dimer | | |
| | Properties: Nonionic, White | | Trade name: Sizepine K-287 | | |
| | powdery or granular, pH (0.5%): | | (ARAKAWA CHEMICAL INDUSTRIES) | | |
| | 7.0 Viscosity (0.5%, 25° C.): | | Properties: Cationic, White | | |
| | 60 mPa · s | | emulsion, Concentration: 20% | | |
| | | | Viscosity (25° C.): 40 cps, pH | | |
| | | | (20° C.): 3.7 | | |
| 183 | Xanthan gum | 0.2 | Detackifying, hydrophobicizing, | 1.0 | o |
| | Trade name: Soar Xan XG550 | | organic crosslinking agent: Blocked | | |
| | (MRC Polysaccharides) | | isocyanate | | |
| | Properties: Anionic, White | | Trade name: Prominate XC-915 | | |
| | powdery Viscosity (1%, 25° C.): | | (TAKEDA CHEMICAL INDUSTRIES) | | |
| | 1500 cps, pH (1%): 7.5 | | Properties: Nonionic, White emulsion, | | |
| | | | Trifunctional group, Molecular weight: | | |
| | | | 1000 Concentration: 43.3%, Viscosity: | | |
| | | | 160 cps, pH: 6.0 | | |
| 184 | Xanthan gum | 0.2 | Detackifying sizing agent: Alkenyl | 0.5 | o |
| | Trade name: Soar Xan XG550 | | succinate | | |
| | (MRC Polysaccharides) | | Trade name: Coloparl SS-40 | | |
| | Properties: Anionic, White | | (Seiko Chemical Industries) | | |
| | powdery Viscosity (1%, 25° C.): | | Properties: Anionic, Brown liquid, | | |
| | 1500 cps, pH (1%): 7.5 | | Concentration: 40.4% Viscosity: | | |
| | | | 80 cps, pH: 10.4 | | |
| 185 | Ampholytic polyacryloamide | 0.3 | Detackifying waterproofing agent: | 0.5 | o |
| | Trade name: Polymerjet 902 | | Branched polyethyleneimine | | |
| | (ARAKAWA CHEMICAL INDUSTRIES) | | Trade name: Epomine P-1000 | | |
| | Properties: Ampholytic, Light | | (NIPPON SHOKUBAI) | | |
| | yellow, slightly turbid liquid, | | Properties: Cationic, Light yellow, | | |
| | Concentration: 15.4%, Viscosity | | transparent, viscous liquid, | | |
| | (25° C.): 1800 mPa · s, pH | | Concentration: 29.9% Viscosity | | |
| | (20° C.): 3.1 | | (25° C.): 633 mPa · s, pH (5%): 10.6 | | |

### EXAMPLES 186 to 195

The pre-vulcanized natural rubber latex was treated with the hydrophilic group sealant for the internal surface. It was formed into the film, and halogenation-treated for the external surface. The tackiness test result, and the hydrophilic group sealant used in each EXAMPLE are given in Table 23. The post-treatment step in each EXAMPLE is described below.

(Post-treatment)

The natural rubber latex film film prepared was treated by the following steps in the order described below, unless otherwise stated:

Heating (1)→Immersion in chlorine water→Heating(2)→Leaching→Post-vulcanization

Post-treatment temperature and treatment time in each EXAMPLE were:

### EXAMPLES 186 to 190

Heating (1): 50° C., 5 min., Heating (2): 50° C., 2 min., Leaching: 70° C., 3 min., Post-vulcanization: 90° C., 5 min.

Furthermore, each was post-vulcanized at 110° C. for 5 minutes for the tackiness test.

### EXAMPLES 191 to 195

The natural rubber latex film formed on the mold was dried at 50° C. for 2 minutes, and leached at 85° C. for 5 minutes. Then, it was heated at 90° C. for 1 minute, and immersed in chlorine water (chlorine concentration: 0.4%) for 5 seconds, to halogenate the external surface of the natural rubber latex film. Furthermore, each was dried at 90° C. for 5 minutes and post-vulcanized at 110° C. for 5 minutes.

TABLE 23

| | | Concen- | |
|---|---|---|---|
| Examples | | tration | Test |
| NO. | Hydrophilic group blocking agents for treating the internal surface | (%) | results |
| 186 | Detackifying crosslinking agent of metallic element: Polyaluminum hydroxide | 0.5 | o |
| | Trade name: Paho#2S (Asada Kagaku Kogyo) | (asAl₂O₃) | |
| | Properties: Cationic, Light yellow, transparent liquid, Viscosity (30° C.): 7 cps | | |
| | Concentration: 10.5% (as Al2O3), pH: 3.5 | | |
| 187 | Detackifying, hydrogen bond adjustor: Polyamide/polyamine epichlorohydrin resin | 0.3 | o |
| | Trade name: Sumirez Resin 675 (Sumitomo Chemical Group) | | |
| | Properties: Cationic, Brown, transparent liquid, Concentration: 25% | | |
| | Viscosity (25° C.): 200 mPa · s, pH (25° C.): 4.1 | | |
| 188 | Detackifying surfactant: Polyoxyethylene derivative | 0.4 | o |
| | Trade name: Emulgen A-60 (Kao Corporation) | | |
| | Properties: Nonionic, Light yellow liquid | | |
| | pH (5%): 6.5 | | |
| 189 | Detackifying, reactive sizing agent (waterproofing agent) Alkyl ketene dimer | 0.5 | o |
| | Trade name: Sizepine K-287 (ARAKAWA CHEMICAL INDUSTRIES) | | |
| | Properties: Cationic, White emulsion, Concentration: 20% | | |
| | Viscosity (25° C.): 40 cps, pH (20° C.): 3.7 | | |
| 190 | Detackifying sizing agent: Alkenyl succinate | 0.5 | o |
| | Trade name: Coloparl SS-40 (Seiko Chemical Industries) | | |
| | Properties: Anionic, Brown liquid, Concentration: 40.4% | | |
| | Viscosity: 80 cps, pH: 10.4 | | |
| 191 | Detackifying surfactant: β -naphthalene sulfonate/formalin condensate | 0.5 | o |
| | Trade name: DEMOL N (Kao Corporation) | | |
| | Properties: Anionic, Light yellow/brown powdery | | |
| 192 | Detackifying, hydrophobicizing, organic crosslinking agent: Blocked isocyanate | 1.0 | o |
| | Trade name: Prominate XC-915 (TAKEDA CHEMICAL INDUSTRIES) | | |
| | Properties: Nonionic, White emulsion, Trifunctional group, Molecular weight: 1000 | | |
| | Concentration: 43.3%, Viscosity: 160 cps, pH: 6.0 | | |
| 193 | Detackifying waterproofing agent: Blocked glyoxal resin | 1.0 | o |
| | (Product of polyamide polyurea glyoxal reaction) | | |
| | Trade name: Sumirez Resin 5001 (Sumitomo Chemical Group) | | |
| | Properties: Nonionic, Light-colored, transparent liquid, Concentration: 30% | | |
| | Viscosity (25° C.): 32 mPa · s, pH (25° C.): 7.7 | | |
| 194 | Detackifying, monofunctional epoxy compound | 1.0 | o |
| | Trade name: Denacast EM-103 (Nagase ChemteX Corporation) | | |
| | Properties: Milky white emulsion, Concentration: 40%, Epoxy equivalents: 1463WPE | | |
| | Viscosity (20° C.): 3100 mPa · s, pH: 5.7 | | |
| 195 | Detackifying, reactive sizing agent (waterproofing agent) Alkyl ketene dimer | 0.5 | o |
| | Trade name: Sizepine K-287 (ARAKAWA CHEMICAL INDUSTRIES) | | |
| | Properties: Cationic, White emulsion, Concentration: 20% | | |
| | Viscosity (25° C.): 40 cps, pH (20° C.): 3.7 | | |

### EXAMPLES 196 to 199

The pre-vulcanized natural rubber latex was incorporated with the hydrophilic group sealant and/or hydrophilic polymer. It was formed into the film, and treated with the hydrophilic group sealant reactive at low temperature for the external surface. The tackiness test result, and the hydrophilic polymer and hydrophilic group sealant used in each EXAMPLE are given in Table 24. The post-treatment step and hydrophilic group sealant reactive at low temperature for treating the external surface in each EXAMPLE are described below.

(Post-treatment)

The natural rubber latex film film prepared was treated by the following steps in the order described below:

Heating→Immersion in the solution for treating the external surface→Drying→Leaching→Post-vulcanization

Post-treatment temperature and treatment time in each EXAMPLE were:

### EXAMPLES 196 and 198

Heating: 50° C., 2 min., Drying: 90° C., 7 min., Leaching: 85° C., 3 min., Post-vulcanization: 110° C., 10 min.

### EXAMPLES 197 and 199

Heating: 38° C., 5 min., Drying: 95° C., 5 min., Leaching: 85° C., 3 min., Post-vulcanization: 110° C., 10 min. (Hydrophilic group sealant reactive at low temperature for the external surface)

Detackifying crosslinking agent of metallic element: Zirconyl acetate
Zircosol ZA (DAIICHIKIGENSO KAGAKUKOGYO)
Properties: Cationic, Slightly brown aqueous solution Concentration: 15.18% (as ZrO₂), pH: 3.4

The above-described sealant was diluted with water to have a ZrO₂ concentration of 1% for use in each EXAMPLE.

TABLE 24

| | Hydrophilic polymers to | | Hydrophilic group blocking agents | | |
|---|---|---|---|---|---|
| | be incorporated in the latex | | to be incorporated in the latex | | |
| | | Incorporated | | Incorporated | |
| Examples | | quantity | | quantity | Test |
| NO. | | (parts) | | (parts) | results |
| 196 | Not used | | Detackifying, hydrogen bond adjustor: | 1.5 | o |
| | | | Polyamide polyurea-based resin | | |
| | | | Trade name: Sumirez Resin 703 | | |
| | | | (Sumitomo Chemical Group) | | |
| | | | Properties: Weakly cationic, | | |
| | | | Brown, transparent liquid, | | |
| | | | Concentration: 50% Viscosity | | |
| | | | (25° C.): 65 mPa · s, pH | | |
| | | | (25° C.): 7.0 | | |
| 197 | Urea phosphorylated starch | 0.25 | Detackifying waterproofing agent: | 0.25 | o |
| | Trade name: MS#4600 | | Zirconium ammonium carbonate | (asZrO₂) | |
| | (Nihon Shokuhin Kako) | | Trade name: Baycoat 20 | | |
| | Properties: Anionic, | | (Nippon Light Metal) | | |
| | Slightly yellow powdery | | Properties: Anionic, Slightly | | |
| | Viscosity (20%, 50° C.): | | yellow liquid, Concentration: 20% | | |
| | 74 mPa · s, pH: 5.5 | | (as ZrO2) Viscosity: 8 cps, pH: 9.5 | | |
| 198 | Not used | | Detackifying waterproofing agent: | 0.5 | o |
| | | | Polyamine epichlorohydrin resin | | |
| | | | Trade name: PA-625 (Nippon | | |
| | | | PMC corporation) | | |
| | | | Properties: Weakly cationic, Light | | |
| | | | brown, transparent liquid, | | |
| | | | Concentration: 60% Viscosity: 250 cps, | | |
| | | | pH (20° C.): 7.0 | | |
| 199 | Ampholytic polyacryloamide | 0.4 | Detackifying sizing agent: | 1.0 | o |
| | Trade name: Fixter K-6LS | | Strengthened rosin sizing agent | | |
| | (Seiko Chemical Industries) | | Trade name: Sizepine E-50 | | |
| | Properties: Ampholytic, Light | | (ARAKAWA CHEMICAL INDUSTRIES) | | |
| | brown, transparent, viscous | | Properties: Anionic, Brown, | | |
| | liquid, Concentration: 15.2%, | | transparent liquid, Concentration: | | |
| | Viscosity (25° C.): 680 cps, | | 50.4% Viscosity (25° C.): 200 | | |
| | pH (1.5%): 4.7 | | cps, pH (5%, 20° C.): 11.0 | | |

### EXAMPLES 200 to 203

The pre-vulcanized natural rubber latex was incorporated with the hydrophilic polymer or hydrophilic group sealant, and treated with the hydrophilic group sealant for the internal surface. It was formed into the film, and treated with the hydrophilic group sealant reactive at low temperature for the external surface. The tackiness test result, and the hydrophilic polymer and hydrophilic group sealant used in each EXAMPLE are given in Table 25. The post-treatment step and hydrophilic group sealant reactive at low temperature for treating the external surface in each EXAMPLE are described below.

(Post-reatment)

The natural rubber latex film film prepared was treated by the following steps in the order described below, unless otherwise stated:

Heating→Immersion in the solution for treating the external surface→Drying→Leaching→Post-vulcanization

Post-treatment temperature and treatment time in each EXAMPLE were:

### EXAMPLE 200

The natural rubber latex film formed was heated at 38° C. for 5 minutes, and leached at 70° C. for 3 minutes. Then, it was heated at 95° C. for 1 minute, and immersed in the treating solution of the hydrophilic group sealant for the external surface for 5 seconds. Furthermore, it was post-vulcanized at 110° C. for 10 minutes.

### EXAMPLE 201

Heating: 95° C., 3 min., Drying: 95° C., 10 min., Leaching: 85° C., 3 min., Post-vulcanization: 110° C., 10 min.

### EXAMPLES 202 and 203

Heating: 40° C., 4 min., Drying: 95° C., 5 min., Leaching: 85° C., 3 min., Post-vulcanization: 110° C., 10 min. (Hydrophilic group sealant reactive at low temperature for treating the external surface)

### EXAMPLE 200

Detackifying crosslinking agent of metallic element: Polyaluminum hydroxide
Paho#2S (Asada Kagaku Kogyo)

The above-described sealant was diluted with water to have an Al₂O₃ concentration of 0.5% for use in each.

### EXAMPLES 201 to 203

Detackifying crosslinking agent of metallic element: Zirconyl acetate
Zircosol ZA (DAIICHIKIGENSO KAGAKUKOGYO)

The above-described sealant was diluted with water to have a ZrO₂ concentration of 1% for use.

TABLE 25

| | Hydrophilic polymers to | | | | |
|---|---|---|---|---|---|
| | be incorporated in the latex | | Hydrophilic group blocking agents | | |
| | | Incorporated | for treating the internal surface | | |
| Examples | | quantity | | Concen- | Test |
| NO. | | (parts) | | tration (%) | results |
| 200 | Not used | | Detacking crosslinking agent of | 0.5 | o |
| | | | metallic element: Polyaluminum | (asAl₂O₃) | |
| | | | hydroxide | | |
| | | | Trade name: Paho #2S | | |
| | | | (Asada Kagaku Kogyo) | | |
| | | | Properties: Cationic, Light yellow, | | |
| | | | Transparent liquid, Viscosity | | |
| | | | (30° C.): 7 cps, Concentration: | | |
| | | | 10.5% (as Al2O3), pH: 3.5 | | |
| 201 | Not used | | Detackifying, hydrogen bond adjustor: | 1.5 | o |
| | | | Polyamide/polyamine epichlorohydrin | | |
| | | | resin | | |
| | | | Trade name: Sumirez Resin 6615 | | |
| | | | (Sumitomo Chemical Group) | | |
| | | | Properties: Cationic, Brown, | | |
| | | | transparent liquid, Concentration: 15% | | |
| | | | Viscosity (25° C.): 40 mPa · s, | | |
| | | | pH (25° C.): 4.0 | | |
| 202 | Cationized tapioca starch | 0.25 | Crosslinking agent of detackifying, | 0.5 | o′ |
| | Trade name: Catesize 350 | | aqueous resin: Carbodiimide | | |
| | (Nippon NSC) | | Trade name: CARBODILITE V-02 | | |
| | Properties: Cationic, White | | (Nisshinbo Industries) | | |
| | powdery Viscosity (5%, 40° C.): | | Properties: Yellow, transparent | | |
| | 17 cps | | liquid, Carbodiimide equivalents: | | |
| | | | 597 Concentration: 40%, pH: 10.1 | | |
| 203 | Carboxymethyl cellulose | 0.25 | Detackifying, hydrogen bond adjustor: | 1.0 | o |
| | Trade name: CMC DAICEL 1330 | | Polyamide/polyamine epichlorohydrin | | |
| | (DAICEL CHEMICAL INDUSTRIES) | | resin | | |
| | Properties: Anionic, White | | Trade name: Sumirez Resin 675 | | |
| | powdery, Viscosity (1%, 25° C.): | | (Sumitomo Chemical Group) | | |
| | 73 cps pH: 6.8, Degree of | | Properties: Cationic, Brown, | | |
| | etherification: 1.27 | | transparent liquid, Concentration: | | |
| | | | 25% Viscosity (25° C.): 200 | | |
| | | | mPa · s, pH (25° C.): 4.1 | | |

### 9. Quantitative Analysis of Protein

Eluted protein was quantitatively analyzed in accordance with JIS T-9010 (Testing method for biological safety of rubber products); 3.6 Colorimetry based on the BCA method for water-soluble protein.

### 10. Analysis of Protein in Natural Rubber Latex Film

### COMPARATIVE EXAMPLE 3

The pre-vulcanized natural rubber latex was incorporated with the hydrophilic polymer, formed into the film, and post-treated for analysis of protein. The analysis result and the hydrophilic polymer used are given in Table 26. The post-treatment step is described below:

(Post-treatment)

The natural rubber latex film prepared was treated by the following steps in the order described below:

Heating→Leaching→Post-vulcanization

Post-treatment temperature and treatment time in COMPARATIVE EXAMPLE 3 were:

Heating Leaching Post-vulcanization 95° C., 7 min. 85° C., 3 min. 110° C., 5 min.

TABLE 26

| | Incorporated | Protein |
|---|---|---|
| Hydrophilic polymers to be | quantity | content |
| incorporated in the latex | (parts) | (ppm) |
| Carboxymethyl cellulose | 0.25 | 140 |
| Trade name: CMC DAICEL 1330 | | |
| (DAICEL CHEMICAL INDUSTRIES) | | |
| Properties: Anionic, White powdery, | | |
| Viscosity (1%, 25° C.): 73 cps | | |
| pH: 6.8, Degree of etherification: 1.27 | | |
| Carboxylate-based acrylic copolymer | 0.25 | 60 |
| Trade name: ARON A-7180 (Toagosei) | | |
| Properties: Anionic, Semi-transparent, | | |
| viscous liquid, Concentration: 16.4% | | |
| Viscosity (25° C.): 20950 cps, | | |
| pH (25° C.): 9.0 | | |
| Polyamide derivative: Polyoxyethylen | 0.25 | 66 |
| ealkyl ether | | |
| Trade name: Elsoft A (Ipposha Oil | | |
| Industries) | | |
| Properties: Nonionic, Light yellow, | | |
| pasty, Concentration: 15% | | |
| Methyl cellulose | 0.4 | 247 |
| Trade name: Metolose SM-400 (Shin-Etsu | | |
| Chemical) | | |
| Properties: Nonionic, White powdery | | |
| Viscosity (2%, 20° C.): 436 mPa · s | | |
| Locust bean gum | 0.5 | 120 |
| Trade name: Soar Locust A120F (MRC | | |
| Polysaccharides) | | |
| Properties: Nonionic, White powdery | | |
| Viscosity (1%, 25° C.): 1200 cps | | |
| Alkyl acetalized polyvinyl alcohol | 0.5 | 140 |
| Trade name: Eslec KW-3 | | |
| (SEKISUI CHEMICAL) | | |
| Properties: Nonionic, Transparent, | | |
| viscous liquid, Concentration: 20% | | |
| Viscosity: 3500 mPa · s, pH: 6 | | |

### COMPARATIVE EXAMPLE 4

The pre-vulcanized natural rubber latex was incorporated or treated for both internal and external surfaces with an epoxy compound. It was formed into the film, and post-treated for analysis of protein. The analysis result and the epoxy compound are given in Table 27. The post-treatment step is described below:

(Post-treatment)

When the natural rubber latex was incorporated with the epoxy compound:

The natural rubber latex film prepared was treated by the following steps in the order described below:

Heating→Leaching→Post-vulcanization

Post-treatment temperature and treatment time in COMPARATIVE EXAMPLE 4 were:
Heating Leaching Post-vulcanization 95° C., 7 min. 85° C., 3 min. 110° C., 5 min.

When the natural rubber latex was surface-treated with the epoxy compound:

The natural rubber latex film film prepared was treated by the following steps in the order described below:

Heating→Immersion in the solution for treating the external surface→Drying→Leaching→Post-vulcanization

Post-treatment temperature and treatment time in COMPARATIVE EXAMPLE 4 were:

Heating: 50° C., 2 min., Drying: 95° C., 5 min., Leaching: 85° C., 3 min., Post-vulcanization: 110° C., 5 min.

TABLE 27

| | | Protein |
|---|---|---|
| | | content |
| Epoxy compound | | (ppm) |
| Glycerol polyglycidyl ether | When | 215 |
| | incorporated: | |
| Trade name: Denacol EX-313 | Incorporated | |
| (Nagase ChemteX Corporation) | | |
| Properties: Anionic, Light yellow | quantity | |
| liquid | (parts) | |
| Viscosity (25° C.): 150 mPa · s, | 1.0 | |
| Epoxy equivalents: 141WPE | | |
| | When used for | 103 |
| | surface treatment | |
| | Concentration (%) | |
| | 2.0 | |

### COMPARATIVE EXAMPLE 5

The pre-vulcanized natural rubber latex was formed into the film, and post-treated for analysis of protein. The analysis result is given in Table 28. The post-treatment step is described below:

(Post-treatment)

The natural rubber latex film prepared was treated by the following steps in the order described below, unless otherwise stated:

Heating→Leaching→Post-vulcanization

Post-treatment temperature and treatment time in COMPARATIVE EXAMPLE 5 were:
Heating Leaching Post-vulcanization

(Leaching treatment at lower temperature) 50° C., 8 min. 70° C., 3 min. 110° C., 5 min.

(Leaching treatment at higher temperature) 95° C., 5 min. 85° C., 3 min. 110° C., 5 min. (Chlorination of both internal and external surfaces)

The natural rubber latex film prepared was heated at 50° C. for 5 minutes, and leached at 85° C. for 3 minutes. Then, it was heated at 95° C. for 5 minutes, released out of the mold, and immersed in chlorine water (chlorine concentration: 0.4%) for 3 minutes, to halogenate both surfaces. Then, it was leached at 85° C. for 1 minute and finally post-vulcanized at 110° C. for 5 minutes.

### COMPARATIVE EXAMPLE 6

The diene-based carboxylated NBR latex was pre-vulcanized under the same conditions as those for the above-described natural rubber latex. It was formed into the film, and post-treated for analysis of protein. The analysis result is also given in Table 28. The post-treatment step and diene-based carboxylated NBR latex used are described below:

(Post-treatment)

The NBR latex film prepared was heated at 95° C. for 5 minutes, leached at 85° C. for 3 minutes, and finally post-vulcanized at 110° C. for 5 minutes.

(Carboxylated NBR Latex)

Nipol LX-551 (Zeon Corporation)

TABLE 28

| | | Measured |
|---|---|---|
| Comparative | | protein |
| Example No. | Remarks | content (ppm) |
| 5 | Leaching at lower temperature | 125 |
| | as the post-treatment step | |
| | Leaching at higher temperature | 75 |
| | as the post-treatment step | |
| | Chlorination on both surfaces | 10 |
| | as the post-treatment step | |
| 6 | The diene-based carboxylated NBR, | 5 |
| | pre-vulcanized under the same | |
| | conditions as those for the natural | |
| | rubber latex, and leached at higher | |
| | temperature as the post-treatment step | |

### EXAMPLES 204 to 210

The pre-vulcanized natural rubber latex was incorporated with the anionic group introducing compound. It was formed into the film, and post-treated for analysis of protein. The analysis result and the anionic group introducing compound used in each EXAMPLE are given in Table 29. The post-treatment step is described below:

(Post-treatment)

The natural rubber latex film prepared was treated by the following steps in the order described below:

Heating→Leaching→Post-vulcanization

Post-treatment temperature and treatment time in each EXAMPLE were:

Heating Leaching Post-vulcanization 95° C., 7 min. 85° C., 3 min. 110° C., 5 min.

TABLE 29

| | | | Measured |
|---|---|---|---|
| | | Incorporated | protein |
| Examples | | quantity | content |
| NO. | Anionic group introducing compounds to be incorporated in the latex | (parts) | (ppm) |
| 204 | Sulfate ethyl sulfone/monochlorotriazine-based bifunctional reactive dye | 0.5 | 36.0 |
| | Trade name: Sumifix Supra Brilliant yellow 3GF (Sumitomo Chemical Group) | | |
| 205 | Sulfate ethyl sulfone/monochlorotriazine-based multi-functional reactive dye | 0.5 | 24.0 |
| | Trade name: Sumifix HF yellow 3R gran (Sumitomo Chemical Group) | | |
| 206 | Dichlorotriazine-based reactive dye | 0.5 | 25.0 |
| | Trade name: Procion yellow MX-3R (BASF Corporation) | | |
| 207 | Carboxypyridinio-S-triazine-based reactive dye | 0.5 | 38.0 |
| | Trade name: Kayacelon React Yellow CN-4G (NIPPON KAYAKU) | | |
| 208 | α-Bromo acrylamide-based reactive dye | 0.5 | 34.9 |
| | Trade name: Lanasol Yellow 4G (Ciba Specialty Chemicals) | | |
| 209 | Alkenyl succinic anhydride | 0.25 | 45.0 |
| | Trade name: Coloparl Z-100 (Seiko Chemical Industries) | | |
| | Properties: Brown, transparent liquid, Viscosity (25° C.): 200 cps | | |
| 210 | Urea phosphorylated starch | 0.25 | 39.0 |
| | Trade name: MS#4600 (Nihon Shokuhin Kako) | | |
| | Properties: Anionic, Slightly yellow powdery | | |
| | Viscosity (20%, 50° C.): 74 mPa · s, | | |
| | pH: 5.5 | | |

### EXAMPLES 211 to 213

The pre-vulcanized natural rubber latex was incorporated with the anionic group introducing compound, and treated with the cationic group introducing compound for both surfaces. It was formed into the film, and post-treated for analysis of protein. The analysis result and the anionic group and cationic group introducing compounds used in each EXAMPLE are given in Table 30. The post-treatment step is described below:

(Post-treatment)

The natural rubber latex film film prepared was treated by the following steps in each EXAMPLE in the order described below:

Heating→Immersion in the solution for treating the external surface→Drying→Leaching→Post-vulcanization

Post-treatment temperature and treatment time in each EXAMPLE were:

### EXAMPLE 211

Heating: 50° C., 5 min., Drying: 95° C., 5 min., Leaching: 85° C., 3 min., Post-vulcanization: 110° C., 5 min.

### EXAMPLES 212 and 213

Heating: 50° C., 2 min., Drying: 95° C., 5 min., Leaching: 85° C., 3 min., Post-vulcanization: 110° C., 5 min.

TABLE 30

| | Reactive dyes to be | | | | |
|---|---|---|---|---|---|
| | incorporated in the latex | | Cationic group introducing compounds | | Measurement |
| | | Incorporated | for treating both surfaces | | result |
| Examples | | quantity | | Concen- | protein |
| NO. | | (parts) | | tration (%) | content (ppm) |
| 211 | Sulfate ethyl sulfone/monochlorotriazine- | 0.5 | Polyamine epichlorohydrin resin | 1.0 | 17.5 |
| | based bifunctional reactive dye | | Trade name: CIBAFIX E | | |
| | Trade name: Sumifix Supra Brilliant | | (Ciba Specialty Chemicals) | | |
| | yellow 3GF (Sumitomo Chemical Group) | | Properties: Cationic, Light | | |
| | | | yellow liquid, Concentration: 20% | | |
| | | | pH (5% solution): 5 | | |
| 212 | Sulfate ethyl sulfone/monochlorotriazine- | 0.25 | Polyamine epichlorohydrin resin | 1.0 | 18.5 |
| | based multi-functional reactive dye | | Trade name: WS-564 (Nippon | | |
| | Trade name: Sumifix HF yellow 3R gran | | PMC corporation) | | |
| | (Sumitomo Chemical Group) | | Properties: Cationic, Light amber | | |
| | | | liquid, Concentration: 20% | | |
| | | | Viscosity (25° C.): 50 cps, | | |
| | | | pH: 3.7 | | |
| 213 | Sulfate ethyl sulfone/monochlorotriazine- | 0.5 | Crosslinking agent of metallic | 1.0 | 12.5 |
| | based bifunctional reactive dye | | element: Polyaluminum hydroxide | (asAl₂O₃) | |
| | Trade name: Sumifix HF yellow 3R gran | | Trade name: Paho#2S (Asada | | |
| | (Sumitomo Chemical Group) | | Kagaku Kogyo) | | |
| | | | Properties: Cationic, Light yellow, | | |
| | | | transparent liquid, Viscosity | | |
| | | | (30° C.): 7 cps Concentration: | | |
| | | | 10.5% (as Al2O3), pH: 3.5 | | |

### EXAMPLES 214 to 217

The pre-vulcanized natural rubber latex was treated with the cationic group introducing compound for both surfaces. It was formed into the film, and post-treated for analysis of protein. The analysis result and the cationic group introducing compound used in each EXAMPLE are given in Table 31. The post-treatment step in each EXAMPLE is described below:

(Post-treatment)

The natural rubber latex film film prepared was treated by the following steps in the order described below:

Heating→Immersion in the solution for treating the external surface→Drying→Leaching→Post-vulcanization

Post-treatment temperature and treatment time in each EXAMPLE were:

### EXAMPLES 214 and 216

Heating: 50° C., 5 min., Drying: 95° C., 5 min., Leaching: 85° C., 3 min., Post-vulcanization: 110° C., 5 min.

### EXAMPLES 215 and 217

Heating: 50° C., 2 min., Drying: 95° C., 5 min., Leaching: 85° C., 3 min., Post-vulcanization: 110° C., 5 min.

TABLE 31

| | Cationic group introducing compounds for treating both surfaces | | Analysis result |
|---|---|---|---|
| Examples | | Concentration | protein content |
| NO. | | (%) | (ppm) |
| 214 | Polyamine epichlorohydrin resin | 1.0 | 37.5 |
| | Trade name: CIBAFIX E (Ciba Specialty Chemicals) | | |
| | Properties: Cationic, Light yellow liquid, Concentration: 20% | | |
| | pH (5% solution): 5 | | |
| 215 | Crosslinking agent of metallic element: Polyaluminum hydroxide | 2.0 | 14.0 |
| | Trade name: Paho#2S (Asada Kagaku Kogyo) | (asAl₂O₃) | |
| | Properties: Cationic, Light yellow, transparent liquid, Viscosity (30° C.): 7 cps, | | |
| | Concentration: 10.5% (as Al2O3), pH: 3.5 | | |
| 216 | Polyamide/polyamine epichlorohydrin resin | 0.5 | 15.0 |
| | Trade name: Euramine P5600 (Mitsui Chemicals) | | |
| | Properties: Cationic, Light yellow, transparent liquid, Concentration: 31% | | |
| | Viscosity (25° C.): 71.3 mPa · s, pH (25° C.): 4.5 | | |
| 217 | Polyamine epichlorohydrin resin | 2.0 | 12.5 |
| | Trade name: WS-564 (Nippon PMC corporation) | | |
| | Properties: Cationic, Light amber liquid, Concentration: 20% | | |
| | Viscosity (25° C.): 50 cps, pH: 3.7 | | |

### EXAMPLES 218 to 223

The pre-vulcanized natural rubber latex was incorporated with the cationic group introducing compound. It was formed into the film, and post-treated for analysis of protein. The analysis result and the cationic group introducing compound used in each EXAMPLE are given in Table 32. The post-treatment step in each EXAMPLE is described below:

(Post-treatment)

The natural rubber latex film prepared was treated by the following steps in the order described below:

Heating→Leaching→Post-vulcanization

Post-treatment temperature and treatment time in each EXAMPLE were:

Heating Leaching Post-vulcanization 95° C., 7 min. 85° C., 3 min. 110° C., 5 min.

TABLE 32

| | Cationic group introducing compounds to be incorporated in the latex | | |
|---|---|---|---|
| | | Incorporated | Analysis result |
| Examples | | quantity | protein content |
| No | | (parts) | (ppm) |
| 218 | Polyamide/polyamine epichlorohydrin resin | 0.25 | 17.5 |
| | Trade name: Sumirez Resin 6625 (Sumitomo Chemical Group) | | |
| | Properties: Cationic, Brown, transparent liquid, Concentration: 25% | | |
| | Viscosity (25° C.): 200 mPa · s, pH (25° C.): 4.0 | | |
| 219 | Polyamidepolyamine resin epichlorohydrin modification | 0.25 | 35.0 |
| | Trade name: Wet Master GT-360 (Toho Chemical Industry) | | |
| | Properties: Cationic, Light yellow/brown, slightly white turbid liquid, Concentration: 59.2% | | |
| | Viscosity (25° C.): 173 mPa · s, pH: 4.3 | | |
| 220 | Styrene-based tertiary amino group-modified polyamide/polyamine epichlorohydrin resin | 0.25 | 32.5 |
| | Trade name: Polymaron 360 (ARAKAWA CHEMICAL INDUSTRIES) | | |
| | Properties: Cationic, Light yellow, slightly white turbid liquid, Concentration: 20.4% | | |
| | Viscosity: 14.5 mPa · s, pH: 4.9 | | |
| 221 | Zirconium ammonium lactate or zirconium ammonium citrate | 0.25 | 35.0 |
| | Trade name: SEQUAREZ 82 (OMNOVA Solutions) | | |
| | Properties: Cationic, Transparent white solution, Concentration: 27% | | |
| | Viscosity: 17 mPa · s, pH: 7.5 | | |
| 222 | Cationized tapioca starch | 0.25 | 28.0 |
| | Trade name: Cato308 (Nippon NSC) | | |
| | Properties: Cationic, White powdery | | |
| 223 | Ampholytic starch | 0.25 | 35.0 |
| | Trade name: Optibond 3282 (Nippon NSC) | | |
| | Properties: Ampholytic, White powdery | | |

### EXAMPLE 224

The pre-vulcanized natural rubber latex was incorporated with the waterproofing agent reactive with and capable of fixing protein in the natural rubber latex under an alkaline condition. It was formed into the film, and post-treated for analysis of protein. The analysis result and the waterproofing agent used in this EXAMPLE are given in Table 33. The post-treatment step is described below:

(Post-treatment)

The natural rubber latex film prepared was treated by the following steps in the order described below:

Heating→Leaching→Post-vulcanization

Post-treatment temperature and treatment time in each EXAMPLE were:

Heating Leaching Post-vulcanization 95° C., 7 min. 85° C., 3 min. 110° C., 5 min.

TABLE 33

| | Waterproofing agent to be incorporated in the latex | | |
|---|---|---|---|
| | | Incorporated | Analysis result |
| Example | | quantity | protein content |
| No. | | (parts) | (ppm) |
| 224 | Ketone resin | 0.25 | 34.0 |
| | Trade name: SI-668 (Nippon PMC corporation) | | |
| | Properties: Nonionic, Slightly white turbid solution, Concentration: 50% | | |
| | Viscosity: 40 cps, pH: 7 | | |

### EXAMPLES 225 to 229

The pre-vulcanized natural rubber latex was incorporated with the hydrophilic polymer, and surface-treated with the cationic group introducing compound. It was formed into the film for the tackiness test and analysis of protein. The results, and the hydrophilic polymer and cationic group introducing compound used in each EXAMPLE are given in Table 34. The Post-treatment step in each EXAMPLE is described below:

(Treatment)

The natural rubber latex film prepared was treated by the following steps in the order described below for both surfaces, unless otherwise stated:

Heating→Immersion in the solution for treating the external surface→Drying→Leaching→Post-vulcanization

Post-treatment temperature and treatment time in each EXAMPLE were:

### EXAMPLE 225

Heating: 50° C., 5 min., Drying: 95° C., 5 min., Leaching: 85° C., 3 min., Post-vulcanization: 110° C., 5 min.

### EXAMPLE 226

Heating: 50° C., 2 minutes, Drying: 95° C., 5 minutes, Leaching: 85° C., 3 min., Post-vulcanization: 110° C., 5 min.

### EXAMPLE 227

The natural rubber latex film was dried at 50° C. for 1 minute, and leached at 75° C. for 3 minutes. Then, it was heated at 95° C. for 1 minute, and immersed in the treating solution of the hydrophilic group sealant for the external surface for 5 seconds. Furthermore, it was dried at 95° C. for 5 minutes, leached at 75° C. for 1 minute, and finally post-vulcanized at 110° C. for 5 minutes.

### EXAMPLES 228 and 229

The natural rubber latex film was heated at 50° C. for 5 minutes, and leached at 85° C. for 3 minutes. Then, it was heated at 95° C. for 1 minute, and immersed in the treating solution of the hydrophilic group sealant for the external surface for 5 seconds. Furthermore, it was dried at 95° C. for 3 minutes, leached at 85° C. for 1 minute, and finally post-vulcanized at 110° C. for 5 minutes.

TABLE 34

| | Hydrophilic polymers to | | | | Measured | |
|---|---|---|---|---|---|---|
| | be incorporated in the latex | | Cationic group introducing compounds | | protein | |
| | | Incorporated | for treating both surfaces | | content (ppm) | Tackiness |
| Examples | | quantity | | Concen- | protein | test |
| NO. | | (parts) | | tration (%) | content (ppm) | results |
| 225 | Carboxylate-based acrylic copolymer | 0.25 | Polyamide/polyamine epichlorohydrin | 1.0 | 22.5 | o |
| | Trade name: ARON A-7180 (Toagosei) | | resin | | | |
| | Properties: Anionic, Semi-transparent, | | Trade name: Euramine P5600 (Mitsui | | | |
| | viscous liquid, Concentration: 16.4% | | Chemicals) | | | |
| | Viscosity (25° C.): 20950 cps, | | Properties: Cationic, Light yellow, | | | |
| | pH (25° C.): 9.0 | | transparent liquid, Concentration: 31% | | | |
| | | | Viscosity (25° C.): 71.3 mPa · s, | | | |
| | | | pH (25° C.): 4.5 | | | |
| 226 | Alkyl acetalized polyvinyl alcohol | 0.5 | Polyamide/polyamine epichlorohydrin | 2.0 | 17.0 | o |
| | Trade name: Eslec KW-3 | | resin | | | |
| | (SEKISUI CHEMICAL) | | Trade name: Sumirez Resin 6625 | | | |
| | Properties: Nonionic, Transparent, | | (Sumitomo Chemical Group) | | | |
| | viscous liquid, Concentration: 20% | | Properties: Cationic, Brown, | | | |
| | Viscosity: 3500 mPa · s, pH: 6 | | transparent liquid, Concentration: 25% | | | |
| | | | Viscosity (25° C.): 200 mPa · s, | | | |
| | | | pH (25° C.): 4.0 | | | |
| 227 | Hydrogen bond adjustor, Polyamide | 0.25 | Internal surface | 2.5 | 21.0 | o |
| | derivative Polyoxyethylen ealkyl | | Crosslinking agent of metallic | (asAl₂O₃) | | |
| | ether | | element: Polyaluminum hydroxide | | | |
| | Trade name: Elsoft A | | Trade name: Paho#2S | | | |
| | (Ipposha Oil Industries) | | (Asada Kagaku Kogyo) | | | |
| | Properties: Nonionic, Light | | Properties: Cationic, Light | | | |
| | yellow, pasty, Concentration: 15% | | yellow, transparent liquid, | | | |
| | | | Viscosity (30° C.): 7 cps | | | |
| | | | Concentration: 10.5% (as Al2O3), | | | |
| | | | pH: 3.5 | | | |
| | | | External surface | 1.0 | | |
| | | | Polyamide/polyamine epichlorohydrin | | | |
| | | | resin | | | |
| | | | Trade name: Sumirez Resin 6625 | | | |
| | | | (Sumitomo Chemical Group) | | | |
| | | | Properties: Cationic, Brown, | | | |
| | | | transparent liquid, Concentration: 25% | | | |
| | | | Viscosity (25° C.): 200 mPa · s, | | | |
| | | | pH (25° C.): 4.0 | | | |
| 228 | Copolymerized polyamide emulsion | 0.25 | Internal surface | 1.0 | 16.2 | o |
| | Trade name: Griltex 2 Suspension | | Crosslinking agent of metallic | (asAl₂O₃) | | |
| | (EMS SHOWA DENKO K.K.) | | element: Polyaluminum hydroxide | | | |
| | Properties: Nonionic, Milky white | | Trade name: Paho#2S | | | |
| | aqueous solution, Concentration: 40% | | (Asada Kagaku Kogyo) | | | |
| | Viscosity: 1500 cps, pH: 9.5 | | Properties: Cationic, Light yellow, | | | |
| | | | transparent liquid, Viscosity | | | |
| | | | (30° C.): 7 cps Concentration: 10.5% | | | |
| | | | (as Al2O3), pH: 3.5 | | | |
| | | | External surface | 1.0 | | |
| | | | Crosslinking agent of metallic | (asAl₂O₃) | | |
| | | | element: Alumina sol | | | |
| | | | Trade name: Alumina sol 200 | | | |
| | | | (Nissan Chemical Industries) | | | |
| | | | Properties: Cationic, Milky white, | | | |
| | | | colloidal solution, Concentration: | | | |
| | | | 10.1% (as Al2O3) Viscosity (20° C.): | | | |
| | | | 530 mPa · s, pH (20° C.): 4.8 | | | |
| 229 | Polyvinyl butyral resin emulsion | 0.25 | Internal surface | 1.0 | 15.0 | o |
| | Trade name: Rczcm VB-1 | | Crosslinking agent of metallic | as Al₂O₃ | | |
| | (CHUKYO YUSHI) | | element: Polyaluminum hydroxide | | | |
| | Properties: Nonionic, White | | Trade name: Paho#2S | | | |
| | liquid, Concentration: 35% | | (Asada Kagaku Kogyo) | | | |
| | Viscosity (25° C.): 20 mPa · s, | | Properties: Cationic, Light | | | |
| | pH (diluted 10 times): 7.2 | | yellow, transparent liquid, | | | |
| | | | Viscosity (30° C.): 7 cps | | | |
| | | | Concentration: 10.5% (as Al2O3), pH: 3.5 | | | |
| | | | External surface | 1.0 | | |
| | | | Crosslinking agent of metallic | as Al₂O₃ | | |
| | | | element: Alumina sol | | | |
| | | | Trade name: Alumina sol 200 | | | |
| | | | (Nissan Chemical Industries) | | | |
| | | | Properties: Cationic, Milky white, | | | |
| | | | colloidal solution, Concentration: | | | |
| | | | 10.1% (as Al2O3) Viscosity (20° C.): | | | |
| | | | 530 mPa · s, pH (20° C.): 4.8 | | | |

### EXAMPLES 230 to 232

The pre-vulcanized natural rubber latex was incorporated with the reactive dye, and surface-treated with the cationic group introducing compound. It was formed into the film for the tackiness test and analysis of protein. The results, and the reactive dye and cationic group introducing compounds used in each EXAMPLE are given in Table 35. The post-treatment step in each EXAMPLE is described below:

(Post-treatment)

The natural rubber latex film film prepared was treated by the following steps in the order described below:

Heating→Immersion in the solution for treating the external surface→Drying→Leaching→Post-vulcanization

Post-treatment temperature and treatment time in each EXAMPLE were:

### EXAMPLE 230

Heating: 50° C., 5 min., Drying: 95° C., 5 min., Leaching: 85° C., 3 min., Post-vulcanization: 110° C., 5 min.

### EXAMPLES 231 to 232

Heating: 50° C., 2 min., Drying: 95° C., 5 min., Leaching: 85° C., 3 min., Post-vulcanization: 110° C., 5 min.

TABLE 35

| | Reactive dyes to be | | | | Measured | |
|---|---|---|---|---|---|---|
| | incorporated in the latex | | Cationic group introducing compounds | | protein | |
| | | Incorporated | for treating both surfaces | | content (ppm) | Tackiness |
| Examples | | quantity | | Concen- | protein | test |
| NO. | | (parts) | | tration (%) | content (ppm) | results |
| 230 | Sulfate ethyl sulfone/monochloro- | 0.5 | Polyamine epichlorohydrin resin | 1.0 | 17.5 | o |
| | triazine-based bifunctional reactive | | Trade name: CIBAFIX E | | | |
| | dye | | (Ciba Specialty Chemicals) | | | |
| | Trade name: Sumifix Supra Brilliant | | Properties: Cationic, Light yellow | | | |
| | yellow 3GF (Sumitomo Chemical Group) | | liquid, Concentration: 20% | | | |
| | | | pH (5% solution): 5 | | | |
| 231 | Sulfate ethyl sulfone/monochloro- | 0.25 | Polyamine epichlorohydrin resin | 1.0 | 18.5 | o |
| | triazine-based multi-functional | | Trade name: WS-564 (Nippon | | | |
| | reactive dye | | PMC corporation) | | | |
| | Trade name: Sumifix HF yellow 3R | | Properties: Cationic, Light amber | | | |
| | gran (Sumitomo Chemical Group) | | liquid, Concentration: 20% | | | |
| | Properties: | | Viscosity (25° C.): 50 cps, pH: 3.7 | | | |
| 232 | Sulfate ethyl sulfone/monochloro- | 0.5 | Detackifying crosslinking agent | 1.0 | 12.5 | o |
| | triazine-based bifunctional reactive | | of metallic element: Polyaluminum | (asAl₂O₃) | | |
| | dye | | hydroxide | | | |
| | Trade name: Sumifix Supra Brilliant | | Trade name: Paho#2S | | | |
| | yellow 3GF (Sumitomo Chemical Group) | | (Asada Kagaku Kogyo) | | | |
| | | | Properties: Cationic, Light yellow, | | | |
| | | | transparent liquid, Viscosity | | | |
| | | | (30° C.): 7 cps Concentration: | | | |
| | | | 10.5% (as Al2O3), pH: 3.5 | | | |

### EXAMPLES 233 to 236

The pre-vulcanized natural rubber latex was surface-treated with the cationic group introducing compound. It was formed into the film for the tackiness test and analysis of protein. The results and the cationic group introducing compound used in each EXAMPLE are given in Table 36. The post-treatment step in each EXAMPLE is described below:

(Post-treatment)

The natural rubber latex film film prepared was treated by the following steps in the order described below:

Heating→Immersion in the solution for treating the external surface→Drying→Leaching→Post-vulcanization

Post-treatment temperature and treatment time in each EXAMPLE were:

### EXAMPLE 233

Heating: 50° C., 5 min., Drying: 95° C., 5 min., Leaching: 85° C., 3 min., Post-vulcanization: 110° C., 5 min.

### EXAMPLES 234 to 235

Heating: 50° C., 2 min., Drying: 95° C., 5 min., Leaching: 85° C., 3 min., Post-vulcanization: 110° C., 5 min.

### EXAMPLE 236

The natural rubber latex film was heated at 50° C. for 5 minutes, and leached at 85° C. for 5 minutes. Then, it was heated at 95° C. for 1 minute, and immersed in the treating solution of the hydrophilic group sealant for the external surface for 5 seconds. Furthermore, it was dried at 95° C. for 3 minutes, leached at 85° C. for 1 minute, and finally post-vulcanized at 110° C. for 5 minutes.

TABLE 36

| | Cationic group | | Cationic group | | Measured | |
|---|---|---|---|---|---|---|
| | introducing compounds for | | introducing compounds for | | protein | |
| | treating the external surface | | treating the external surface | | content (ppm) | Tackiness |
| Examples | | Concen- | | Concen- | protein | test |
| NO. | | tration (%) | | tration (%) | content (ppm) | results |
| 233 | Polyamide/polyamine epichloro- | 0.5 | Polyamide/polyamine epichloro- | 0.5 | 15.0 | o |
| | hydrin resin | | hydrin resin | | | |
| | Trade name: Euramine P5600 | | Trade name: Euramine P5600 | | | |
| | (Mitsui Chemicals) | | (Mitsui Chemicals) | | | |
| | Properties: Cationic, Light yellow, | | Properties: Cationic, Light | | | |
| | transparent liquid, Concentration: | | yellow, transparent liquid, | | | |
| | 31% Viscosity (25° C.): | | Concentration: 31% Viscosity | | | |
| | 71.3 mPa · s, pH (25° C.): 4.5 | | (25° C.): 71.3 mPa · s, | | | |
| | | | pH (25° C.): 4.5 | | | |
| 234 | Polyamine epichlorohydrin resin | 2.0 | Polyamine epichlorohydrin | 2.0 | 12.5 | o |
| | Trade name: WS-564 (Nippon | | resin | | | |
| | PMC corporation) | | Trade name: WS-564 (Nippon | | | |
| | Properties: Cationic, Light amber | | PMC corporation) | | | |
| | liquid, Concentration: 20% | | Properties: Cationic, Light | | | |
| | Viscosity (25° C.): 50 cps, pH: 3.7 | | amber liquid, Concentration: | | | |
| | | | 20% Viscosity (25° C.): 50 cps, | | | |
| | | | pH: 3.7 | | | |
| 235 | Crosslinking agent of metallic | 2.0 | Crosslinking agent of metallic | 2.0 | 14.0 | o |
| | element: Polyaluminum hydroxide | (asAl₂O₃) | element: Polyaluminum hydroxide | (asAl₂O₃) | | |
| | Trade name: Paho#2S | | Trade name: Paho#2S | | | |
| | (Asada Kagaku Kogyo) | | (Asada Kagaku Kogyo) | | | |
| | Properties: Cationic, Light yellow, | | Properties: Cationic, Light | | | |
| | transparent liquid, Viscosity | | yellow, transparent liquid, | | | |
| | (30° C.): 7 cps Concentration: | | Viscosity (30° C.): 7 cps | | | |
| | 10.5% (as Al2O3), pH: 3.5 | | Concentration: 10.5% (as Al2O3), | | | |
| | | | pH: 3.5 | | | |
| 236 | Crosslinking agent of metallic | 2.0 | Crosslinking agent of metallic | 1.4 | 16.3 | o |
| | element: Polyaluminum hydroxide | (asAl₂O₃) | element: Peroxy titania sol | (asTiO₂) | | |
| | Trade name: Paho#2S | | Trade name: TKC-301 | | | |
| | (Asada Kagaku Kogyo) | | (Tayca Corporation) | | | |
| | Properties: Cationic, Light yellow, | | Properties: Cationic, Yellow | | | |
| | transparent liquid, Viscosity | | transparent liquid, | | | |
| | (30° C.): 7 cps Concentration: | | Concentration: 1.4% (as TiO2) | | | |
| | 10.5% (as Al2O3), pH: 3.5 | | | | | |

### EXAMPLES 237 and 238

The pre-vulcanized natural rubber latex was incorporated with the cationic group introducing compound, and treated with the cationic group introducing compound for both surfaces. It was formed into the film, and post-treated for the tackiness test and analysis of protein.

The results, and the cationic compound and cationic group introducing compound used in each EXAMPLE are given in Table 37. The post-treatment step in each EXAMPLE is described below:

(Post-treatment)

The natural rubber latex film film prepared was treated by the following steps in the order described below:

Heating→Immersion in the solution for treating the external surface→Drying→Leaching→Post-vulcanization Post-treatment temperature and treatment time in each EXAMPLE were:

Heating: 50° C., 5 min., Drying: 95° C., 5 min., Leaching: 85° C., 3 min., Post-vulcanization: 110° C., 5 min.

TABLE 37

| | Cationic group | | | | | |
|---|---|---|---|---|---|---|
| | introducing compounds to | | | | Measured | |
| | be incorporated in the latex | | Cationic group introducing compounds | | protein | |
| | | Incorporated | for treating the external surface | | content (ppm) | Tackiness |
| Examples | | quantity | | Concen- | protein | test |
| NO. | | (parts) | | tration (%) | content (ppm) | results |
| 237 | Cationized starch | 0.25 | Polyamide/polyamine epichloro- | 0.5 | 14.0 | o |
| | Trade name: Cato308 | | hydrin resin | | | |
| | (Nippon NSC) | | Trade name: Euramine P5600 | | | |
| | Properties: Cationic, | | (Mitsui Chemicals) | | | |
| | White powdery | | Properties: Cationic, Light | | | |
| | | | yellow, transparent liquid, | | | |
| | | | Concentration: 31% | | | |
| | | | Viscosity (25° C.): 71.3 | | | |
| | | | mPa · s, pH (25° C.): | | | |
| | | | 4.5 | | | |
| 238 | Cationized starch | 0.25 | Polyamine epichlorohydrin resin | 1.0 | 27.5 | o |
| | Trade name: Cato308 | | Trade name: WS-564 (Nippon | | | |
| | (Nippon NSC) | | PMC corporation) | | | |
| | Properties: Cationic, | | Properties: Cationic, Light | | | |
| | White powdery | | amber liquid, Concentration: | | | |
| | | | 20% Viscosity (25° C.): | | | |
| | | | 50 cps, pH: 3.7 | | | |

### EXAMPLE 239

The pre-vulcanized natural rubber latex was incorporated with the waterproofing agent reactive with and capable of fixing protein in the natural rubber latex under an alkaline condition. It was surface-treated with the cationic group introducing compound, formed into the film, and post-treated for the tackiness test and analysis of protein. The analysis result, and the waterproofing agent and cationic group introducing compound used in this EXAMPLE are given in Table 38. The post-treatment step in each EXAMPLE is described below:

(Post-treatment)

The natural rubber latex film film prepared was treated by the following steps in the order described below:

Heating→Immersion in the solution for treating the external surface→Drying→Leaching→Post-vulcanization

Post-treatment temperature and treatment time in this EXAMPLE were:

Heating: 50° C., 5 min., Drying: 95° C., 5 min., Leaching: 85° C., 3 min., Post-vulcanization: 110° C., 5 min.

TABLE 38

| | Waterproofing agents to be | | Cationic group | | Measured | |
|---|---|---|---|---|---|---|
| | incorporated in the latex | | introducing compounds | | protein | |
| | | Incorporated | for treating both surfaces | | content (ppm) | Tackiness |
| | | quantity | | Concen- | protein | test |
| NO. | | (parts) | | tration (%) | content (ppm) | results |
| 239 | Ketone resin | 0.25 | Polyamide/polyamine epichloro- | 0.5 | 25 | o |
| | Trade name: SI-668 | | hydrin resin | | | |
| | (Nippon PMC corporation) | | Trade name: Euramine P5600 | | | |
| | Properties: Nonionic, | | (Mitsui Chemicals) | | | |
| | Slightly white turbid | | Properties: Cationic, Light | | | |
| | solution, Concentration: | | yellow, transparent liquid, | | | |
| | 50% Viscosity: 40 cps, pH: 7 | | Concentration: 31% | | | |
| | | | Viscosity (25° C.): 71.3 | | | |
| | | | mPa · s, pH (25° C.): 4.5 | | | |

### EXAMPLES 240 to 246

The pre-vulcanized natural rubber latex was incorporated with the hydrophilic polymer or cationic group introducing compound, and treated with the cationic group introducing compound for the internal surface. It was formed into the film, and coating-treated with the detackifying, carboxylated, NBR or halogenation-treated for the external surface, for the tackiness test and analysis of protein. The results, and the hydrophilic polymer and cationic group introducing compound used in each EXAMPLE are given in Table 39. The external surface coating treatment step, carboxylated NBR used, carboxyl group sealant used, and halogenation treatment step are described below:

(External Surface Coating Treatment Step)

The natural rubber latex film prepared was heated at 50° C. for 5 minutes, and leached at 85° C. for 3 minutes. Then, it was heated at 95° C. for 1 minute, and immersed in the external surface coating solution for 5 seconds. Furthermore, it was dried at 95° C. for 3 minutes, leached at 85° C. for 1 minute, and finally post-vulcanized at 110° C. for 5 minutes.

The coating solution of the carboxylated NBR latex was incorporated only with 0.25 parts of the carboxyl group sealant, and diluted with water to have the solid latex concentration of 5%.

(Carboxylated NBR Latex)

Nipol LX-551 (Zeon Corporation)

(Carboxyl Group Sealant)

Detackifying, hydrogen bond adjustor: Polyamidepolyamine epichlorohydrin resin
Sumirez Resin 6625 (Sumitomo Chemical Group)
   (External Surface Halogenation Treatment Step)

The natural rubber latex film prepared was heated at 50° C. for 5 minutes, and leached at 85° C. for 3 minutes. Then, it was heated at 95° C. for 5 minutes, and immersed in chlorine water (chlorine concentration: 0.4%) for 3 minutes. Furthermore, it was leached at 85° C. for 1 minute, and finally post-vulcanized at 110° C. for 5 minutes.

### EXAMPLE 247

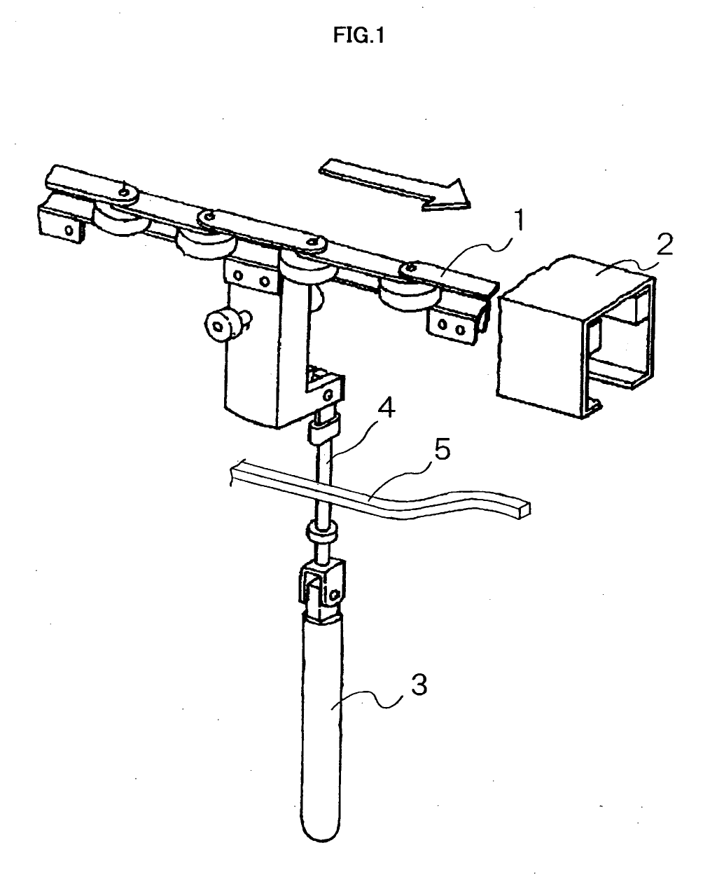

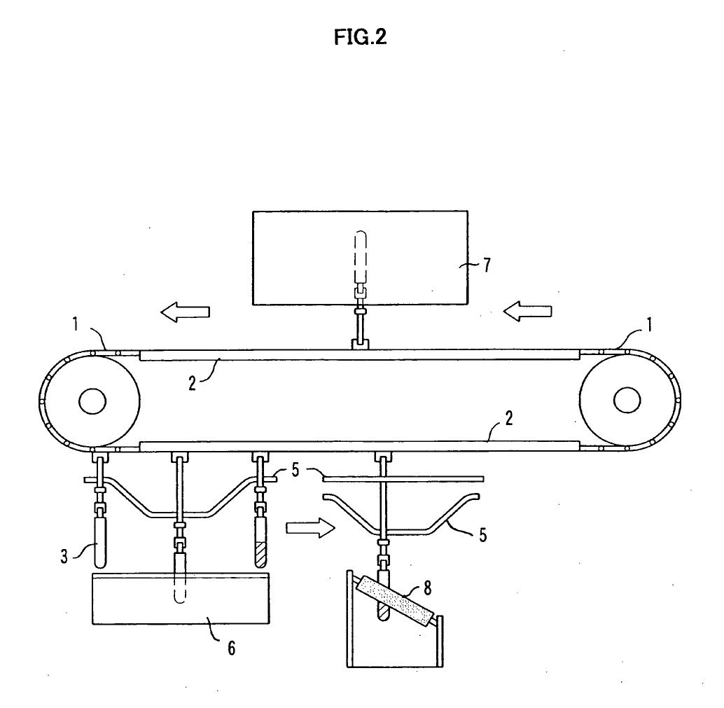

The prototype fingerstall production unit shown in FIG. 2 was constructed, based on the immersion type carrier shown in FIG. 1 (Japanese Patent Laid-Open No. 07-329084), and used to produce the fingerstalls in a manner similar to the procedure above-described in each EXAMPLE.

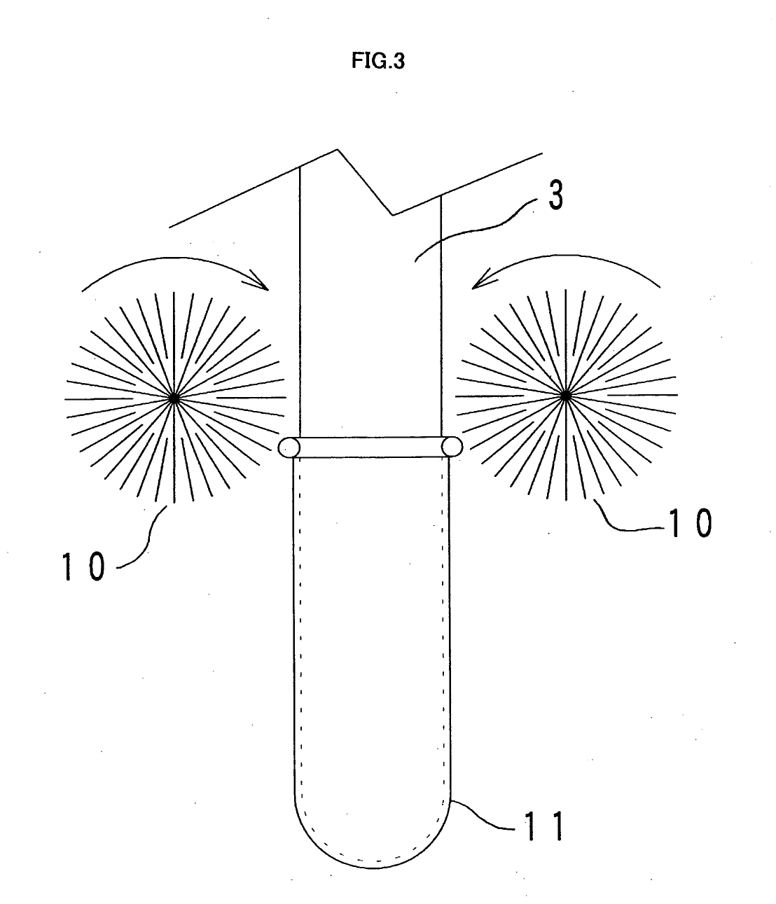

In the immersion type carrier shown in FIG. 1, the chain 1 moves along the guide rail 2 to carry the immersion mold 3, and the rod 4 moves along the guide 5 to move the immersion mold 3 in the vertical direction. Referring to FIG. 2, the immersion mold 3, when passing over the immersion tank 6, moves downwards to be immersed in the tank 6. The immersion tanks are prepared for each of the coagulating liquid, latex liquid, leaching water and external surface treatment solution. They are replaced with each other, as required, for the immersion or leaching treatment. On completion of the immersion or leaching treatment, the immersion mold 3 is passed to the drying furnace 7 in which it is dried. The guide 5 is adjusted in such a way to prevent the immersion mold 3 from moving downwards and coming into contact with the winding machine 8, while the machine 8 is not in service. The immersion mold 3 is set immobilized, as required, during the immersion, drying or leaching step for a given treatment time. The winding machine 8 winds up the film 11 from the immersion mold 3 on which it is set by rotating the roll-shaped brushes (FIG. 3) 10 disposed obliquely and passing the immersion mold 3 between them. On completion of the latex film forming process, the film is wound up and released from the immersion mold 3 on which it is set by passing the mold 3 through the winding machine 8. Each fingerstall wound up is dried at 90° C. for 30 minutes to finish the production step. The fingerstall thus produced can be easily put on a finger.

TABLE 39

| | Hydrophilic polymers | | | | | | |
|---|---|---|---|---|---|---|---|
| | or cationic group | | | | | | |
| | introducing compounds to | | Cationic group | | | | |
| | be incorporated in the latex | | introducing compounds | | | Measured | |
| | | Incor- | for treating the | | | protein | |
| | | porated | internal surface | | Eexternal | content (ppm) | Tackiness |
| Examples | | quantity | | Concen- | surface | protein | test |
| NO. | | (parts) | | tration (%) | treatment | content (ppm) | results |
| 240 | Alkyl acetalized polyvinyl | 0.5 | Polyamide/polyamine | 2.0 | coated | 16.5 | ◯ |
| | alcohol | | epichlorohydrin resin | | halogenized | 19.1 | |
| | Trade name: Eslec KW-3 | | Trade name: Sumirez Resin | | | | |
| | (SEKISUI CHEMICAL) | | 6625 (Sumitomo Chemical | | | | |
| | Properties: Nonionic, | | Group) | | | | |
| | Transparent, viscous liquid, | | Properties: Cationic, | | | | |
| | Concentration: 20% Viscosity: | | Brown, transparent liquid, | | | | |
| | 3500 mPa · s, pH: 6 | | Concentration: 25% Viscosity | | | | |
| | | | (25° C.): 200 mPa · s, | | | | |
| | | | pH (25° C.): 4.0 | | | | |
| 241 | Copolymerized polyamide | 0.25 | Crosslinking agent of | 1.0 | coated | 18.7 | ◯ |
| | emulsion | | metallic element: | (asAl₂O₃) | halogenized | 17.0 | |
| | Trade name: Griltex 2 | | Polyaluminum hydroxide | | | | |
| | Suspension (EMS SHOWA | | Trade name: Paho#2S | | | | |
| | DENKO K.K.) | | (Asada Kagaku Kogyo) | | | | |
| | Properties: Nonionic, | | Properties: Cationic, | | | | |
| | Milky white aqueous solution, | | Light yellow, transparent | | | | |
| | Concentration: 40% | | liquid, Viscosity (30° C.): | | | | |
| | Viscosity: 1500 cps, pH: 9.5 | | 7 cps Concentration: 10.5% | | | | |
| | | | (as Al2O3), pH: 3.5 | | | | |
| 242 | Cationized starch | 0.25 | Polyamide/polyamine | 0.5 | coated | 2.4 | ◯ |
| | Trade name: Cato308 | | epichlorohydrin resin | | halogenized | 9.2 | |
| | (Nippon NSC) | | Trade name: Euramine P5600 | | | | |
| | Properties: Cationic | | (Mitsui Chemicals) | | | | |
| | White powdery | | Properties: Cationic, Light | | | | |
| | | | yellow, transparent liquid, | | | | |
| | | | Concentration: 31% | | | | |
| | | | Viscosity (25° C.): 71.3 | | | | |
| | | | mPa · s, pH (25° C.): 4.5 | | | | |
| 243 | Polyamide/polyamine | 0.25 | Polyamine epichlorohydrin | 1.0 | coated | 2.5 | ◯ |
| | epichlorohydrin resin | | resin | | halogenized | 8.3 | |
| | Trade name: Sumirez Resin | | Trade name: WS-564 | | | | |
| | 6625 (Sumitomo Chemical | | (Nippon PMC corporation) | | | | |
| | Group) | | Properties: Cationic, Light | | | | |
| | Properties: Cationic, | | amber liquid, Concentration: | | | | |
| | Brown, transparent liquid, | | 20% Viscosity (25° C.): | | | | |
| | Concentration: 25% Viscosity | | 50 cps, pH: 3.7 | | | | |
| | (25° C.): 200 mPa · s, | | | | | | |
| | pH (25° C.): 4.0 | | | | | | |
| 244 | Not used | | Crosslinking agent of | 2.0 | coated | 11.3 | ◯ |
| | | | metallic element: | (asAl₂O₃) | halogenized | 15.0 | |
| | | | Polyaluminum hydroxide | | | | |
| | | | Trade name: Paho#2S | | | | |
| | | | (Asada Kagaku Kogyo) | | | | |
| | | | Properties: Cationic, | | | | |
| | | | Light yellow, transparent | | | | |
| | | | liquid, Viscosity (30° C.): | | | | |
| | | | 7 cps Concentration: 10.5% | | | | |
| | | | (as Al2O3), pH: 3.5 | | | | |
| 245 | Not used | | Polyamide/polyamine | 2.0 | coated | 9.5 | ◯ |
| | | | epichlorohydrin resin | | halogenized | 10.1 | |
| | | | Trade name: Sumirez Resin | | | | |
| | | | 6625 (Sumitomo Chemical | | | | |
| | | | Group) | | | | |
| | | | Properties: Cationic, | | | | |
| | | | Brown, transparent liquid, | | | | |
| | | | Concentration: 25% Viscosity | | | | |
| | | | (25° C.): 200 mPa · s, | | | | |
| | | | pH (25° C.): 4.0 | | | | |
| 246 | Not used | | Zirconium oxychloride | 1.0 | coated | 9.9 | ◯ |
| | | | | (asZrO2) | halogenized | 11.7 | |

### Industrial Applicability

The present invention provides a detackified natural rubber latex product. The invention also provides the natural rubber latex product from which protein present in the natural rubber latex is eluted out to only a limited extent. The present invention also provides the natural rubber latex product which causes no discoloration of the metallic product surface with which it comes into contact, when it is to be used for handling a precision device or the like, by coating it, as required, with a synthetic rubber latex layer vulcanized without using sulfur.

1. A detackified natural rubber latex product, characterized in that both surfaces are provided with a detackified, diene-based carboxylated synthetic rubber latex coating layer.

2. A detackified natural rubber latex product with one or both surfaces detackified, characterized in that a natural rubber latex is incorporated with a detackifying hydrophilic polymer and/or hydrophilic group sealant.

3. A detackified natural rubber latex product with one or both surfaces detackified, characterized in that the surfaces of a natural rubber latex product are treated with a hydrophilic group sealant.

4. A detackified natural rubber latex product with one or both surfaces detackified, characterized in that a natural rubber latex is incorporated with at least one selected from the group consisting of nonionic polymer and anionic polymer, and cationic polymer and ampholytic polymer which cause no gelation of the natural rubber latex, and further with at least one selected from a hydrophilic group sealant and a carboxyl group sealant.

5. The detackified natural rubber latex product with one or both surfaces detackified according to any one of claims 2 to 4, characterized in that an external surface of a natural rubber latex product or a natural rubber latex product incorporated with a hydrophilic group sealant and/or hydrophilic polymer is detackified by providing at least one layer selected from the group consisting of a detackified polymer layer, a halogenation treated layer, a layer treated with a detackifying crosslinking agent of tri- or tetra-valent metallic element, and a layer treated with at least one of a peroxotitania solution, peroxotitania sol, zirconia sol or alumina sol, a layer treated with a hydrophilic group sealant and a layer treated with a carboxyl group sealant.

6. A detackified natural rubber latex product with one or both surfaces detackified, characterized in that the detackified polymer coating layer, as set forth in claim 5, on an external surface is a detackifying, diene-based carboxylated synthetic rubber latex coating layer or a detackifying, releasing agent coating layer.

7. A detackified natural rubber latex product with one or both surfaces detackified, characterized in that the detackifying polymer coating layer or the detackifying diene-based carboxylated synthetic rubber latex coating layer, as set forth in any one of claims 1, 5 and 6, on an external surface is detackified by incorporating the polymer or a diene-based carboxylated synthetic rubber latex with a hydrophilic group sealant or a carboxyl group sealant.

8. A detackified natural rubber latex product with one or both surfaces detackified, characterized in that the detackifying polymer coating layer or the detackifying diene-based carboxylated synthetic rubber latex coating layer, as set forth in claims 1, 5 and 6, on an external surface is detackified by at least one selected from a hydrophilic group sealant and a carboxyl group sealant incorporated in the natural rubber latex.

9. A detackified natural rubber latex product with one or both surfaces detackified, characterized in that the detackifying polymer coating layer or the detackifying, diene-based carboxylated synthetic rubber coating latex layer, as set forth in any one of claims 1, 5 and 6, on an external surface is detackified by treating a surface of the polymer coating layer or diene-based carboxylated synthetic rubber latex coating layer with at least one selected from a hydrophilic group sealant and a carboxyl group sealant.

10. A detackified, lubricating, diene-based carboxylated synthetic rubber latex coat or product with one or both surfaces detackified, characterized in that a lubricating, diene-based carboxylated synthetic rubber latex coat or product, which is incorporated with a reactive, cationic compound or the lubricating, diene-based carboxylated synthetic rubber latex coat or product treated with one or more carboxyl group sealants.

11. The detackified natural rubber latex product with one or both surfaces detackified according to claim 7, characterized in that an external surface is coated with a detackified, lubricating, diene-based carboxylated synthetic rubber latex incorporated with a reactive, cationic compound.

12. A detackified natural rubber latex product with one or both surfaces detackified, characterized in that an internal surface of the natural rubber latex product as set forth in any one of claims 1 to 11 is detackified with at least one selected from a hydrophilic group sealant and a carboxyl group sealant incorporated in the natural rubber latex.

13. A detackified natural rubber latex product with one or both surfaces detackified, characterized in that an internal surface of the natural rubber latex product as set forth in any one of claims 1 to 11 is detackified with at least one selected from a hydrophilic group sealant and a carboxyl group sealant incorporated in the detackified polymer coating layer or detackifying, diene-based carboxylated synthetic rubber latex coating layer on an external surface.

14. A detackified natural rubber latex product with one or both surfaces detackified, characterized in that an internal surface of the product as set forth in any one of claims 1 to 11 is detackified by providing a detackifying polymer layer, layer treated with detackifying crosslinking agent of tri- or tetra-valent metallic element, or a layer treated with a hydrophilic group sealant or a carboxyl group sealant.

15. A detackified natural rubber latex product with one or both surfaces detackified, characterized in that the detackifying polymer coating layer on an internal surface, as set forth in claim 14, is a detackifying, diene-based carboxylated synthetic rubber latex coating layer.

16. A detackified natural rubber latex product with one or both surfaces detackified, characterized in that the detackifying polymer coating layer or the detackifying, diene-based carboxylated synthetic rubber latex coating layer, as set forth in claim 14 or 15, on an internal surface is detackified by incorporating the polymer or the carboxylated synthetic rubber latex with at least one selected from a hydrophilic group sealant and a carboxyl group sealant.

17. A detackified natural rubber latex product with one or both surfaces detackified, characterized in that the detackifying polymer coating layer or the detackifying, diene-based carboxylated synthetic rubber latex coating layer, as set forth in claims 14 or 15, on an internal surface is detackified by coating the internal surface of the polymer coating layer or the carboxylated synthetic rubber latex coating layer with at least one selected from a hydrophilic group sealant and a carboxyl group sealant.

18. A detackified natural rubber latex product with one or both surfaces detackified, wherein the detackifying polymer coating layer or the detackifying, diene-based carboxylated synthetic rubber latex coating layer on an internal surface, as set forth in claims 14 or 15, is detackified with a hydrophilic group sealant or a carboxyl group sealant incorporated in the detackifying polymer coating layer or detackifying, diene-based carboxylated synthetic rubber latex coating layer, as set forth in any one of claims 1 and 5 to 7, on an external surface, or with a hydrophilic group sealant or a carboxyl group sealant incorporated in the natural rubber latex.

19. A detackified natural rubber latex product with one or both surfaces detackified, characterized in that the hydrophilic, nonionic polymer, as set forth in claim 4 or 5, has at least one hydrophilic group selected from the group consisting of hydroxyl (—OH), ether (—O—) and amide (—CONH₂—) groups.

20. A detackified natural rubber latex product with one or both surfaces detackified, characterized in that the hydrophilic, anionic polymer, as set forth in claim 4 or 5, has at least one hydrophilic group selected from the group consisting of carboxyl (—COOM), sulfate ester (—OSO₃M), sulfonate (—SO₂OM), phosphate (—PO₃HM or —PO₃M₂), phosphate ester, —SO₂NH₂, and —SO₂NHCOR groups, where M is hydrogen atom, and alkali metal, ammonia or organoammonium; and R is an alkyl, phenyl which may be substituted or not, or naphthyl group which may be substituted or not.

21. A detackified natural rubber latex product with one or both surfaces detackified, characterized in that the hydrophilic, cationic polymer which causes no gelation of the natural rubber latex, as set forth in claim 4 or 5, has at least one compound selected from the group consisting of amine salt (primary, secondary or tertiary), quaternary ammonium or pyridinium salt, phosphonium salt and sulfonium salt.

22. A detackified natural rubber latex product with one or both surfaces detackified, characterized in that the hydrophilic, ampholytic polymer which causes no gelation of the natural rubber latex, as set forth in claim 4 or 5, has the hydrophilic group as set forth in claims 20 and 21.

23. A detackified natural rubber latex product with one or both surfaces detackified, characterized in that the hydrophilic polymer, as set forth in any one of claims 4, 5 and 19 to 22, is a water-soluble polysaccharide or derivative thereof.

24. A detackified natural rubber latex product with one or both surfaces detackified, characterized in that the water-soluble polysaccharide, as set forth in claim 23, is selected from the group consisting of carboxymethyl cellulose, methyl cellulose, ureaphosphate-esterified starch, cationized starch, ampholytic starch, guar gum, phosphate-esterified guar gum, ampholytic guar gum, sodium alginate, carrageenan, locust bean gum, and xanthan gum.

25. A detackified natural rubber latex product with one or both surfaces detackified, characterized in that the hydrophilic polymer, as set forth in any one of claims 4, 5 and 19 to 22, is water-soluble, water-sensitive or water-dispersible synthetic polymer.

26. A detackified natural rubber latex product with one or both surfaces detackified, characterized in that the hydrophilic polymer, as set forth in claim 25, is selected from the group consisting of ammonium polyacrylate, ampholytic polyacrylamide, polyethylene oxide, polyvinyl alcohol, cationic polyamide resin, carboxylate-based acrylic copolymer, cationic acrylic copolymer, N-methoxymethylated polyamide modification (water-soluble nylon), acrylate ester copolymer, polyvinyl butyral, and cationic styrene/acrylic acid copolymer.

27. A detackified natural rubber latex product with one or both surfaces detackified, characterized in that the water-dispersible synthetic polymer, as set forth in claim 25 is selected from the group consisting of polyvinyl acetate, ethylene-vinyl acetate copolymer, styrene/acrylate ester copolymer, styrene/methacrylate ester copolymer, acrylate ester copolymer, alkali-thickened acrylic-based emulsion, methacrylate ester copolymer, vinyl acetate/acrylic acid copolymer, vinyl acetate/acrylate ester copolymer, vinyl acetate/methacrylic acid copolymer, vinyl acetate/methacrylate ester copolymer, polyacrylamide, polymethacrylamide, copolymerized polyamide emulsion, acrylamide-based copolymer, methacrylamide-based copolymer, anionic, cationic and ampholytic modifications of these polymers, polyvinyl butyral emulsion, and polyolefin containing carboxyl group.

28. A detackified natural rubber latex product with one or both surfaces detackified, characterized in that the detackifying, hydrophilic polymer, as set forth in claim 2, is at least one selected from the group consisting of methyl cellulose, locust bean gum, xanthan gum, carboxymethyl cellulose, alginate, carrageenan, and polyamide derivative.

29. A detackified natural rubber latex product with one or both surfaces detackified, characterized in that the hydrophilic group sealant or carboxy group sealant, as set forth in any one of claims 2 to 18, is a detackifying crosslinking agent of tri- or tetra-valent metallic element.

30. The detackified natural rubber latex product with one or both surfaces detackified according to claim 29, characterized in that the detackifying crosslinking agent of tri- or tetra-valent metallic element contains at least selected from the group consisting of aluminum, titanium and zirconium compounds.

31. A detackified natural rubber latex product with one or both surfaces detackified, characterized in that the hydrophilic group sealant or carboxy group sealant, as set forth in any one of claims 2 to 18 is at least one selected from the group consisting of peroxotitania solution, peroxotitania sol, zirconia sol and alumina sol.

32. A detackified natural rubber latex product with one or both surfaces detackified, characterized in that the hydrophilic group sealant or carboxy group sealant, as set forth in any one of claims 2 to 18, is a detackifying, hydrophobic, organic crosslinking agent for the hydrophilic polymer as set forth in claim 4 or 5 and/or an auxiliary component of natural rubber latex.

33. A detackified natural rubber latex product with one or both surfaces detackified, characterized in that the detackifying, hydrophobic, organic crosslinking agent, as set forth in claim 32, contains at least one selected from the group consisting of blocked isocyanate, oxazoline and carbodiimide.

34. The detackified natural rubber latex product with one or both surfaces detackified according to any one of claims 2 to 18, characterized in that the hydrophilic group sealant or carboxy group sealant contains at least one type of detackifying, hydrogen bond adjustors.

35. A detackified natural rubber latex product with one or both surfaces detackified, characterized in that the detackifying, hydrogen bond adjustor, as set forth in claim 34, is selected from the group consisting of a polyamide compound, polyamide epoxy resin, polyaminepolyurea-based resin and polyamidepolyurea-based resin.

36. A detackified natural rubber latex product with one or both surfaces detackified, characterized in that the hydrophilic group sealant or the carboxy group sealant as set forth in any one of claims 2 to 18, and the compound reactive with the carboxyl group in the carboxylated synthetic rubber latex as set forth in claim 10 or 11 are polyamide amine/epihalohydrin condensate, polyamine/epihalohydrin condensate, polyamidepolyurea/epihalohydrin condensate, polyaminepolyurea/epihalohydrin condensate, polyamideaminepolyurea/epihalohydrin condensate, polyamidepolyamine epichlorohydrin resin modified with a quaternary amino group, styrene-based polyamidepolyamine epichlorohydrin resin modified with a quaternary amino group, cation-modified urea resin, and cation-modified, epoxy-based polyamide resin.

37. A detackified natural rubber latex product with one or both surfaces detackified, characterized in that the hydrophilic group sealant or carboxy group sealant, as set forth in any one of claims 2 to 18, contains at least one compound selected from the group consisting of monofunctional amine, monofunctional epoxy compound, monofunctional isocyanate, monofunctional blocked isocyanate, alkyl ketene dimer (AKD), alkenyl ketene dimer, alkenyl succinic anhydride (ASA), aliphatic acid anhydride, and isocyanate aziridine derivative.

38. A detackified natural rubber latex product with one or both surfaces detackified, characterized in that the hydrophilic group sealant or the carboxy group sealant, as set forth in any one of claims 2 to 18, is a detackifying sizing agent.

39. A detackified natural rubber latex product with one or both surfaces detackified, characterized in that the hydrophilic group sealant or carboxy group sealant, as set forth in any one of claims 2 to 18 is a detackifying anionic, nonionic, or cationic surfactant.

40. A detackified natural rubber latex product with one or both surfaces detackified, characterized in that the detackifying waterproofing agent, as set forth in any one of claims 2 to 18, acts on a tacky auxiliary component of the natural rubber latex, incorporated hydrophilic nonionic, anionic, cationic or ampholytic polymer, or a polymer coating layer or a carboxylated synthetic rubber latex coating layer.

41. A detackified natural rubber latex product with one or both surfaces detackified, characterized in that the detackifying waterproofing agent, as set forth in claim 40, is a compound having a methylol group or lower alkylated compound thereof, aldehyde-based compound, a compound having an epoxy or chlorohydrin group, a compound having an ethyleneimine group, a polyvinyl butyral-based compound, or a tri- or tetra-valent multi-valent metallic compound.

42. A detackified natural rubber latex product with one or both surfaces detackified, characterized in that the detackifying waterproofing agent, as set forth in claims 40 and 41, is polyamide epoxy resin, branched polyethylene imine, modified polyamine-based resin, polyamide-based resin, ketone resin, alkyl ketene dimer, ammonium zirconium carbonate, or blocked glyoxal resin.

43. A detackified natural rubber latex product with one or both surfaces detackified, characterized in that the hydrophilic group sealant or carboxy group sealant, as set forth in any one of claims 2 to 18, is a detackifying water repellant.

44. A detackified natural rubber latex product with one or both surfaces detackified, characterized in that the hydrophilic group sealant or carboxy group sealant, as set forth in any one of claims 2 to 18, is a detackifying releasing agent.

45. A natural rubber latex product of controlled protein elution, characterized by being treated with a compound which can introduce an anionic and/or cationic group in protein in the natural rubber latex.

46. The natural rubber latex product of controlled protein elution according to claim 45, characterized in that the compound which can introduce an anionic and/or cationic group in the natural rubber latex is a compound reactive with protein in the natural rubber latex.

47. The natural rubber latex product of controlled protein elution according to claim 45, characterized in that the compound which can introduce an anionic and/or cationic group in the natural rubber latex is a fixing compound or compound which can be fixed.

48. The natural rubber latex product of controlled protein elution according to claim 46, characterized in that the compound which can introduce an anionic and/or cationic group in the natural rubber latex is reactive dye and derivative of carboxylic anhydride as anionic compounds; polyamideamine/epihalohydrin condensate, polyamine/epihalohydrin condensate, polyamidepolyurea/epihalohydrin condensate, polyaminepolyurea/epihalohydrin condensate, polyamideaminepolyurea/epihalohydrin condensate, polyamidepolyamine epichlorohydrin resin modified with a quaternary amino group, styrene-based, polyamidepolyamine epichlorohydrin resin modified with a quaternary amino group, cation-modified urea resin, cation-modified epoxy-based polyamide resin, crosslinking agent of multi-valent (trivalent or higher), and peroxotitania solution, peroxotitania sol, zirconia sol and alumina sol as cationic compounds.

49. The natural rubber latex product of controlled protein elution according to claim 47, characterized in that the fixing compound which can introduce an anionic and/or cationic group in the natural rubber latex is anionic, ampholytic and/or cationic starch.

50. The natural rubber latex product of controlled protein elution according to any one of claims 45 to 48, characterized in that the functional group reactive with protein of the compound which can introduce an anionic group in protein in the natural rubber latex is at least one selected from the group consisting of dichlorotriazine, difluorochlorotriazine, dichloroquinoxaline, monofluorotriazine, β-sulfatoethylsulfone, monochlorotriazine, trichloropyrimidine, carboxypyridino-S-triazine, α-bromoacrylamide, acrylamide, ω-chloroacetyl, epoxy and carboxyl anhydride.

51. A natural rubber latex product of controlled protein elution, characterized by being treated with a waterproofing agent (ketone resin) reactive with protein in natural rubber latex under an alkaline condition and capable of fixing the protein.

52. A detackified natural rubber latex product of controlled protein elution, characterized by being treated in a manner as set forth in any one of claims 45 to 51, and also in a manner as set forth in any one of claims 1 to 42.

53. A producing method of the detackified natural rubber latex product with one or both surfaces detackified, and/or the natural rubber latex product of controlled protein elution, as set forth in any one of claims 1 to 52, characterized by being leaching-treated subsequent to drying at high temperature.

54. The detackified natural rubber latex product with one or both surfaces detackified, and/or the natural rubber latex product of controlled protein elution, according to any one of claims 1 to 52, characterized by being a fingerstall, glove, balloon or condom.

55. A finger stall of a detackified natural rubber latex with one or both surfaces detackified, and/or a natural rubber latex of controlled protein elution, characterized in that the finger stall of the detackified natural rubber latex and/or natural rubber latex of controlled protein elution as set forth in claim 54 has a shape of being mechanically wound up from a mouth before being released out of a mold.
